(19) United States
(12) Patent Application Publication
(10) Pub. No.: US 2004/0088730 A1
(43) Pub. Date: May 6, 2004

(54) System and method for maximizing license utilization and minimizing churn rate based on zero-reject policy for video distribution

(76) Inventors: Srividya Gopalan, Bangalore (IN); Kanchan Sripathy, Bangalore (IN); V. Sridhar, Bangalore (IN); K. Kalyana Rao, Bangalore (IN)

Correspondence Address: VENABLE, BAETJER, HOWARD AND CIVILETTI, LLP, P.O. BOX 34385, WASHINGTON, DC, 20043-9998, US

(21) Appl. No.: 10/285,511

(22) Filed: Nov. 1, 2002

(51) Int. Cl. H04N 7/173; H04N 9/47; H04N 7/18; G06F 13/00; H04N 5/445; G06F 3/00; H04N 7/16

(52) U.S. Cl. 725/93; 725/119; 725/8; 725/1; 725/45; 725/52; 725/40; 725/46

(57) ABSTRACT

The proposed system defines a comprehensive video license distribution system to achieve the zero-reject of requests from subscribers, maximizing the usage of licenses and minimizing the churn rate by (a) using symbolic and numeric features of movies; (b) planning video license distribution of different license kinds to a predictable group of subscribers based on the analysis of subscriber video viewing patterns; (c) exclusive handling of unpredictable behavior of subscribers; (d) the effective trading of favor points; (e) intelligent timing and selection of subscriber specific previews; and (f) the detailed analysis of subscriber complaints. The system generates individually tailored weekly movie plans for subscriber communities for preferred and anticipated demands using movie feature set, movie hierarchy, pop-chart and past subscriber usage pattern, performs buy and swap analysis for acquiring and relinquishing licenses of movies, determines a near optimal distribution of available licenses and allocates the licenses to meet the demands, uses favor points for anticipated demands, re-plans in case of non-viewing of a planned movie, triggers favor points based on the goodwill shown, and interacts with external entities for movie feature set and pop-chart updates.

### FIELD OF THE INVENTION

The present invention relates to video license distribution in general, and more particularly, maximizing video license utilization. Still more particularly, the present invention relates to a system and method for planning video license distribution of different license kinds based on analysis of subscriber video viewing patterns to meet video demands.

### BACKGROUND OF THE INVENTION

Video distribution systems process real-time demands from users for movies and stream the requested movies. Movies that are streamed are owned by content producers and operators of video distribution systems need to obtain proper streaming licenses from the distributors. License management deals with ensuring that streaming of movies is in conformance with the obtained licenses. For an improved return on investment, the operators are required to effectively use the obtained licenses without violating the license terms and conditions. With the proliferation of network of systems in general and Internet in particular, video distribution systems tend to be organized in multiple layers so that movie streaming can be purposeful and cost-effective. However, such an architecture of video distribution system poses challenges for license utilization and management. Furthermore, providing support for real-time video on demand requires huge investment for setting up adequate infrastructure and acquiring adequate licenses. Near video on demand systems address these issues by minimally delaying one or more movie requests or utilizing point of presence servers.

Another important aspect of video distribution systems is churn management. One of the effective ways of handling churn is to manage subscriber expectations. Users would want the movies of their choice at their chosen time at their preferred cost. Meeting all these three features simultaneously is a very tough proposition for the video distribution systems.

Operators of video distribution systems acquire licenses of movies that are valid for a period of time and manage the distribution of movies to their users. In order to provide the demanded services, users and operators are bound by SLAs. Further, it helps to interact with users through questionnaires and other means to get to know more about users' expectations. SLAs and this additional information can be used by operators to some extent manage well subscribers' expectations. In order to attract users to the movies, promotional offers can be made available based on the number of movies watched. The biggest problem is to achieve a good balance between flexible SLA definitions, subscriber behavior and usage pattern analysis, and promotional offers. Usage pattern analysis in the context of movies requires elaborate characterization of movies so that a detailed analysis can be undertaken. Another equally important issue is related to movie-specific license buy-plan and plan for the usage of these acquired licenses to enhance revenue earnings.

### DESCRIPTION OF THE RELATED ART

U.S. Pat. No. 6,388,714 to Schein; Steven M et al for “Interactive computer system for providing television schedule information” (issued on May 14, 2002 and assigned to Starsight Telecast INC (Fremont, Calif.)) provides television schedule information on a visual interface by means of an electronic program guide, allowing the viewer to navigate and interact with the electronic program guide that is displayed. The electronic program guide is a schedule and/or listing information area that depicts programs, titles or services that the subscriber would likely be interested in, on each channel at each time during the day, week or month. The program guide accomplishes this through a subscriber interface using which the subscriber answers preference or choice questions, or through heuristic learning based on a series of repetitive operations performed by subscriber. A subscriber previewing a movie can receive information regarding other movies released during the same period and promotional offers.

U.S. Pat. No. 6,263,504 to Ebisawa; Kan for “Data delivery system, data receiving apparatus, and storage medium for video programs” (issued on Jul. 17, 2001 and assigned to Sony Corporation (Tokyo, JP)) describes a near video on demand system in which a data storage unit provided in a receiving apparatus so that a video program can be provided with an instantaneous response equivalent to the VOD system. The data of the first part of the video data is stored in the data storage unit in advance and when there is a request for reproduction, the stored data is immediately reproduced. Further, the data after the first data is sent from a transmitting apparatus, buffering is performed in the receiving apparatus, and the resultant data is reproduced continuous with the data of the first part.

U.S. Pat. No. 6,057,872 to Candelore Brant for “Digital coupons for pay televisions” (issued on May 2, 2000 and assigned to General Instrument Corporation (Horsham, Pa.)) describes selective transmission of digital coupons to subscriber terminals for promotional purposes. Subscribers automatically receive coupon credits when they meet the preconditions of the digital coupons. Free or reduced price pay-per-view programming in particular may be provided when a subscriber purchases a given number of paid programs at a regular price. The terminals maintain a running balance of available coupon credits and inform the subscriber via a user interface of the available balance. Subscribers can be rewarded for viewing commercial messages by awarding coupons, which can be immediately redeemed for paid programs. With an optional report back capability, terminal usage pattern data can be retrieved and analyzed by program service providers to determine the effectiveness of the promotions and to gather additional demographic and individual data. Moreover, the network controller can control the delivery of the digital coupon information to the terminals based on the received usage pattern data.

Recommender systems are based on information filtering techniques that use individual previous behavior to produce recommendation. These systems advise users by selecting information that users may be interested in and filtering out what users may not be interested in. Information filtering along with collaborative filtering techniques have been used to select information based on the subscriber's previous preference tendency and the opinion of other people who have similar tastes as that of the subscriber. Saranya Maneeroj, Hideaki Kanai and Katsuya Hakozaki in “Combining Dynamic Agents and Collaborative Filtering without Sparsity Rating Problem for Better Recommendation Quality” (appeared on June 2001 in Proceedings of the Second DELOS Network of Excellence Workshop on Personalization and Recommender Systems in Digital Libraries) describe an improved recommendation method that increases the accuracy of recommendation results. This method uses the notion of similarity between a subscriber feature vector and a movie feature vector as rating data predicted by the information filtering agents.

P. Baudisch and L. Brueckner in “TV Scout: Lowering the entry barrier to personalized TV program recommendation” (appeared on May 2002 in Proceedings of the 2nd International Conference on Adaptive Hypermedia and Adaptive Web Based Systems (AH2002)) describe a recommendation system providing users with personalized TV schedules. The TV Scout architecture overcomes the drawback of filtering systems that gather information from users about their interests before they can compute personalized recommendations. Continuous supply of relevance feedback in the form of queries or manual profile manipulation improves the subscriber's profile.

“Rule-based Video Classification System for Basketball Video Indexing” by Wensheng Zhou, Asha Vellaikal, C. C. Jay K (appeared on October 2000 in the Proceedings of the 2000 ACM workshops on Multimedia, Los Angeles, Calif., United States) investigates the use of video content analysis, feature extraction and clustering techniques for video semantic classifications and proposes a supervised rule-based video classification system as applied to basketball video. A basketball video structure is examined and categorized into different classes according to distinct visual and motional characteristic features by the rule-based classifier. The rules are calculated using an inductive decision-tree learning approach that is applied to multiple low-level image features. Such a categorization can be used to index and retrieve videos.

Information on business models related to licensing can be found in the source http://www.drmnetworks.net/solutions.html (accessed on May 31, 2002). The discussed models include video on demand model that is similar to a standard rental store program which allows subscriber to view a piece of content for a specified time period; the time frame model works for web publishers who want to establish longer relationship with the customers by offering large collections of content for extended viewing periods; the token model provides increased flexibility and is based on a bank of tokens that is decremented whenever the content is accessed; the promotion model allows the release and promotion of content to gather marketing information.

The known systems have no means for effectively assessing the movie demands from subscribers from the aspect of license utilization to achieve “zero” reject of movie demands and to reduce subscriber churn rate. A sound business model for a video distribution system requires maximizing the return on investment and one of the important aspects of the return on investment is to be able to retain subscribers. Not loosing subscribers would lead to improved infrastructure utilization, thereby enhancing the revenue. The major recurring investment in a video distribution system is related to license acquisition and it is equally important to manage the return on this investment. The level of satisfaction, and hence churn rate, is dependent on how effectively the system addresses the movie demands from subscribers. The present invention, described by systems and methods presented herein, addresses each of the above issues adequately by proposing a comprehensive video license distribution system based on the policy of zero reject of requests for maximizing license utilization and minimizing churn rate.

### SUMMARY OF THE INVENTION

The primary objective of the invention is to achieve the zero-reject of requests from subscribers of the comprehensive video license distribution system and at the same time maximizing the usage of licenses and minimizing the churn rate. The objective of the present invention is achieved by describing movies using an elaborate symbolic and numeric features, planning video license distribution of different license kinds to a predictable group of subscribers based on the analysis of subscriber video viewing patterns and handling of exception group on one-on-one basis, the effective use of favor points and previews, and the detailed analysis of subscriber complaints.

One aspect of the present invention is to provide for the definition of multiple SLA parameters that include parameters related to favor points comprising willingness on part of the subscriber to be part of give and take offers, type migration details, billing discount information, and other SLA parameters comprising seeking subscribers' consent for data collection for analysis, SLA-type based booking closing time and WP related parameters.

Another aspect of the invention is to provide for the identification of subscriber groups that include exception group comprising new subscribers, unpredictable subscribers, potential churn subscribers, non weekly plan participation subscribers and normal group comprising remaining subscribers.

Another aspect of the invention is to provide a method for FP management comprising defining and modifying of FP rules, computing subscriber FP based on FP triggers, analyzing subscriber FP for subscriber type migration and FP expiry.

Yet another aspect of the invention is to provide a method for preview management comprising means for utilization of preview capsules that are part of preview package of a movie, processing of subscriber specific URL preview events, processing of subscriber specific sponsor click events, processing of post login events and means for streaming community movie related previews.

Another aspect of the invention is to provide a method for complaints management comprising means for root cause analysis of subscriber specific complaints and for comparing subscriber specific MTTR sequence of complaints with system defined MTTR sequence to identify potential churn subscribers.

Yet another aspect of the invention is to provide a method for billing management comprising means for computing subscriber billing discount based on the accumulated favor points over a period of time using a set of rules.

Another aspect of the invention is to describe movies using a set of symbolic features and numeric features to provide an appropriate description of the movies and relate these descriptions in a hierarchical fashion and further to use multiple such hierarchies to identify movies of interest to subscribers.

Another aspect of the invention is to provide for determination of subscriber's most probable movie count by analyzing day-wise past subscriber's movie viewing pattern based on movie recency.

Yet another aspect of the invention is to provide for identification of movie feature set comprising classifying movies viewed by subscriber during past week into each of plurality of hierarchies based on movie symbolic and numeric feature set, identifying best possible plurality of representative nodes of plurality of hierarchies for collection of movies viewed by subscriber, identifying subscriber specific combined symbolic and numeric feature set based on subscriber specific minimum number of most general representative nodes from the identified nodes of plurality of hierarchies, and means for predicting subscriber specific symbolic and numeric feature set based on combined symbolic and numeric features sets representing movies viewed by subscriber during past weeks.

Another aspect of the present invention is to provide for selection of movies from popularity chart comprising ranking of movies in subscriber specific popularity chart based on subscriber specific predicted symbolic and numeric feature set and symbolic and numeric features sets associated with the movies in the popularity chart and selecting movies based on weighted distribution of movie licenses and subscriber's SLA type.

Yet another aspect of the present invention is to provide for slot selection comprising ranking subscriber specific slots based on weighted slot occupancy due to movies viewed by subscriber during past weeks and means for selecting subscriber specific movie count number of slots based on inter-slot gap.

Still another aspect of the present invention is to provide for movie slot matching comprising subscriber specific matching of movies to slots based on maximum degree of similarity between symbolic and numeric features associated with each movie and slot.

Another aspect of the present invention is to provide for weekly plan preparation comprising computing subscriber specific number of preferred and expected movies.

Yet another aspect of the present invention is to provide a method for preferred demand bulk allocation comprising allocating allotted licenses to meet subscriber's preferred demands.

Still another aspect of the present invention is to provide a method for expected demand bulk allocation comprising allocating allotted licenses to meet subscriber's expected demands in the order of the subscriber's rank where subscribers are ranked based on weights determined using subscriber specific past data consisting of complaints, revenue, successful viewings, past favor points, and SLA type.

Another aspect of the present invention is to provide a method for processing incremental demands comprising checking of subscriber's SLA compliance, checking of license availability for a movie in a slot, negotiating for an alternate movie or slot in case of non-availability of the license, generating FP triggers, and updating license availability.

Yet another aspect of the present invention is to provide a method for processing real-time demands comprising checking of subscriber's SLA compliance, checking of license availability for a movie in a slot, generating FP triggers, and updating license availability.

Still another aspect of the present invention is to provide a method for re-planning comprising processing of difference between demanded and actual viewings of a subscriber by allocating a backup slot for the missed movie or allocating best possible alternate movie for the backup slot.

Another aspect of the present invention is to define three distinct kinds of licenses namely bulk reusable (BR), bulk non-reusable (BNR), and single non-reusable (SNR) licenses.

Another aspect of the present invention is to provide a method for ROI analysis comprising computing movie-wise churn rate, movie-wise incurred expense and movie-wise revenue earned for each community and further ranking these communities based on the weighted sum of movie wise churn rate, movie-wise incurred expense, and movie-wise revenue earned.

Yet another aspect of the present invention is to provide a method for buy analysis comprising selecting plurality of movies for license acquisition based on consistent utilization of each movie using upper watermark and life cycle analyses.

Still another aspect of the present invention is to provide a method for preferred demand allocation comprising determining movie-wise near optimal license-kind-wise requirement to meet preferred demand of movie based on evaluation of cost and utilization criteria of the license-kind-wise requirement.

Yet another aspect of the present invention is to provide a method for swap analysis comprising selecting plurality of movies for license swapping based on consistent low utilization of each movie using lower watermark and life cycle analyses.

Another aspect of the present invention is to provide a method for expected demand allocation comprising determining movie-wise distribution of available licenses to meet expected demand of the movie based on near-optimal allocation of plurality of license kinds to meet license-kind specific pre-defined utilization criterion and further assigning best possible alternate movie to meet the remaining unsatisfied demands based on license availability.

Still another aspect of the present invention is to provide a method for license acquisition comprising movie-wise distribution of licenses to be acquired from plurality of distributors based on past bought percentage and computing number of licenses of movie to be swapped from the distributor based on the total number of licenses to be swapped, swap potential, and pre-defined swap ratio.

Still another aspect of the present invention is to provide a method for movie and popularity chart management comprising interacting with external entities for managing symbolic and numeric feature updates for movies, movie hierarchy updates, and popularity chart updates.

Other aspects of the present invention will become apparent from the following drawings, description of the preferred embodiments and claims.

### BRIEF DESCRIPTION OF THE DRAWINGS

FIG. 1 depicts the complete functionality of the Comprehensive Video License Distribution System.

FIG. 2 is a network architecture depicting the interconnections between LSM, CCM and CSLM in a provider's network.

FIG. 3 is a schematic representation of CVLDS depicting various subscriber activities, LSM specific operator related activities and system activities, CCM specific operator related and system activities, and CSLM specific operator related and system activities.

FIG. 4 describes sample SLAs containing CVLDS specific parameters.

FIG. 4A gives sample values for some SLA parameters for various subscriber types.

FIG. 4B gives subscriber type based sample FP values earned by subscribers for various give and take activities resulting in positive or negative favor points.

FIG. 4C gives sample subscriber weekly plan across a week for all days and for all slots.

FIG. 4D depicts the format in which subscribers demand for a movie.

FIG. 5 depicts the functionality of the LSM subsystem of CVLDS.

FIG. 6 is a flowchart that describes subscriber registration procedure in CVLDS.

FIG. 7 depicts the schematic representation of the subscriber groups for WP preparation.

FIG. 8 describes the exception/normal group identification procedure for identifying subscribers belonging to exception group and normal group of CVLDS.

FIG. 9 describes the weekly plan confirmation process for a subscriber.

FIG. 10 describes the various types of FP categories.

FIG. 10A is a table describing the various FP categories and their associated FP rules.

FIG. 11 depicts the FP management module.

FIG. 12 describes the monthly subscriber billing procedure.

FIG. 12A describes the subscriber billing format.

FIG. 13 depicts the preview management module

FIG. 14 describes complaint management activities performed by LSM.

FIG. 14A describes the process of complaint sequence correlation.

FIG. 15 depicts the functionality of the CCM subsystem of CVLDS.

FIG. 16 describes the sequence of various periodic activities performed by CCM.

FIG. 16A describes the structure of CPD table.

FIG. 16B describes the structure of CED table.

FIG. 16C describes the structure of PDL table.

FIG. 16D describes the structure of EDL table.

FIG. 17 describes the sequence of various activities performed during WP processing.

FIG. 18 describes the steps involved in the subscriber specific movie count prediction process.

FIG. 18A describes the Movie Count Prediction table.

FIG. 19 describes the steps involved in the subscriber specific movie feature set identification procedure for each hierarchy.

FIG. 20 describes the steps involved in identifying the best combination of partial descriptions using multiple hierarchies for describing the movies viewed by a subscriber.

FIG. 21 describes the main steps involved in subscriber specific feature set prediction procedure.

FIG. 22 describes the steps involved in subscriber specific symbolic feature set prediction procedure.

FIG. 23 describes the steps involved in subscriber specific numeric feature set prediction procedure.

FIG. 24 describes the steps involved in subscriber specific popularity chart based final movie selection procedure.

FIG. 24A describes the structure of Popularity Chart table.

FIG. 25 is a description of subscriber specific slot selection procedure.

FIG. 25A describes the steps involved in subscriber specific backup slot identification procedure.

FIG. 26 describes the steps involved in subscriber specific movie/slot matching procedure.

FIG. 26A describes steps involved in subscriber specific slot Ds identification procedure.

FIG. 26B describes steps involved in subscriber specific slot DN identification procedure.

FIG. 27 is a description of subscriber specific weekly plan preparation.

FIG. 28 is a description of the steps involved in the subscriber movie allocation process.

FIG. 28A describes the structure of the PDLA table.

FIG. 28B describes the structure of the IDLA table.

FIG. 28C describes the structure of the DS table.

FIG. 29 describes the preferred demand bulk allocation procedure.

FIG. 30 describes the expected demand bulk allocation procedure.

FIG. 30A is a description of the steps involved in the subscriber ranking procedure.

FIG. 30B is a description of the steps involved in the determination of past favor rating for a subscriber.

FIG. 30C is a description of the steps involved in the determination of past data rating for a subscriber.

FIG. 30D is a description of the steps involved in the determination of the rating due to frequency of past favors.

FIG. 30E is a description of the steps involved in the determination of rating due to past complaints.

FIG. 30F is a description of the steps involved in the determination of rating due to past revenue.

FIG. 30G is a description of the steps involved in the determination of rating due to past viewings.

FIG. 31 is a description of the steps involved in subscriber specific alternate movie allocation procedure.

FIG. 32 depicts the incremental demand scheduling procedure of CVLDS.

FIG. 33 depicts incremental synchronization procedure of CVLDS.

FIG. 34 depicts real-time demand scheduling procedure of CVLDS.

FIG. 35 describes the steps involved in the subscriber movie/slot re-planning procedure.

FIG. 36 depicts the functionality of the CSLM subsystem of CVLDS.

FIG. 37 describes the sequence of various license related activities performed in CSLM.

FIG. 37A describes the sequence of various movie related activities performed in CSLM.

FIG. 38 defines kinds of licenses and licensing policies of CVLDS.

FIG. 38A describes license policy management procedure of CVLDS.

FIG. 38B describes a typical life cycle of a movie.

FIG. 39 describes the steps involved in the return on investment analysis procedure of CVLDS.

FIG. 40 describes steps involved in the buy analysis procedure of CVLDS.

FIG. 40A provides the structure of Acquisition List.

FIG. 40B provides the structure of MAllocationTable.

FIG. 41 describes steps involved in the preferred demand analysis and distribution procedure of CVLDS.

FIG. 41A describes the utility function in evaluating the utilization of licenses.

FIG. 41B describes the cost function in evaluating the incremental cost of license acquisition.

FIG. 42 describes steps involved in the expected demand analysis and distribution procedure.

FIG. 43 describes steps involved in the swapping analysis procedure of CVLDS.

FIG. 43A describes the structure of Swap Analysis list.

FIG. 44 describes the license acquisition procedure of CVLDS.

FIG. 44A describes the structure of AS table.

FIG. 45 describes the movie & pop chart management procedure of CVLDS.

### DETAILED DESCRIPTION OF THE PREFERRED EMBODIMENTS

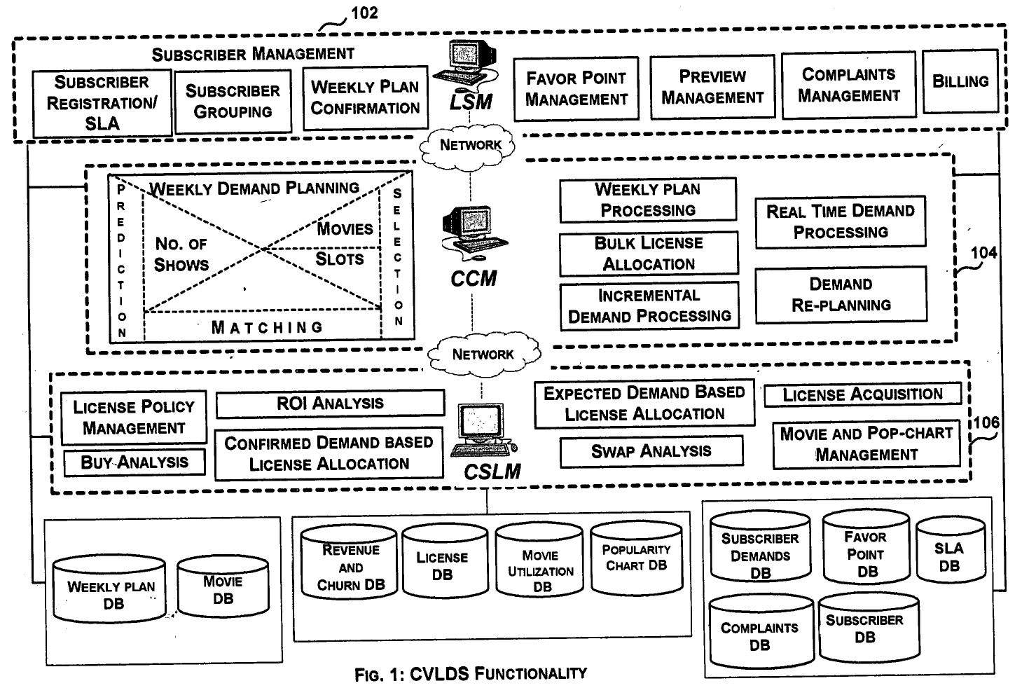

FIG. 1 depicts the complete functionality of the Comprehensive Video License Distribution System (CVLDS) in terms of Local Subscriber Manager (LSM), Community Content Manager (CCM), and Content Storage and License Manager (CSLM). The main objectives of CVLDS are zero reject of requests from subscribers, maximizing the usage of licenses available within the system, and minimizing the churn rate. The proposed invention achieves zero reject objective by (a) defining flexible SLAs; (b) give and take offers; (c) detailed analysis of subscriber viewing pattern; (d) detailed analysis of subscriber requests; (e) showing managed previews; and (f) community viewing centers. The system aims to achieve maximizing of license utilization by (a) defining flexible license policies; (b) planning plausible and anticipatory demands; (c) movie-wise return-on investment analysis; (d) near-optimal demand based license allocation; (e) careful buy/swap decisions; and (f) gap analysis. The system aims to minimize churn rate by (a) flexible favor point management; (b) flexible planning policies; (c) best effort streaming; (d) complaint analysis; (e) billing discounts; and (f) type migrations.

Favor points play an important role in managing subscriber expectations. There are specific clauses defined as part of SLAs in order minimize surprises and formalize the interaction process. Specifically, clauses related to favor points include willingness on part of subscriber to be part of give and take offers, type migration details, and billing discount information. The system uses favor points to accommodate SLA violations by subscribers and also to suggest alternate movies in case of shortage of licenses.

In order to undertake a detailed analysis of subscriber viewing patterns and in order to manage licenses effectively, it is proposed to divide the day into multiple time slots, for example, 24 hours of a day could be divided into 96 slots each of fifteen minutes duration. Further, it is proposed that a subscriber could request for a movie beginning in any one of these slots. Another way of managing licenses is to restrict slot requests based on SLA type. Slot and movie restrictions are also specified explicitly in SLAs. With subscriber movie requests being with respect to slots, it becomes possible to plan and acquire licenses in a best possible way. In order to achieve effective planning, it is proposed to plan for a contiguous number of days and week seems the most appropriate for planning purposes. The idea is to plan for the whole week based on the most probable number of movies a subscriber might watch during the next week. In other words, a detailed analysis is undertaken based on the past data related to a subscriber to arrive at this movie count. Subscriber's privacy is protected by defining a clause in the SLA with regard to data collection for analysis and asking for a confirmation just before the commencement of a movie. Weekly demand planning objective is to determine as much of the movies and their associated slots as possible. This is required in order to meet the twin objectives of zero reject and maximizing of license utilization simultaneously. However, at the same time, it is essential to give as much choice to subscribers as possible. The proposed weekly demand planning balances between these two requirements by bifurcating the demands into “preferred” and “expected” demands. The preferred category of demands is alternatively pessimistic planning in the sense that the objective is to plan just as much as to be able to receive confirmation for these movies and their slots from the subscribers. As system matures, it should be possible to get confirmation for most of the movies subscribers would watch next week this week. This becomes possible as the “preferred” plan offered to subscribers for confirmation is based on the detailed analysis of the viewing patterns of the subscribers. The movies are described using a set of symbolic and numeric features so as to provide an apt description of the movies. Furthermore, these descriptions are related in a hierarchical fashion and multiple such hierarchies are used in identifying movies of interest to subscribers. During weekly demand planning, description of movies watched by subscribers are analyzed with respect to these multiple hierarchies and a symbolic and numeric features set is determined as the one that most suitably describes most of the movies watched by the subscribers. Such a feature set is used along with a filtered popularity chart to identify the movies that would be of interest to subscribers. The next step is to identify the most preferred slots based again on the past data. Finally, the movies are distributed in the selected slots and slotted movies are divided into groups. First group is the “preferred” group that which is sent to subscribers for confirmation; this group is identified so as to achieve confirmation for all or at least most of the movies. Second group is the “expected” group that which is used to request for licenses. Subsequently, after the allocation of licenses for the movies in the “predicted” group, effort is directed towards maximizing the usage of these allotted licenses by undertaking gap analysis. Gap analysis attempts to maximize license utilization by providing “indirect” information about the predicted movies to the subscribers. One of the ways of this propaganda is to show appropriate movies to subscribers at appropriate times. It is essential that subscribers get to watch multiple previews of a movie, called preview capsules, from multiple perspectives to enable the subscriber to select the movie for watching. Another aspect of gap analysis is about show time. The predicted movie for a subscriber is bound to a predicted slot in which the subscriber is expected to watch the movie. It is essential to time the preview appropriately so that the subscriber almost selects the “predicted” slot as the “preferred” slot. In case there is a mismatch between the expected movie/slot with actual movie/slot, it is required to undertake re-planning. Re-planning involves identifying the incremental/real-time demand with closest “expected” demand so as to apply necessary corrections. At the least, is essential to ensure that subscriber does not get to watch a movie twice, once due to subscriber's own request and the second time due to the “expected” demand planning. During the course of a week, subscribers' requests are received and processed. These demands are of two types: incremental demands are the demands that are put on the system much before the show time. SLA defines SLA-type wise restrictions, in the form of booking closing time, on when a subscriber need to request for a movie. In case there is an SLA violation by a subscriber due to the time of booking, favor point policies are invoked to help accommodate the request. The second type of demand is called real-time demand in which a subscriber requests for a movie just before (within fifteen minutes) the show time. In case if a license is not available to meet a request, CCM attempts to negotiate with the subscriber for an adjacent slot/nearest movie as an alternative by trading favor points. Further, the processing of incremental and real-time demands involves collaboration among CCMs to maximize the license utilization across CVLDS.

CCMs consolidate the preferred demands and expected demands, and provide the same to the CSLM requesting grant of licenses. CSLM allocates licenses in such a way that the preferred demands from CCMs are always granted while doing a “best effort” allocation to meet “expected” demands. During license allocation, CSLM identifies movies that are consistently in demand and those that are consistently not in demand. This helps CVLDS to keep licenses for those movies that subscribers would like to watch thereby maximizing the license utilization. The systems employs swapping as a means to relinquish the licenses for movies that are not in demand to obtain licenses for the movies in demand. In order to have flexibility in license management and have good “bargain power” while purchasing licenses, licenses are obtained in three different kinds: BR—bulk reusable, a license kind in which a single license could be used repeatedly without any overlap to stream a movie to a group of subscribers simultaneously; the second kind, BNR—bulk non reusable, in which a single license could be used to stream simultaneously to a group of subscribers only once; the third kind, SNR—single non reusable, in which a single license could be used to stream a movie to one subscriber once. CVLDS obtains multiple licenses of these kinds over a period of time to meet the dynamic demand characteristic of a movie. In order to make predictable purchases of licenses, the system defines a movie life cycle based on the dynamic demand characteristic and is used as a basis for deciding the combination of licenses that need to be purchased based on the life cycle of a movie. The same movie life cycle is also used to identify different kinds of licenses that need to be relinquished. The distribution of available licenses, after the identification of additional licenses to be bought based on watermark analysis, is done in two phases. In each of the two phases, it is required to allocate licenses in a near-optimal way to ensure that the licenses of different license kinds are distributed to ensure the better utilization by first allocating the licenses to the most deserving CCMs. In phase I, the licenses are allocated to meet the preferred demands. This is done as there is a commitment to subscribers by CCMs regarding these movies. The near-optimal allocation is based on the minimization of non-utilization of licenses, due to the bulk nature of two of the licenses kinds, and additional cost incurred due to the need to purchase additional licenses to meet the preferred demands. In phase II, the licenses are allocated to meet the expected demands from the CCMs and this is done in such a way that the return on investment on allotment of licenses to the CCMs is high. For this purpose, the CCMs are ranked on several factors such as movie-wise churn rate, movie-wise incurred expenses and movie-wise revenue earned. These factors are movie-wise as different CCMs could perform differently with respect to different movies. This means that during the allocation of licenses of a movie, preference is given to those CCMs that are performing well with respect to that movie. The license distribution in Phase II is based on maximally allocating the available number of licenses of BR kind, followed by maximally allocating the available number of licenses of BNR kind, and finally maximally allocating the available number of licenses of SNR kind.

The acquisition of licenses of movies is based on buy-swap principle. Typically, licenses are obtained from multiple distributors and it is necessary to build loyalty with the distributors to enjoy special discounts during the purchase of licenses. This is achieved by swapping licenses with those distributors from whom there is a plan to buy additional licenses and quantum of swapping is based on “swap potential” and “swap ratio”.

CSLM also interacts with external entities to obtain pop-chart updates and symbolic and numeric features for the new movies. Pop-charts are used by the CCMs to suggest movies to subscribers during weekly planning, and symbolic and numeric features are used during subscriber specific movie/slot predictions. New movies are handled within the system by showing previews weeks before the license acquisition, obtaining the licenses of SNR kind, allocating them to CCMs based CCMs' overall performance, and suggesting them as alternate movies. New subscribers are handled within the system by making them part of the exception group so that till such time sufficient data becomes available, new subscribers are handled on one-on-one basis. The system addresses complaints by subscribers very effectively and uses the same to identify the potential churn subscribers. By putting an effort to identify potential churn subscribers well ahead of time gives an opportunity to reduce the churn rate. These potential churn subscribers are also made part of the exception group. Exception group also contains those subscribers whose weekly plan prediction has not been very effective and subscribers who have an exceptional favor point “gives” and “takes.” System handles shortage of licenses in case of popular movies by managing community viewing centers. The movies for these CVCs are scheduled during weekly planning by CCMs and the scheduled movies are shown during the scheduled time periods. The preview management shows the previews of movies scheduled in CVCs, thereby enabling subscribers to plan watching of the movies in CVCs. FIG. 1 describes the overall system functionality. LSM 102, CCM 104 and CSLM 106 are the three major system components. Weekly Plan DB, Movie DB, Revenue and Churn DB, License DB, Movie Utilization DB, Popularity Chart DB, Subscriber Demands DB, Favor Points DB, Complaints DB, Subscriber DB, and SLA DB are the plurality of databases that are part of the system.

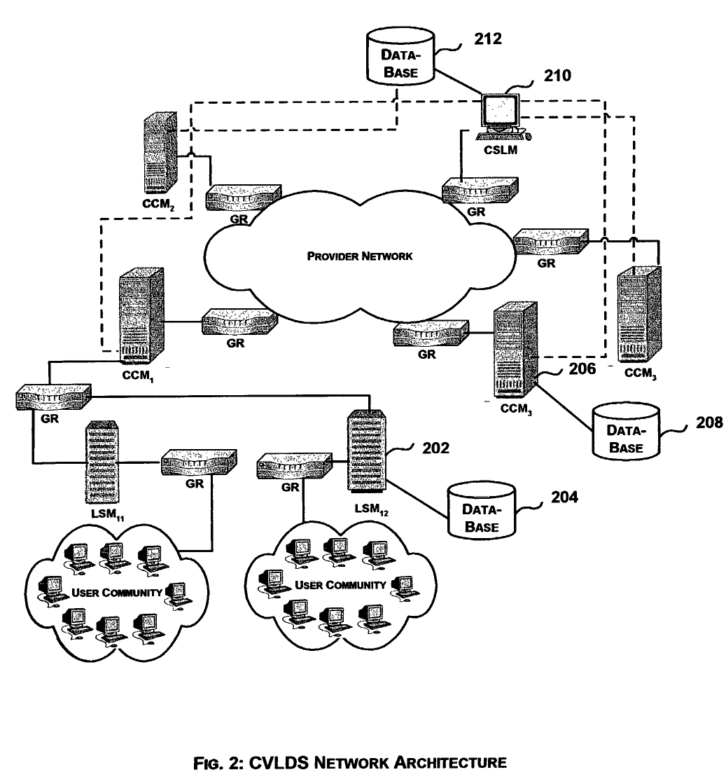

FIG. 2 is a network architecture depicting the interconnections between LSM, CCM and CLSM in a provider's network in accordance with a preferred embodiment of the present invention. Every LSM 202 manages a group of subscribers in a community and one or more of LSMs are connected to CCM. Every LSM establishes communication with subscribers in the LSM specific community, for crafting and modifying SLAs, for receiving complaints from the subscribers and for managing previews. Further, LSM establishes communication with subscribers and its CCM during weekly plan confirmation and for movie streaming. Also, LSM maintains/accesses databases, 204 and 208, for storing/retrieving favor point rules, favor points, complaints, and previews. Each CCM 206 is connected to CSLM and multiple LSMs. The CCM maintains/accesses databases, 208 and 212, for preferred and expected demand planning, movie, and pop-chart details. Further, CCM establishes communication with CSLM for sending consolidated preferred and expected demands and for receiving allocated license tables. CCM also establishes communication with subscribers for movie streaming. Each CSLM 210 is connected to multiple CCMs. CSLM establishes connection with external entities for receiving movie, hierarchy, and pop-chart updates. Further, CSLM maintains database 212 for ranking CCMs and for movie description, movie license, hierarchy, and pop-chart updates. Also, CSLM establishes communication with CCMs for sending pop-chart information with distinct ordering of movies for each of the CCMs.

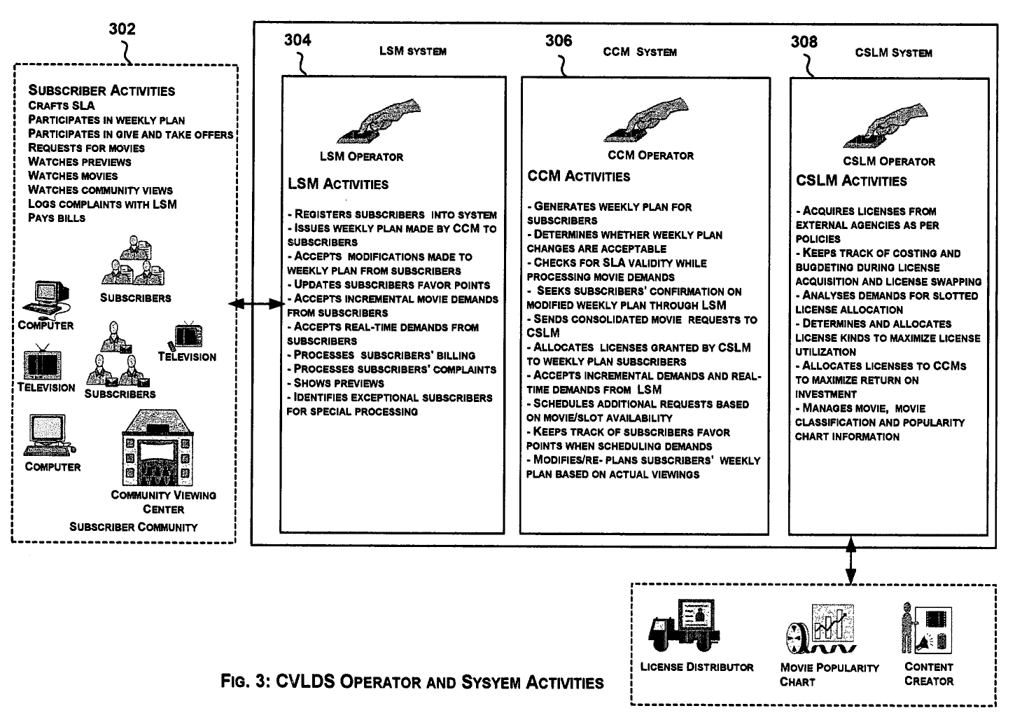

FIG. 3 is a schematic representation of CVLDS depicting various subscriber activities in 302, LSM specific operator related activities and system activities in 304, CCM specific operator related and system activities in 306, and CSLM specific operator related and system activities in 308.

The subscriber activities 302 comprising SLA crafting, participating in weekly plan, participating in give and take offers, requesting for movies, watching previews, watching movies, watching community views, lodging complaints with LSM and paying bills.

The LSM specific activities 304 comprising registering subscribers into system, issuing WP made by CCM to subscribers, accepting modifications made to WP by subscribers, accepting incremental movie demands from subscribers and accepting real-time demands from subscribers. Further, the said LSM specific activities also include updating subscribers' FP, processing subscribers' billing, processing subscribers' complaints, showing previews and identifying exceptional subscribers for special processing.

The CCM specific activities 306 comprising generating weekly plan for subscribers, determining whether weekly plan changes are acceptable, checking for SLA validity while processing movie demands, seeking subscribers confirmation on modified weekly plan through LSM, sending consolidated movie requests to CSLM, allocating licenses granted by CSLM to weekly plan subscribers, accepting incremental demands and real-time demands from LSM, scheduling additional requests based on movie/slot availability, keeping track of subscribers' favor points when scheduling demands, and modifying/re-planning subscribers' weekly plan based on actual viewings.

The CSLM specific activities 308 comprising acquiring licenses from external agencies as per policies, keeping track of costing and budgeting during license acquisition and license swapping, analyzing demands for slotted license allocation, determining and allocating license kinds to maximize license utilization, allocating licenses to CCMs to maximize return on investment, managing movie information, movie classification information and pop-chart information.

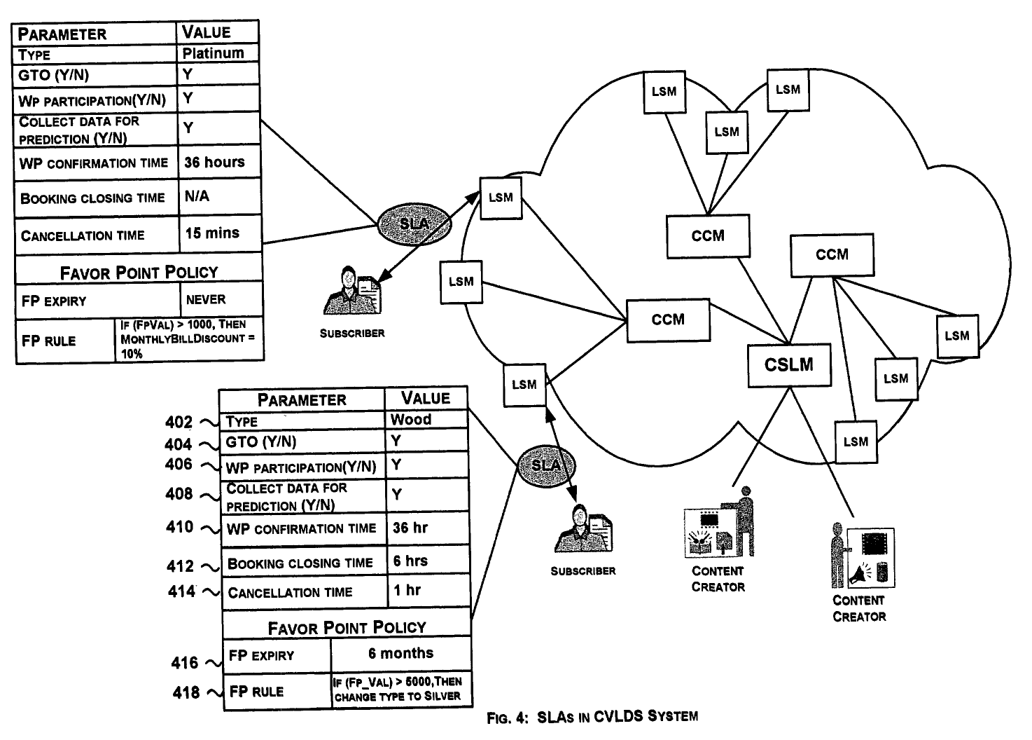

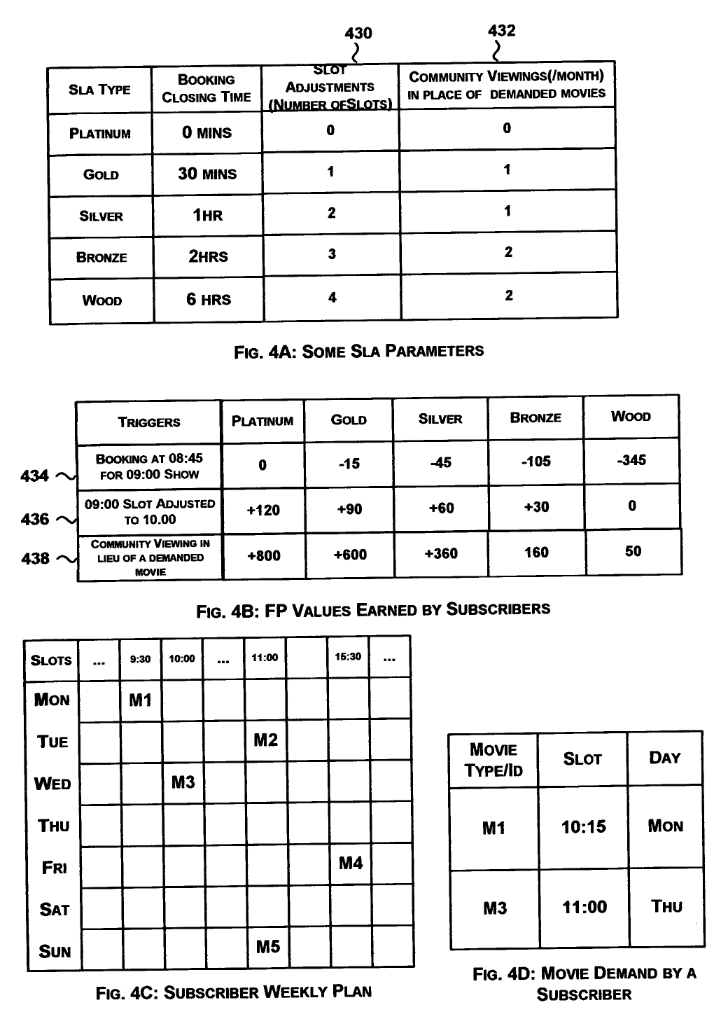

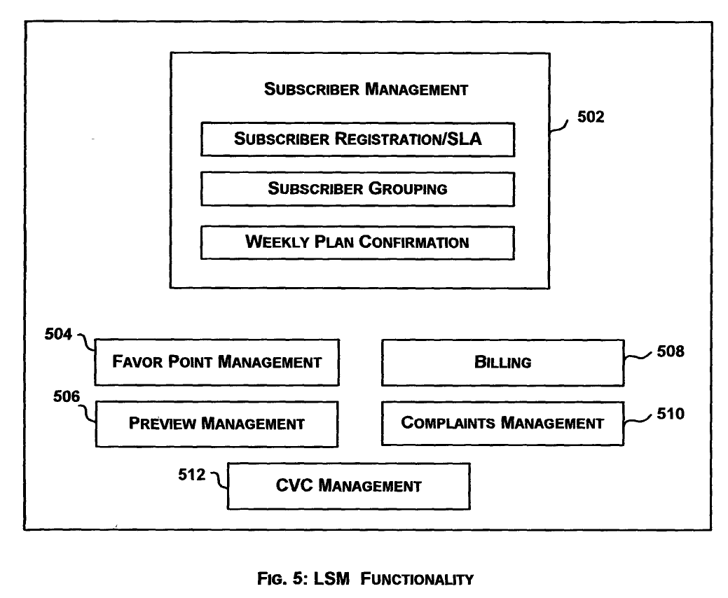

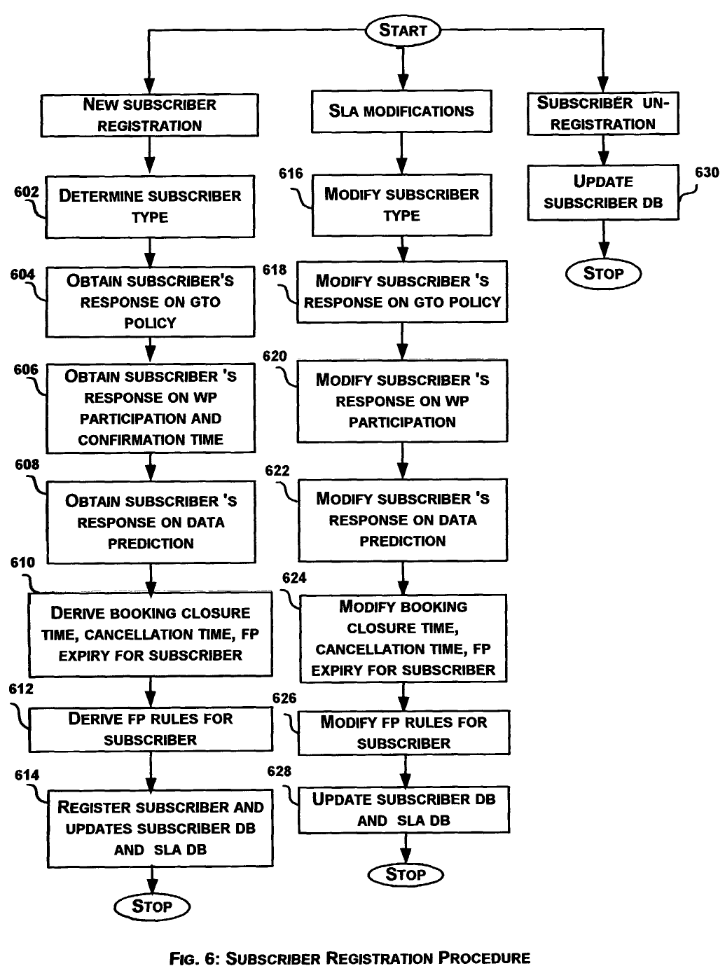

FIG. 4 describes sample SLAs containing CVLDS specific parameters.

The “Type” parameter 402 describes the type of subscriber which can be one of “Platinum.” “Silver,” “Gold,” “Bronze” and “Wood.”

The “GTO (Y/N)” parameter 404 in SLA gives subscriber an option to be eligible for favor points.

The “WP participation (Y/N)” parameter 406 in SLA gives subscriber an option to participate in weekly planning of movie schedules and this in turn aids the system in removing subscribers from the weekly planning activities if WP participation is not selected.

The “Collect data for prediction (Y/N)” parameter 408 allows subscriber to share movie viewing information. This parameter value is forced to “Y” value if WP participation parameter value is “Y.”

The “WP confirmation time” parameter 410 suggests subscriber to confirm the received

WP within the agreed upon confirmation time.

The “Booking closing time” parameter 412 enforces the subscribers to request for movie before a pre-defined time.

The “Cancellation time” parameter 414 allows the subscriber to cancel a movie within a pre-defined time.

Favor Point Policy details in SLA defines subscriber specific favor point policies.

The “FP Expiry” parameter 416 is subscriber specific and defines the maximum life span of the accumulated FP value for the subscriber.

The “FP rule” parameter 418 is subscriber specific and defines one or more rules for processing favor points.

FIG. 4A gives sample values for some SLA parameters for various subscriber types. Slot Adjustment parameter 430 describes the number of slots by which a subscriber request could be preponed or postponed. Community Viewings parameter 432 describes the number of requested movies that could be watched in a CVC.

FIG. 4B gives subscriber type based sample FP values earned by subscribers for various give and take activities resulting in positive or negative favor points. Trigger 434 describes the deducted number of favor points when requested for a movie after the booking closing time. The amount of favor points deducted is based on booking closing time as per SLA of subscriber and actual booking time of request. Trigger 436 describes the added number of favor points whenever slot adjustment is made to meet subscriber request, which is based on slot adjustment parameter as per SLA and the number of slots actually adjusted. Trigger 438 describes the added number of favor points whenever subscriber watches a movie in CVC.

FIG. 4C gives sample subscriber weekly plan across a week for all days and for all slots.

FIG. 4D depicts the format in which subscribers demand for a movie.

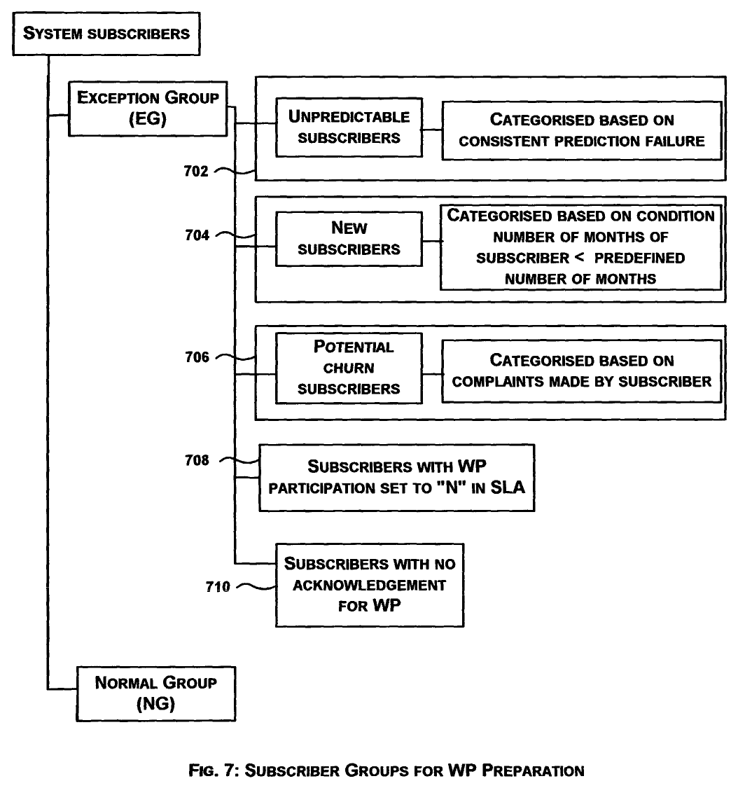

FIG. 5 depicts the functionality of the LSM subsystem of the present invention. The LSM subsystem comprises of a Subscriber Management Component 502, Favor Point Management Component 504, Preview Management Component 506, Billing Component 508, Complaint Management Component 510 and a Community View Center Management Component 512.

The Subscriber Management Component 502 is responsible for managing SLAs, subscriber group identification, and managing weekly plan confirmation.

The Favor Point Management Component 504 is responsible for managing FP specific SLA parameters, FP policies, and FP-based subscriber migrations. Further, the above component is in charge of computing subscriber specific favor points based on favor point triggers generated during transaction processing.

The Preview Management Component 506 is responsible for managing URL based, sponsor based and login time previews. The previews shown are subscriber specific and consist of a list of previews of forthcoming, subscriber confirmed, subscriber specific expected movies and community movie related previews.

The Billing Component 508 is responsible for managing subscriber bill discounts based on subscriber specific FPs.

The Complaint Management Component 510 is responsible for performing root cause analysis of complaints and complaint based subscriber churn analysis.

The Community View Center Management Component 512 is responsible for arranging regular shows at community centers. The movies selected for showing in community centers are based on license availability and demand for the movies.

FIG. 6 is a flowchart that describes subscriber registration procedure for crafting SLAs for newly registered customers in the system, modifying SLA's of existing customers and handling unregistration of subscribers in CVLDS.

Steps 602-614 describe steps for registering new subscribers into the system.

Step 602 determines the type of the new subscriber wherein the type is one of “Platinum,” “Gold,” “Silver,” “Bronze” and “Wood.” Subscriber selects the appropriate type based on the services associated with the particular type.

Step 604 obtains subscriber's response on GTO, wherein if the subscriber is part of GTO, the subscriber becomes eligible for favor point based discounts.

Step 606 obtains subscriber's response on WP participation and confirmation time.

Participating in weekly plan by selecting “Y” for WP participation entails subscriber to a discount and further enrolls subscriber for weekly planning. If the system does not receive confirmation for communicated WP from subscriber within WP confirmation time, the subscriber will not be part WP processing and as a consequence, subscriber will not be eligible for WPP discount for that week.

Step 608 obtains subscriber's response on data prediction and based on the response, subscriber's movie viewing information such as movie type and time of watching is gathered and made available for weekly planning.

Step 610 derives values for the parameters such as booking closing time, cancellation time, and FP Expiry based on default and negotiated values for these parameters.

Step 612 derives FP rules based on subscriber 's response on a set of default FP rules defined in CVLDS.

Step 614 registers a subscriber into CVLDS and further, Subscriber DB and SLA DB are appropriately updated.

Steps 616-628 describe steps for modifying SLAs related to existing subscribers in CVLDS.

Step 616 modifies type of a subscriber based on the services requested by the subscriber. The new modified type will come into effect from the next immediate WP processing.

Step 618 modifies subscriber's response on GTO. If the modification is from “N” to “Y,” then accumulation and processing of favor points will come into immediate effect. On the other hand, if the modification is from “Y” to “N,” then accumulation of FP will stop with immediate effect while processing of so far accumulated FP will continue until either FP expires or is exhausted.

Step 620 modifies subscriber 's response on WP participation. If the modification is from “N” to “Y,” then WP processing begins from next immediate WP processing provided sufficient past gathered data is available for analysis. If sufficient data is not available, WP processing is delayed until sufficient data becomes available. Further, the value of Collect data for prediction parameter is set to “Y” if it is not already “Y.” On the other hand, if the modification is from “Y” to “N,”

then WP processing stops from next immediate WP processing.

Step 622 modifies subscriber's response on data prediction. If the modification is from “N” to “Y,” then gathering of data will commence immediately. On the other hand, if the modification is from “Y” to “N,” then gathering of data will stop with immediate effect provided the value of the parameter WP participation is “Y.”

Step 624 modifies values for the parameters, such as booking closing time, and cancellation time and FP expiry, for a subscriber and these modified values come into immediate effect.

Step 626 modifies/deletes existing FP rules and adds new FP rules for a subscriber and these rules come into immediate effect.

Step 628 updates Subscriber DB and SLA DB appropriately.

Step 630 describes step for subscriber unregistration from CVLDS. Step 630 un-registers the subscriber from CVLDS and updates Subscriber DB appropriately.

FIG. 7, Subscriber Groups for WP Preparation, exhibits schematic representation of plurality of subscriber groups. Based on a set of conditions, subscribers become a part of the exception group as they fail test for predictability and the subscribers of this group are candidates for special attention. The subscribers not belonging to the exception group become part of the normal group and are the candidates for WP processing. Partitioning of subscribers of CVLDS into exception group and normal group is to help reduce the subscriber churn and in order to make better predictions.

Steps 702-710 describe various conditions under which subscribers are categorized into the exception group.

In step 702, unpredictability condition under which subscribers are made part of the exception group is specified where the unpredictability condition checks for consistent prediction failure. The consistent failure prediction can be determined based on (a) corrections made by a subscriber to the communicated WP; and (b) low correlation between expected demands and incremental/real-time demands.

In step 704, newness condition under which subscribers are made part of the exception group is specified where the newness condition check is based on the joining date of subscribers. New subscribers are unpredictable due to unavailability of sufficient data for prediction.

In step 706, potential chum condition under which subscriber is made part of the exception group is specified. The objective is not to loose potential churn subscribers in due course of time due to unexpected WP prediction errors. The potential churn subscribers are identified based on the consistency of complaints made by the subscribers.

In step 708, WP participation condition under which a subscriber is made part of the exception group is specified. The WP participation condition checks whether the SLA parameter, WP participation, is set as “N” for the subscriber. One of the reasons why a subscriber may opt out of WP processing is inhibition to share movie viewing information. In CVLDS, it is proposed to selectively gather movie/slot information even if the SLA parameter, WP participation, is set to “Y” by requesting subscriber permission just before the commencement of a movie.

In step 710, NACK for WP condition under which a subscriber is made part of the exception group is specified. The NACK for WP condition checks whether there was a failure on part of the subscriber to acknowledge the subscriber's WP within WP confirmation time.

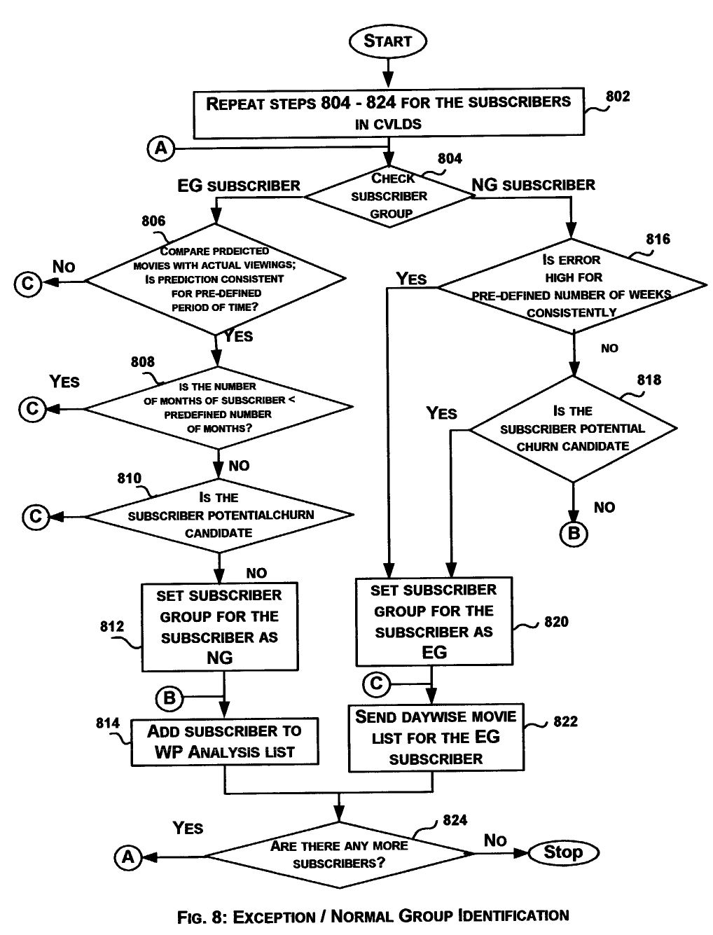

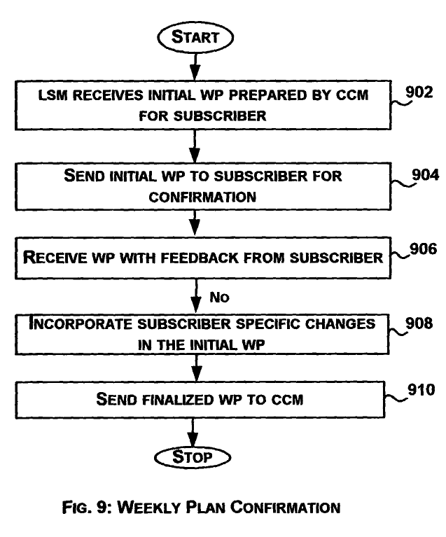

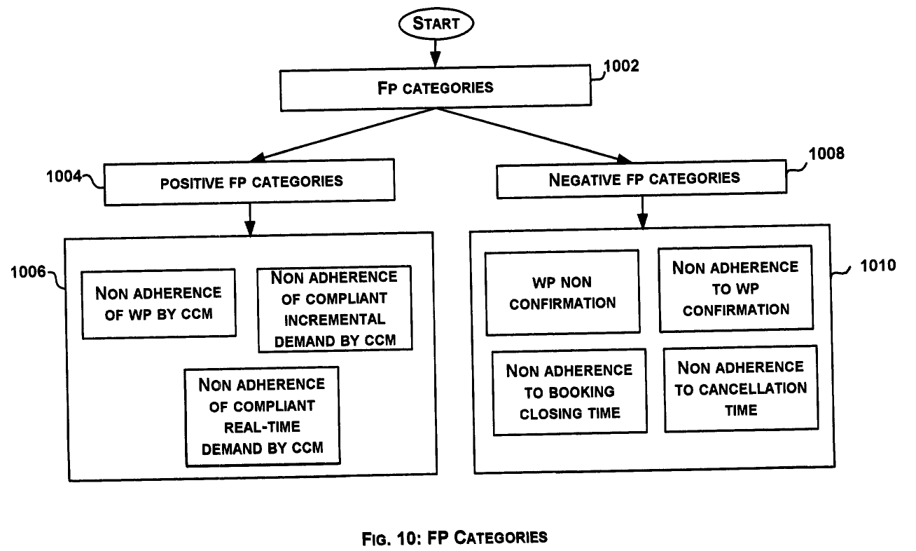

FIG. 8 describes Exception/Normal Group Identification procedure for identifying subscribers belonging to exception group and normal group of CVLDS. Exception Group Identification procedure is performed every week prior to WP processing. Subscribers of exception group are given specialized attention by sending manually selected day-wise movie list as a guide for movie selection and WP processing is performed for subscribers of normal group.

In step 802, steps 804-824 are repeated for all subscribers in CVLDS. Step 804 checks whether a subscriber belongs to normal or exception group. If the subscriber belongs to exception group, processing beginning from step 806 is performed and otherwise processing beginning from step 816 is performed.

Step 806 checks whether a subscriber has been predictable for a pre-defined number of weeks. During WP processing, the subscribers in exception group who are part of WP processing are analyzed separately with as much available past data to arrive at a predicted movie list for each of these subscribers. The week-wise comparison of this predicted list for these subscribers with actual viewings would help in identifying the predictability of the subscribers. If a subscriber is not yet consistently predictable, the subscriber continues to remain in the exception group (step 822). Otherwise step 808 is performed.

Step 808 checks whether the number of months of a subscriber in the exception group is less than a pre-defined number of months, that is, checks whether the subscriber is a new subscriber of CVLDS. If the subscriber is a new subscriber, then the subscriber is retained in the exception group (step 822). Otherwise step 810 is performed.

Step 810 checks whether a subscriber in the exception group is a potential churn candidate. If the subscriber is a potential churn candidate, then the subscriber is retained in the exception group (step 822). Otherwise step 812 is performed.

In step 812, the subscriber is marked as normal group subscriber and further, in step 814 the subscriber is added to WP analysis list.

Step 816 checks whether prediction error for the normal group subscriber has been high consistently for a pre-defined number of weeks. If the prediction error related to the subscriber is consistently high, then the subscriber is moved to exception group in step 820 and step 822 is performed. Otherwise step 818 is performed.

Step 818 checks whether normal group subscriber has become a potential churn candidate. If the subscriber is a potential churn candidate, then the subscriber is moved to exception group in step 820 and step 822 is performed. Otherwise step 814 is performed.

In step 822, manually prepared day-wise list is communicated to exception group subscribers.

Step 824 checks whether there are any remaining subscribers to be categorized into exception/normal groups.

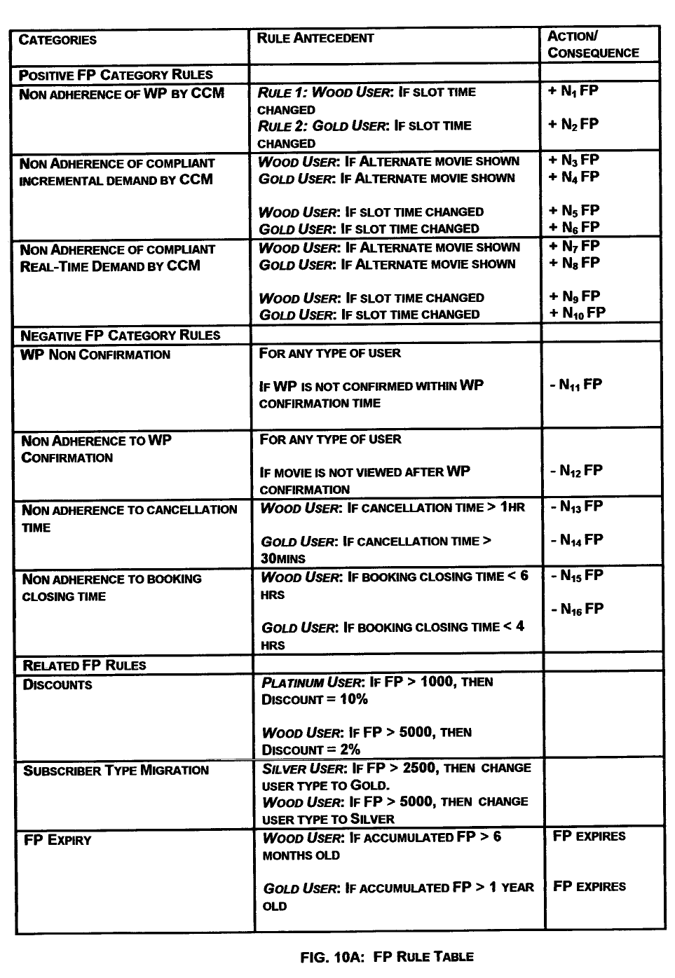

FIG. 9 describes the Weekly Plan Confirmation process for a subscriber. WP is prepared for all subscribers in the normal group based on the available movies and their licenses. As the WP is based on prediction using past viewing pattern, it is necessary to get a subscriber confirmation to ensure maximum utilization of obtained licenses. While the confirmation process itself might lead to changes in subscriber WP, these changes are incorporated to meet the subscriber expectations. Maturity in the prediction process that is part of WP preparation leads to reduced prediction error thereby resulting in minimal changes during WP confirmation.

In step 902, LSM receives initial WPs for subscribers of the LSM from CCM. In step 904, the initial WP is sent to the subscriber for confirmation. In step 906, the WP is received from the subscriber with feedback on the movies/slots provided in the initial WP. LSM validates the received WP from a subscriber for SLA compliance and if required LSM operator negotiates with the subscriber to arrive at an SLA compliant WP. In step 908, the changes made to the WP by the subscriber are incorporated to arrive at finalized WP. Step 910 sends the finalized WP to CCM.

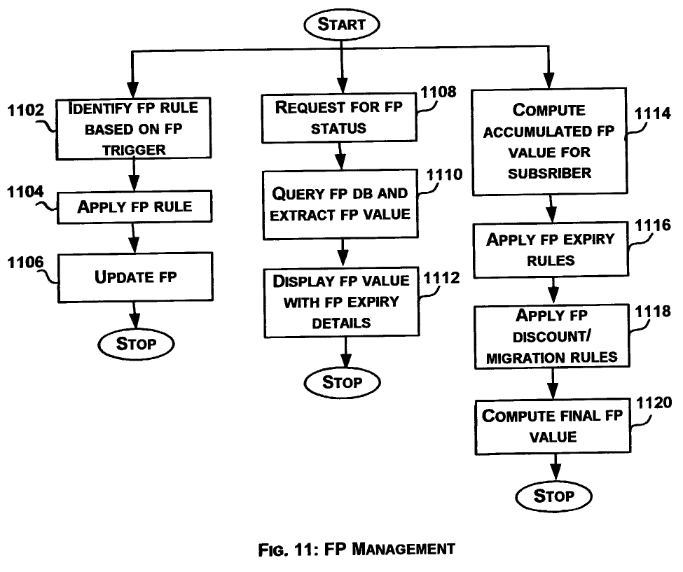

FIG. 10 describes the various types of FP categories (step 1002). Many subscriber activities and interactions result in modifications to FPs. FPs are introduced into CVIDS to manage situations arising due to SLA violations and shortage of licenses. Some of these activities result in increase in favor points and these activities are collectively called positive FP categories (step 1004) and these are the activities in which subscriber has favored the system by accommodating system requests. Step 1006 provides multiple positive FP categories. The positive FP category, Non-adherence of WP by CCM, is to account for situations such as SLA parameter based slot adjustments, on the confirmed WP by subscriber, automatically done by the system. The positive FP category, Non-adherence of compliant incremental demand by CCM, is to account for situations such as movie/slot adjustments suggested by the system to meet the incremental subscriber demand. The positive FP category, Non-adherence of compliant real-time demand by CCM, is to account for situations such as movie/slot adjustments suggested by the system to meet the real-time subscriber demand.

Some subscriber activities and interactions result in non-compliance of SLA by the subscriber and these activities, collectively called negative FP categories (step 1008), result in decrease in FPs. Step 1010 provides multiple negative FP categories. The negative FP category, WP non-confirmation, is to manage situations such as failure on part of subscriber to confirm WP within SLA defined confirmation time. The negative FP category, non-adherence to WP confirmation, is to manage situations such as failure on part of subscriber to watch movies as per confirmed WP. The negative FP category, non-adherence to booking closing time, is to manage situations such as failure on part of subscriber to demand movies within SLA defined booking closing time. The negative FP category, non-adherence to cancellation time, is to manage situations such as failure on part of subscriber to cancel movies as per SLA defined cancellation time.

FIG. 10A is a table describing the various FP categories and their associated FP rules. The Action/Consequence column of the table indicates the resulting value of FP due to this rule after the rule is applied. For example, +N₁ FP indicates that N₁ favor points will be added to the total accumulated FP value after the successful application of rule 1.

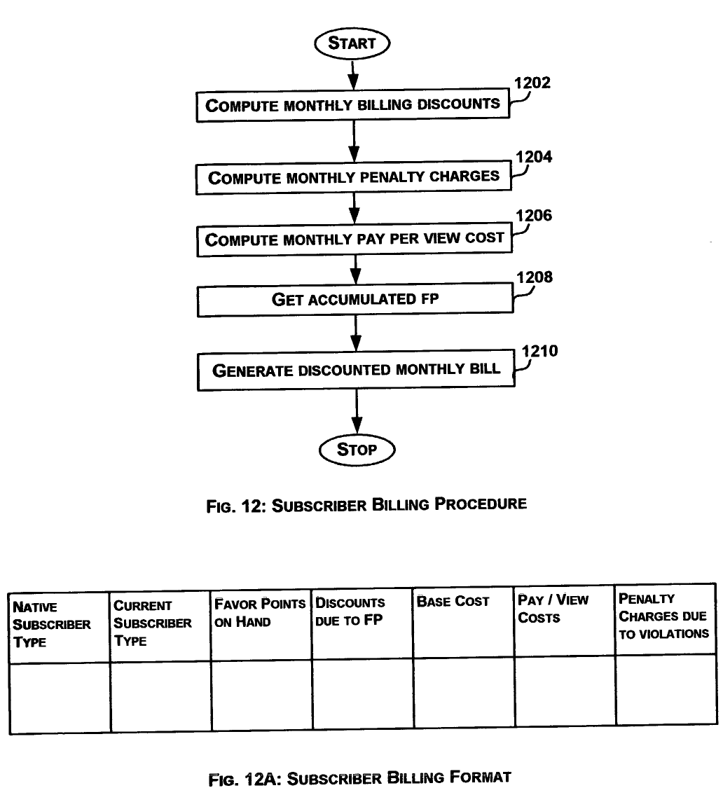

FIG. 11 depicts the FP Management Module. The module performs the activities of FP trigger analysis, current FP status determination and computation of accumulated FP value.

In step 1102, the FP trigger is analyzed and the corresponding subscriber specific FP rule is identified. In step 1104, the FP rule associated with the trigger is applied resulting in positive or negative FP value. In step 1106, the FP value is used to update Favor Point DB.

Steps 1108-1112 process subscriber specific queries related to favor points.

In step 1108, the subscriber specific query is analyzed to form a suitable database query.

In step 1110, the FP database is queried and the current FP value is extracted. In step 1112, the current FP value along with expiry and discount details are displayed.

Steps 1114-1120 compute subscriber specific monthly billing discounts based on favor points.

In step 1114, accumulated FP value is obtained from Favor Point DB. In step 1116, the appropriate FP expiry rules are applied on the current accumulated FP value. In step 1118, the appropriate FP discount/migration rules are applied on the resulting accumulated FP value. In step 1120, the resulting accumulated FP value is updated onto Favor Point DB.

FIG. 12 describes the monthly Subscriber Billing Procedure.

In step 1202, subscriber specific applicable monthly discount is obtained. In step 1204, the monthly penalty charges if any are determined. The triggers such as successive non-confirmation of WP impose penalty charges. In step 1206, the total cost due to pay per views is computed. In step 1208, the latest subscriber specific FP value is obtained and further, in step 1210 discounted monthly bill is generated.

FIG. 12A describes the subscriber billing format.

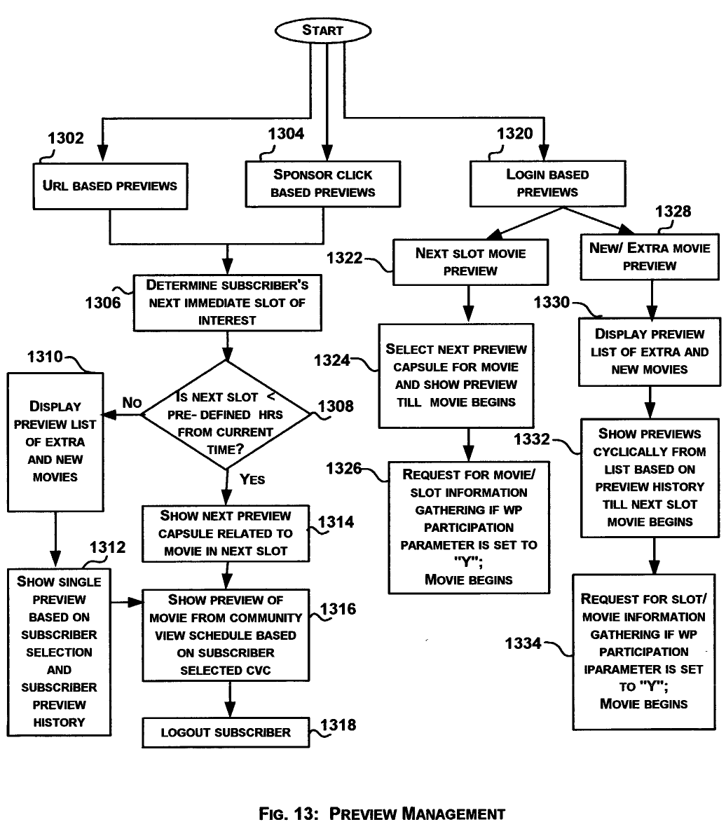

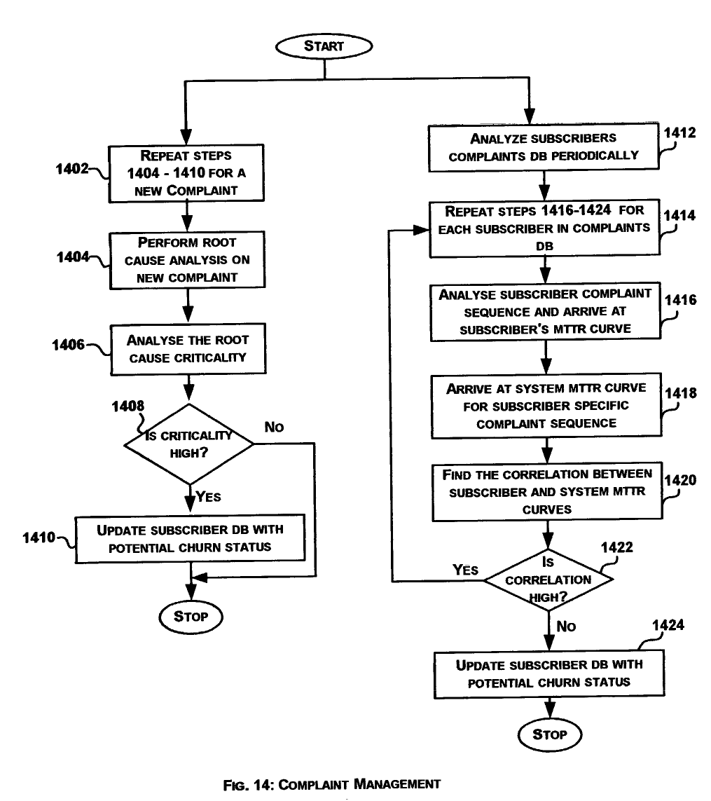

FIG. 13 depicts the Preview Management Module. Preview management plays an important role in maximizing the utilization of obtained licenses wherein sufficient needed information regarding preferred and expected movies identified for a subscriber is provided in a most effective manner. Subscriber specific preview management involves systematically showing previews related to preferred and expected movies. Further, the previews need to be managed dynamically as incremental demands and cancellations occur. Also, previews of extra movies, where the extra movies are movies for which excess licenses are available, and forthcoming movies need to be managed across subscribers. The preview associated with a movie consists of independently viewable multiple preview capsules. Showing of a preview of a movie for a subscriber is based on showing one preview capsule at a time and scheduling the previewing of multiple capsules in such a way as to uniformly show all preview capsules. Further, it is necessary to show these previews at such a time so as to derive maximum benefits.

Previews of movies can be invoked by the subscriber in one of three ways, namely, URL based, sponsor based and login time previews. Subscriber specific previews are made available from a pre-defined URL. In order to draw more attention to these previews, the previews can also be accessed through sponsor clicks. Step 1302 processes URL based preview requests and step 1304 processes sponsor click based preview requests. In step 1306, the subscriber's next immediate slot of interest is determined based on the current time. This determination is to enhance the subscriber's interest by showing the preview for the next immediate movie that is expected to be watched. In step 1308, a check is made to determine if the next immediate slot of interest to the subscriber is a pre-defined number of hours away from the current time. If the condition in the above step is not satisfied, step 1310 is executed otherwise step 1314 is executed. This condition is checked is to ensure that the previews are shown at the most appropriate time to derive maximum benefits. In step 1310, a preview list consisting of new (that is, forthcoming) and extra movies is displayed to the subscriber. The preview of each movie consists of one or more preview capsules. A single preview capsule displays a distinct preview of the movie. The system consults the subscriber's preview history to determine the last movie and the corresponding preview capsule viewed by the subscriber. The preview capsules for movies are shown to the subscriber in a round-robin fashion so that the most recently displayed preview capsule is not repeated within a short period of time for the same subscriber. In step 1312, the preview capsule is selected from the above list and is shown to the subscriber.

In step 1314, the next preview capsule related to movie in the next slot is shown to the subscriber. In step 1316, a list of movies scheduled in community viewing centers is displayed and upon selection of a CVC by the subscriber, appropriate preview capsule based on the subscriber specific preview history is shown. In step 1318, the preview history is suitably updated before logging out the subscriber.

Step 1320 describes login based preview process. Subscribers log into the system to watch movies of their interest. As the show times are slotted in CVLDS, typically a short time is available before the commencement of movie. It is proposed to utilize this time to show previews in order to enhance the license utilization. The subscriber has two options that include viewing the preview of a movie related to the next slot or viewing previews of new and extra movies.

In step 1322, the preview of a movie related to the next slot is chosen based on subscriber specific preview history. In step 1324, the chosen preview capsule is shown to the subscriber and the preview history is suitably updated. Steps 1322-1324 are repeated until the commencement of the movie. In step 1326, the subscriber's permission for movie/slot information gathering is obtained before initiating the streaming of the movie.

In step 1328, a preview list consisting of new/extra movies is displayed to a subscriber. In step 1330, on selection of a particular movie from the preview list by the subscriber, an appropriate preview capsule is selected based on the preview history and is shown to the subscriber in step 1332. Steps 1330-1332 are repeated until the commencement of the movie. In step 1334, the subscriber's permission for movie/slot information gathering is obtained before initiating the streaming of the movie.

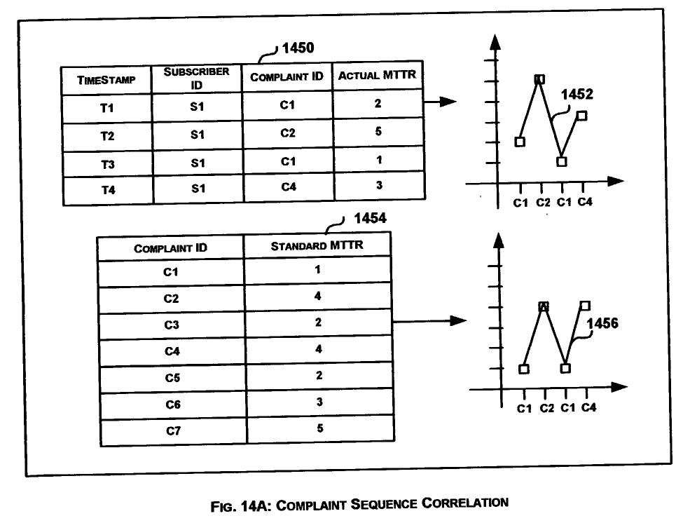

FIG. 14 describes complaint management activities performed by LSM. Compliant management activity comprises of analyzing new and existing complaints of subscribers of CVLDS. Based on the criticality of new complaints and consistency of the old complaints, a subscriber is marked as potential churn candidate. This helps the system in reducing subscriber churn across the system by giving individual attention to subscribers with critical and consistent complaints.

Steps 1402-1410 of complaint management procedure is repeated for analyzing every new complaint that is received by LSM and steps 1412-1424 of complaint management procedure is repeated periodically for analyzing Complaints DB where the analysis is performed for identifying potential churn candidates.

In step 1402, steps 1404-1410 are repeated for any new complaint received by LSM. In step 1404, root cause analysis is performed on the new complaint. Root cause analysis is performed in order to identify the cause and this identification helps in eliminating multiple related complaints. LSM operator performs the root cause analysis, initiates necessary actions to rectify the root cause, and identifies the criticality of the root cause. In step 1406, the criticality of the complaint is evaluated. Step 1408 checks whether criticality of the new complaint high. If the criticality is high, in step 1410, the subscriber related to the complaint is marked as potential churn candidate and Subscriber DB is suitably updated.

In step 1412, periodic analysis of Complaints DB is performed. In step 1414, steps 1416-1424 are repeated for all subscribers in Complaints DB.

In step 1416 of complaint management procedure, all the complaints received from the subscriber for a pre-defined period of time are analyzed and a complaint sequence for the subscriber is formed. Further, based on the complaint sequence, subscriber's MTTR curve is arrived at based on the time taken to close each of the complaints in the complaint sequence.

In step 1418, for the same set of subscriber specific complaints sequence obtained in step 1416, system's MTTR curve is arrived at based on the standard time defined for closing each of the complaints in the complaint sequence.

Step 1420 determines the correlation between subscriber's MTTR curve and system's MTTR curve and further, step 1422 checks whether the correlation between subscriber's MTTR curve and system's MTTR curve is high. In step 1424, if the correlation is low, the subscriber is marked as potential churn candidate in Subscriber DB.

FIG. 14A describes the correlation of subscriber specific complaint MTTR sequence with respect to system MTTR sequence. Table 1450 provides a sample sequence of complaints related to a subscriber and the actual MTTR for closing each of the complaints in the sequence. Graph 1452 provides the subscriber specific MTTR curve for the complaints sequence described above. Table 1454 provides standard MTTR for the possible complaints. Step 1456 provides system MTTR curve for the above described subscriber specific complaint sequence.

FIG. 15 depicts the functionality of the CCM subsystem of the present invention. The CCM subsystem comprises of a Demand Planning Component 1502, a Bulk License Allocation Component 1504, an Incremental Demand Processing Component 1506, a Real-Time Demand Processing Component 1508, a Periodic Demand Re-planning Component 1510, and a Weekly Plan Processing Component 1512.

The Demand Planning Component 1502 of the CCM subsystem is responsible for predicting the number of shows that a subscriber is likely to view in the coming week, selecting a set of movies and slots for the coming week, and matching the selected movies to the identified slots by a detailed analysis of the subscriber's past movie viewing patterns. Efficient license management requires a good knowledge of the possible demands for movies. The system capable of a good prediction of this demand is in a position to utilize available licenses very effectively. Near VOD systems may not normally request directly subscribers to provide their movie viewing plan for obvious reasons. As a consequence, it is required to get this information in a more systematic way. The present invention makes a detailed analysis of the past data of a subscriber to arrive at the subscriber specific weekly movie viewing plan that almost matches with the subscriber's expectations. Higher this match for most of the subscribers in the system, better will be the license utilization. The present invention proposes to achieve a higher degree of match by identifying a portion of the planned demand for a subscriber confirmation and this portion is identified in such a way there is a high possibility of the subscriber accepting and confirming this portion of the plan. This portion of the plan is referred to as preferred demand. The remaining portion of the plan is referred to as expected demand and is used to optimistically plan for the license requirements.

The Bulk License Allocation Component 1504 of the CCM subsystem is responsible for the allocation of allotted licenses, by CSLM, to meet the preferred demands. Further, this component is also responsible for the allocation of allotted licenses to meet the expected demands using favor point based subscriber ranking. Bulk license allocation is necessary to assure streaming of movies to the subscribers who have already confirmed the WP and for better utilization of remaining licenses via preview management.

The Incremental Demand Processing Component 1506 of the CCM subsystem is responsible for analyzing and scheduling of incremental demands of subscribers and for generating FP triggers and the Real-Time Demand Processing Component 1508 of the CCM subsystem is responsible for analyzing and scheduling of near real-time demands of subscribers and for generating FP triggers. The confirmed weekly plan of a subscriber addresses a portion of the possible movie requests from the subscriber. Hence, remaining demands from the subscriber are expected to happen over a period of time during the course of the week. These remaining demands from subscriber are received much before the show timing in the form of incremental demands or just before the show timing in the form of real-time demands.

The Periodic Re-Planning Component 1510 of the CCM subsystem is responsible for modifying subscriber specific weekly plan based on the comparison of planned and actual viewings. Re-planning is needed whenever the subscriber was unable to view movies as per the plan to meet an alternative expectation of the subscriber to view the same or an equivalent movie at a future appropriate time slot.

Weekly Plan Processing Component 1512 of the CCM subsystem is responsible for the preparation of subscriber specific weekly plan consisting of preferred demand and expected demand from subscribers. WP processing is a periodic activity in CVLDS and in a preferred embodiment “week” has been chosen as this period. However, this period could alternatively be chosen either as day or as month. Week in particular has an advantage of including within the planning period both weekdays and weekends in which a typical subscriber's behavior differ significantly.

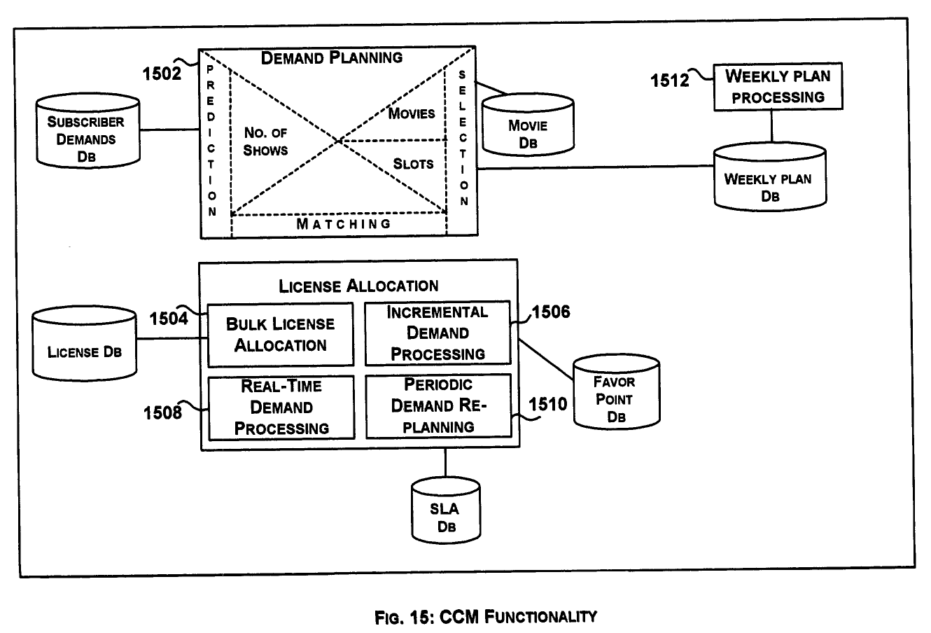

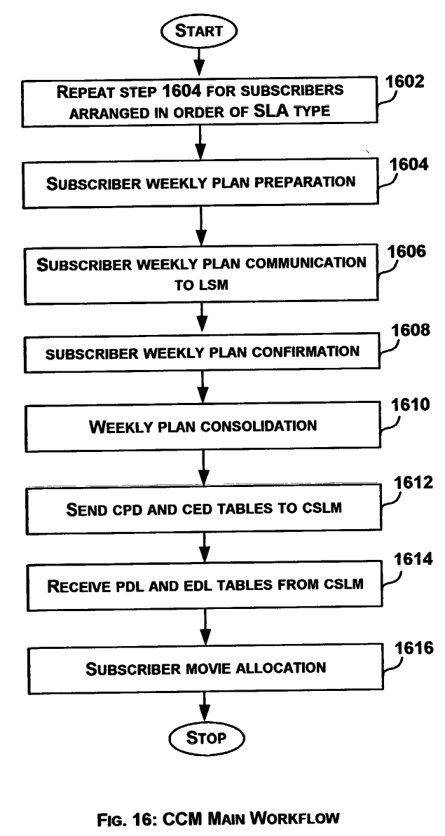

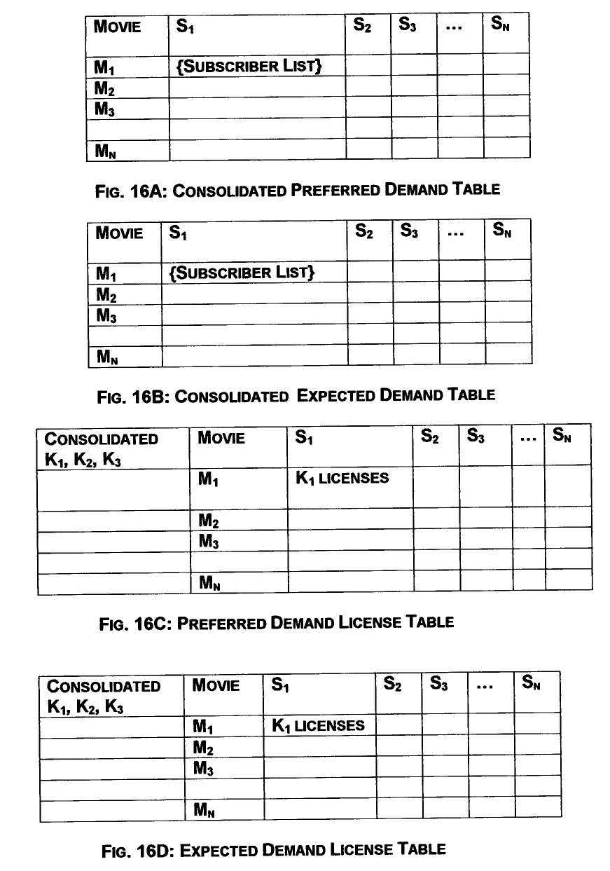

FIG. 16 CCM Main Workflow describes the sequence of various activities performed by CCM periodically.

Step 1602 repeats step 1604 for each subscriber in the ranked order wherein the ranking is based on subscribers' SLA type. The process of WP preparation involves the selection of movies from pop-chart to be made part of subscribers' WP. In order to give preference to subscribers based on their SLA type, it is necessary to order subscribers before WP preparation. Step 1604 prepares subscriber specific weekly plan that comprises of preferred and expected movie demands for all subscribers with the SLA parameter WP participation set to “Y.” Step 1606 communicates, for subscribers in normal group, a subscriber weekly plan to the corresponding LSM to receive confirmation from the subscribers. LSM sends these WPs to the subscribers and receives confirmation from them within WP confirmation time. Step 1608 receives the confirmed weekly plan from the subscribers through LSMs. Step 1610 consolidates all the WPs from the subscribers where the consolidation is performed by combining the respective preferred and expected demands of all subscribers to generate CPD and CED tables. CPD table contains the consolidated preferred demands of all the subscribers and CED table contains the consolidated expected demands of all the subscribers. The consolidation is done to arrive at slot-wise aggregated demand for each movie. Step 1612 communicates the consolidated Weekly Plan for preferred and expected demands, CPD and CED tables containing only the counts rather than the list of subscribers, to the CSLM. Step 1614 receives the Preferred Demand License (PDL) table and Expected Demand License (EDL) table from CSLM containing the consolidated K₂ and K₃ allocated licenses and slot-wise allocated K₁ licenses for each movie. Step 1616 performs the allocation of movies to the subscribers to meet their preferred and expected demands.

FIG. 16A describes the structure of CPD table.

FIG. 16B describes the structure of CED table.

FIG. 16C describes the structure of PDL table.

FIG. 16D describes the structure of EDL table.

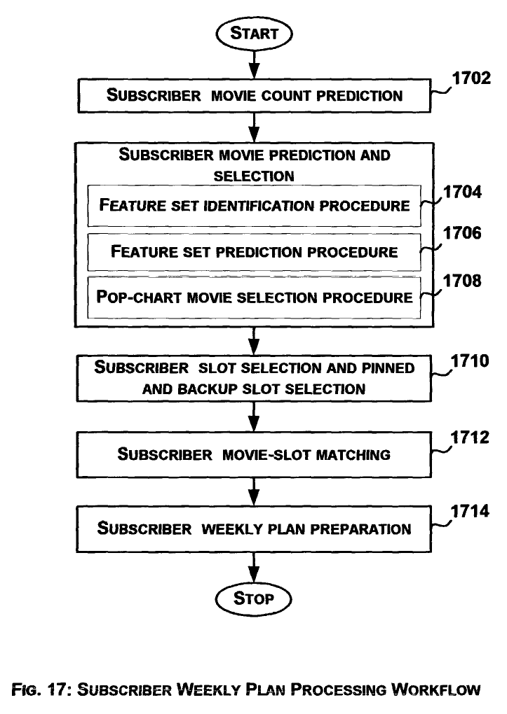

FIG. 17, Subscriber Weekly Plan Processing Workflow, describes the sequence of various activities performed during WP processing.

Step 1702 predicts subscriber movie count where the movie count is the most probable number of movies that the subscriber is likely to watch in the coming week.

Steps 1704-1708 determine the most probable movies for a subscriber. In order to help the most appropriate movie selection, movies are represented using a set of features organized in the form of multiple hierarchies. Prediction of movies is achieved by characterizing the past movies viewed by the subscriber using a subset of these features.

Step 1704 performs the feature set identification procedure based on feature set hierarchies and feature based representation of movies viewed by the subscriber during the past week. Step 1706 performs the feature set prediction procedure to identify the most representative feature set for the coming week based on week-wise feature sets associated with the past movies viewed by the subscriber. Step 1708 selects movies based on the predicted most representative feature set for the subscriber and the movies in the popularity chart. Step 1710 performs the prediction and selection of the most probable pinned and backup slots for viewing the movies by the subscriber based on the analysis of the subscriber's most frequently viewed slots. Step 1712 performs the matching of the most probable movies with the most probable slots based on the feature set representation of these movies and slots and the extent of match. Step 1714 prepares the subscriber WP containing the preferred and expected movies based on the movies selected for the subscriber.

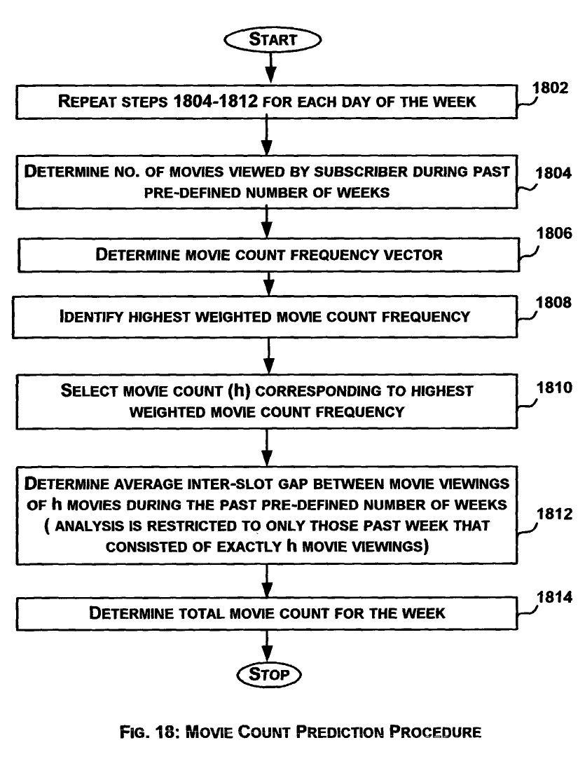

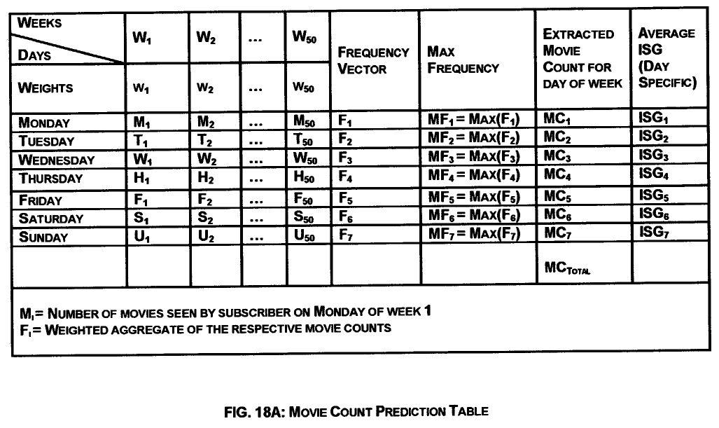

FIG. 18 describes the steps involved in the movie count prediction process for a subscriber. Past subscriber movie viewing pattern is analyzed to determine the day-wise weighted movie count based on movie recency, thereby arriving at the week-wise most probable movie count for the subscriber.

Let W₁, W₂, . . . , Wₙ be the weeks under consideration and w₁, w₂, . . . , wₙ be the corresponding weights based on recency factor such that w₁≦w₂≦ . . . ≦Wₙ. This inequality on weights ensures that movie count prediction is biased towards the most recent viewing pattern of the subscriber.

Let m₁, m₂, . . . , mₙ be the count of the movies respectively seen by the subscriber on day D of weeks W₁, W₂, . . . , Wₙ.

Let MCFV=<c₀, c₁, . . . , cₖ> where c₁=Σxⱼ where xⱼ=wⱼ if mⱼ=i else xⱼ=0 for j=1 . . . n. Step 1802 repeats steps 1804-1812 for each day of a week by analyzing data for the day of the week over the past pre-defined number of weeks. In step 1804, the number of movies (mⱼ) viewed by the subscriber on the day of each of the pre-defined number of past weeks is determined. In step 1806, the weighted movie count MCFV for the day of the week is determined. In step 1808, the highest weighted movie count frequency cₕ is identified as cₕ≦cᵢ for i=1, . . . , k. In step 1810, the movie count, h, corresponding to the highest weighted movie count frequency is selected. In step 1812, the inter-slot gap is determined based on the average gap between the movie viewings in the past where the analysis is restricted to only those past weeks (for day D of week) that consists of exactly h movie viewings.

In step 1814, the movie count for each day of week determined by the above steps is totaled to obtain the total movie count for the subscriber for the coming week.

FIG. 18A is a description of the Movie Count Prediction Table.

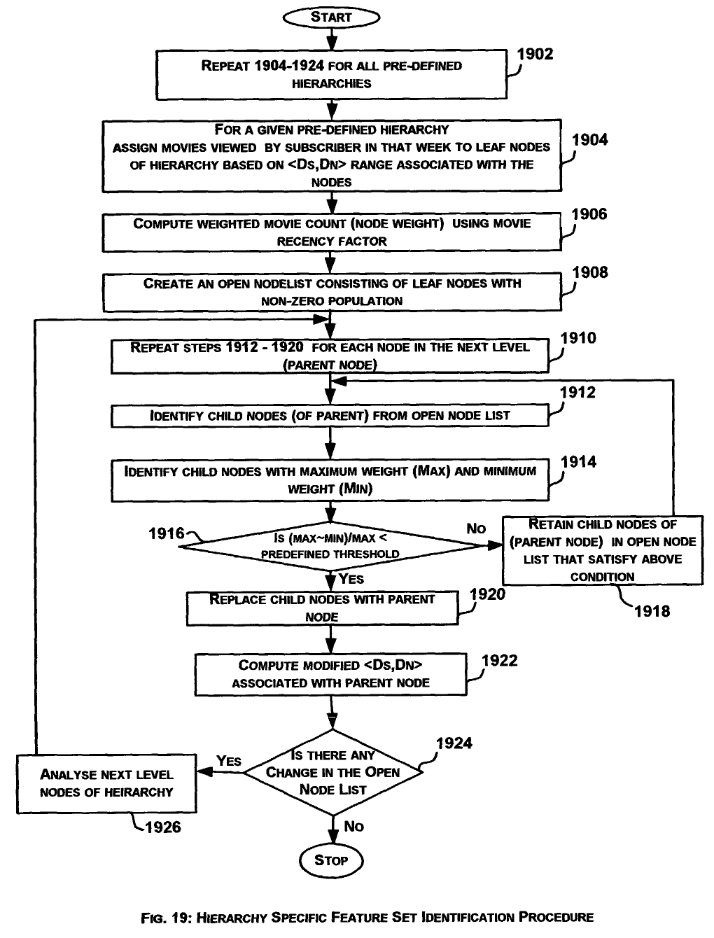

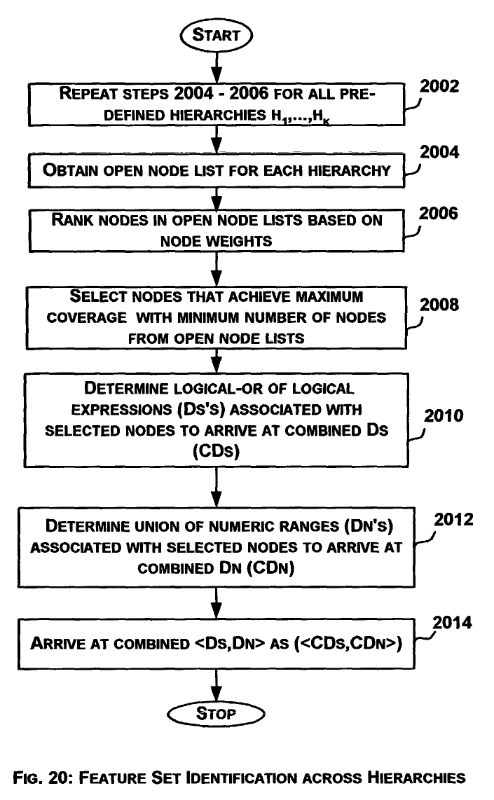

FIG. 19 describes the steps involved in subscriber specific movie feature set identification procedure for each hierarchy. Movies are described using a set of symbolic features and numeric features so as to provide an apt description of the movies. Furthermore, these descriptions are related in a hierarchical fashion and multiple such hierarchies are used in identifying movies of interest to subscribers. Typical hierarchy description can be based on type of movie such as comedy and action, or based on director of movie. The symbolic feature set is a collection of labels or features associated with a movie. It is represented by a logical expression involving the conjunction and disjunction of features. Examples of symbolic features include color and sound aspects associated with a movie. The numeric feature set is measurable and represented by a range of values. Examples of numeric features include the length of a movie or the number of lead actors a movie. A pair <DS, DN> characterizes each node in the hierarchy, where DS is a logical expression of symbolic features and DN is a vector where each element of the vector is represented by a “range”. Each movie is characterized by a pair <DS, DN>, where DS is a logical expression of symbolic features and DN is a vector where each element of the vector is represented by a “value” in the range of that numeric feature. The objective of the procedure is to describe the collection of movies viewed by the subscriber using one or more nodes at an appropriate level in the hierarchy so as to arrive at as generic as possible a description that closely describes the subscriber's movie viewing pattern.

Step 1902 repeats steps 1904-1924 for each of the pre-defined hierarchies in CVLDS. In step 1904, the movies viewed by the subscriber over a past pre-defined number of weeks are assigned to the leaf nodes of the hierarchy under consideration by comparison of the movies'<DS,DN> with the <DS,DN> of the leaf nodes. Each movie is assigned to that leaf node with which the degree of match is maximum. In step 1906, the node weight is computed based on the movie weights derived using movie recency associated with the movies assigned to that node. The weighted movie count is obtained as an aggregate of movie weights. In step 1908, an open node list consisting of leaf nodes of the hierarchy with non-zero population (non-zero node weight) is constructed. Step 1910 repeats steps 1912-1922 for each node in the next level (parent node). In step 1912, the child nodes (corresponding to the parent node under consideration) from open node list are identified. In step 1914, the child nodes with maximum and minimum weight are identified. In step 1916, a check is made to determine the distributed nature of the node weights of the child nodes. If the ratio of difference between the maximum and minimum weights to the maximum weight of the child nodes of the parent is less than a pre-defined threshold value, step 1918 is executed else step 1920 is executed. Replacing two or more child nodes by the parent node is appropriate only if there is a good representation of movies in each of the child node. In step 1918, the child nodes identified in step 1912 are retained in the open node list since they cannot be represented by their parent node that represents a generalized description of movies. In step 1920, the child nodes are replaced by their parent node in the open node list and the node weight of the parent node is computed to be as the sum of node weights of the child nodes. In step 1922, having completed the analysis of all the nodes in the next level, the modified <DS, DN> associated with parent node is computed as the union (logical OR operation with respect to DS and set theoretic union with respect DN) of the <DS,DN> of the child nodes. In step 1924, a check is made to determine the possibility of further generalization based on whether the open node list was modified. If true, step 1926 is executed to repeat the process for the next level nodes of the hierarchy.

At the completion of the above procedure, for each of the pre-defined hierarchies, computed <DS,DN> associated with each of the nodes in the open node list collectively characterize the movies viewed by the subscriber over the past pre-defined number of weeks with respect to that hierarchy. The multiple pre-defined hierarchies are different ways of describing the same collection of movies. It is possible that the movies viewed by one subscriber could be better described using hierarchy H₁ while the movies viewed by another subscriber could be better described by hierarchy H₂.

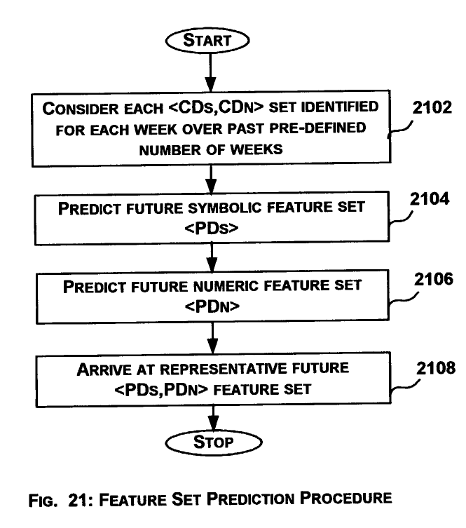

FIG. 20 describes the steps involved in identifying the best combination of partial descriptions using multiple hierarchies for describing the movies viewed by a subscriber. Step 2002 repeats steps 2004-2006 for all pre-defined hierarchies defined in CVLDS. In step 2004, the open node list associated with each hierarchy is obtained. In step 2006, the nodes from open node lists are ranked based on their node weights. In step 2008, nodes that achieve maximum coverage with minimum number of nodes are selected from the open node lists. This step begins with selecting the top ranked node and subsequently considering those of the remaining nodes in the order of their ranks, in such a way that each additionally selected node covers the movies that have not been covered by the previously considered nodes. The step concludes when about a pre-defined percentage of movies are collectively covered by the selected nodes. In step 2010, the logical OR operation is performed on the logical expressions (DS's) associated with selected nodes to arrive at a combined DS (CDS). In step 2012, the union operation is performed on the numeric ranges (DN's) associated with selected nodes to arrive at a combined DN (CDN). In step 2014, a representative movie characteristic set for the subscriber (<CDS,CDN>) is formed.

Let W₁, W₂, . . . , W₅₀, . . . , W₁₀₀ be the past weeks under consideration and W₁₀₁ be the current week and W₁₀₂ be the next week. FIG. 20 computes <CDS,CDN> for the movies viewed during the weeks W₅₁, . . . , W₁₀₀ and database contains similarly computed <CDS,CDN> for weeks {W₅₀, . . . , W₉₉}, {W₄₉, . . . , W₉₈}, . . . , {W₁, . . . , W₅₀}. It is required to compute <CDS,CDN> for W₁₀₂ based on previously computed <CDS,CDN>S.

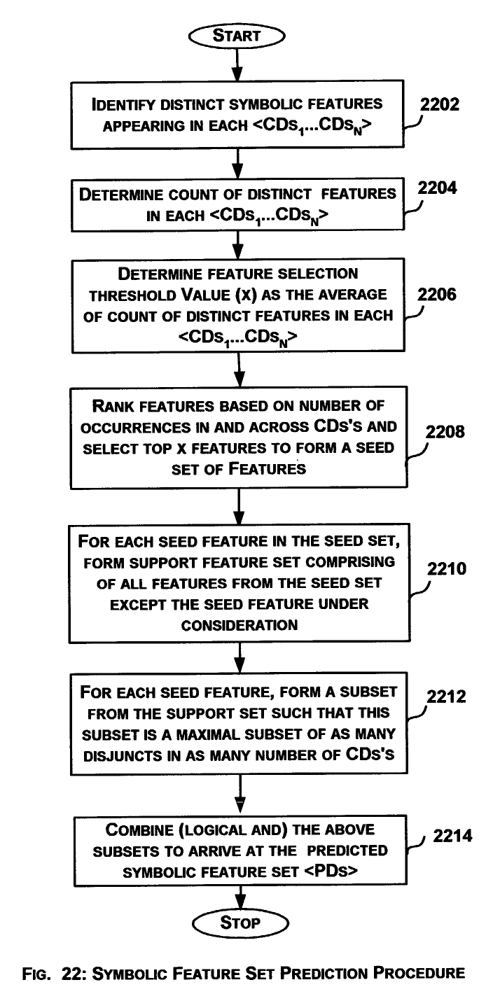

FIG. 21 describes the main steps involved in the feature set <CDS,CDN> prediction procedure for a subscriber. This procedure predicts subscriber specific symbolic and numeric feature set based on combined symbolic and numeric features sets, <CDS,CDN>S (step 2102), representing movies viewed by the subscriber during past weeks. In step 2104, the future symbolic feature set <PDS> for the coming week is predicted based on the past CDS's. In step 2106, the future numeric feature set <PDN> for the coming week is predicted based on the past CDN's. In step 2108, the representative predicted <PDS,PDN> feature set for the coming week is formed.

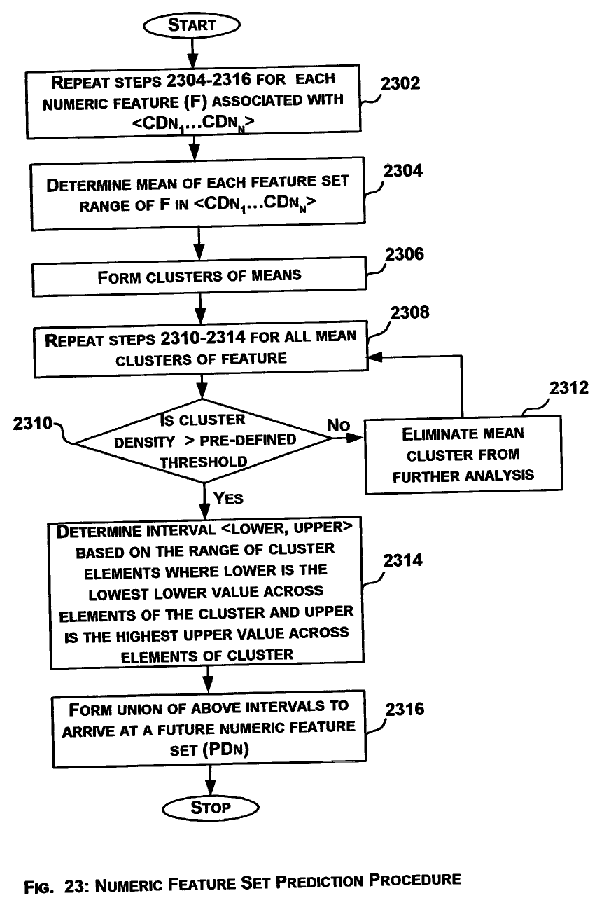

FIG. 22 describes the steps involved in the symbolic feature set (DS) prediction procedure for a subscriber. This procedure determines PDS using the most commonly present features and forming a logical expressions based on these features in such a way that the logical expression closely follows the logical expressions of <CDS₁, . . . , CDSₙ>. In step 2202, the distinct symbolic features present in <CDS₁, . . . , CDSₙ> are identified and in step 2204, their count (x₁, x₂, . . . , xₙ) with respect to <CDS₁, . . . , CDSₙ> is determined. In step 2206, a symbolic feature selection threshold value (x) is determined as the average of the counts x₁, x₂, . . . , xₙ. In step 2208, candidate symbolic features are selected by ranking distinct symbolic features based on the number of their occurrences in and across <CDS₁, . . . , CDSₙ>. The actual number of features selected is determined by the value of x determined in the previous step. The selected features are identified as seed features and a seed feature set is formed. In step 2210, a support feature set is formed comprising of all features from the seed feature set except the seed feature under consideration. In step 2212, a subset is formed (for each seed feature), from the support set, such that the subset is a maximal subset of as many disjuncts in as many number of CDS's. This is done to determine characteristic movie feature combinations for the subscriber which always appear together. In step 2214, a logical AND operation is performed on the above subsets to arrive at the predicted symbolic feature set <PDS>.

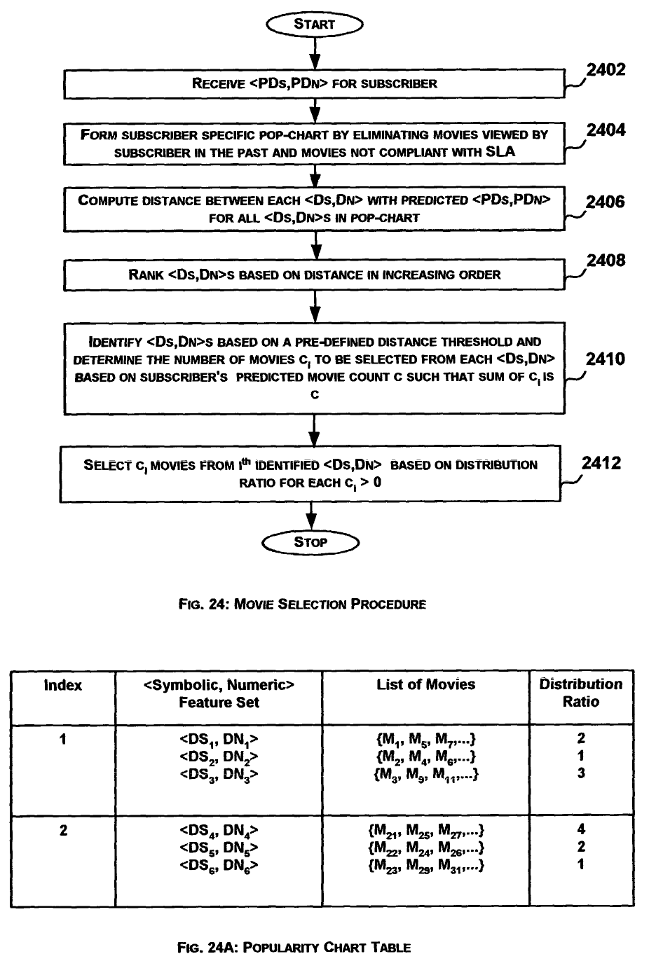

FIG. 23 describes the steps involved in the numeric feature set (DN) prediction procedure for a subscriber. Step 2302 repeats steps 2304-2316 for each numeric feature (F) appearing in <CDN₁, . . . , CDNₙ>. Let R₁=[L₁, U₁], . . . Rₖ=[Lₖ, Uₖ] be the k ranges associated with F. In step 2304, the mean of each distinct range, m₁ (mean of L₁ and U₁), . . . , mₖ, of F is determined. In step 2306, clusters of means are formed. Step 2308 repeats steps 2310-2314 for each of the clusters identified for F. In step 2310, a check is made to determine if the density of the cluster is greater than a pre-defined threshold value. This check is made to identify and select densely populated clusters. If the check made in step 2310 is false then step 2312 is executed, else step 2314 is executed. In step 2312, the cluster is eliminated from further analysis, as this cluster is a weak representative of F. In step 2314, the cluster interval (range) is determined as <lower, upper>, based on the range of cluster elements where lower is the lowest lower value across elements of the cluster and upper is the highest upper value across elements of cluster.

Let R₁, R₂, and R₄ be the ranges associated with the elements of the cluster. Then the interval <lower, upper> is determined as lower=L₂ and upper=U₄ where L₂≦L₁≦L₄ and U₂≦U₁≦U₄.

In step 2316, a union of intervals of newly identified intervals, from the cluster analysis, of F is formed and made part of PDN.

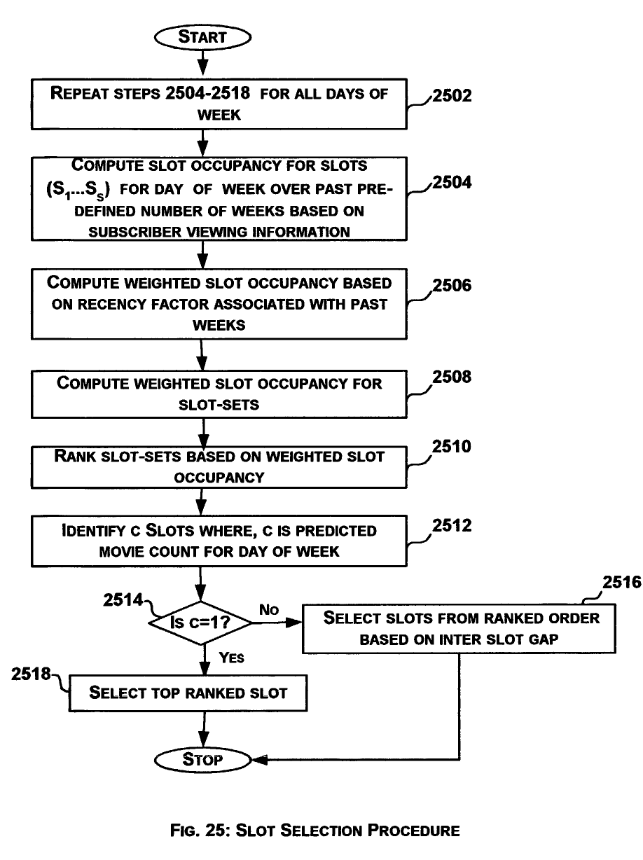

FIG. 24 describes the steps involved in the popularity chart based final movie selection for a subscriber. This procedure involves the creation of the subscriber specific popularity chart. The subscriber specific popularity chart consists of movie types compliant with SLA of the subscriber and movies not so far viewed by the subscriber. The number of movies selected for the subscriber is based on the subscriber specific predicted movie count.

In step 2402, the derived <PDS,PDN> for a subscriber is received. In step 2404, the subscriber specific popularity chart with distribution ratios is created for the subscriber by considering only those movies not so far viewed by the subscriber and movies compliant with SLA. In step 2406, the distance (measure of similarity) between each <DS,DN> in pop-chart with the predicted <PDS,PDN> for the subscriber is computed. In step 2408, the <DS,DN>S are ranked in the increasing order of their distances. Step 2410 identifies <DS,DN>S based on a pre-defined distance threshold and determines the number of movies Cᵢ to be selected from each <DS,DN> based on subscriber's predicted movie count C such that sum of Cᵢ is C. Step 2412 selects Cᵢ movies from i^{th} identified <DS,DN> based on the distribution ratio for each Cᵢ>0.

FIG. 24A is a table describing the structure of the popularity chart.

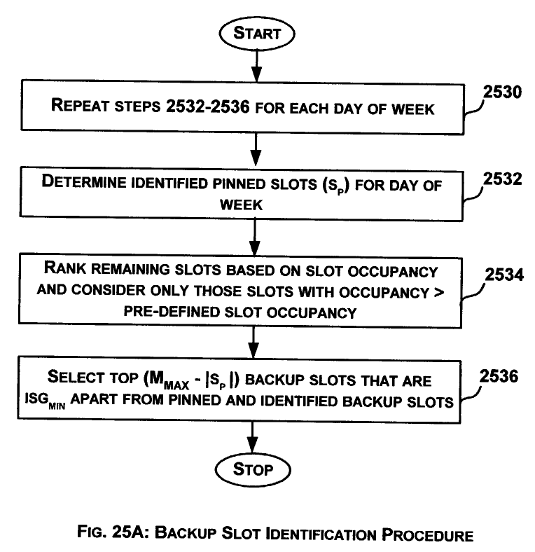

FIG. 25 is a description of the slot selection procedure for a subscriber. The number of slots selected is based on the movie count predicted for a subscriber for the coming week. In order to arrive at the subscriber's most preferred show times, an analysis of the frequently viewed slots of the subscriber is made and representative show times are selected based on high slot occupancy and recency. The slot occupancy is based on the first slot of a movie, that is slot in which the show of a movie commences.

Step 2502 repeats steps 2504-2518 for all days of the week. In step 2504, subscriber movie viewing data is analyzed for the day of week under consideration over past pre-defined number of weeks to determine slot occupancy. In step 2506, the weighted slot-occupancy is computed for each slot by multiplying the slot occupancy by a weight based on recency factor associated with past weeks. The value of the slot recency factor increases gradually from the first week to the most recent week. This is done to capture the subscriber's most recent slot preferences in which the movies are most likely to be watched by the subscriber. A slot-set is a triplet of adjacent slots. Adjacent slots may tend to exhibit similar viewing characteristics of the subscriber and hence are considered as a set. In step 2508, the total weighted slot occupancy for each adjacent slot in a slot-set is computed as the aggregated weights of the slots in the slot-set. In step 2510, the slot-sets are ranked based on their weighted slot occupancy. A representative slot is chosen from each slot-set as the preferred slot for the subscriber. In step 2512, C slots are identified for day of week under consideration where C represents the predicted movie count for the day of week. In step 2514, a check is made to determine if the value of C is 1. If true, step 2518 is executed else step 2516 is executed. In step 2516, C slots are selected from the ranked order of slots based on inter-slot gap. In step 2518, the top ranked slot determined for the day of week under consideration is selected.

FIG. 25A describes the steps involved in Backup Slot Identification Procedure for a subscriber. Backup slots are required to re-plan an alternative expectation of the subscriber when the subscriber is unable to view a movie as per the plan. As the subscriber may miss a movie on any day, it is required to identify day-wise backup slots. Hence, it is required to identify one or more backup slots on each day of a week and number and position of backup slots identified are based on two pre-defined parameters namely, M_{MAX} denoting the maximum number of movies that could be viewed on a day and ISG_{MIN} denoting the minimum inter-slot gap between two movie viewings. Step 2530 repeats steps 2532-2536 for each day of a week for a subscriber. Step 2532 determines the identified pinned slots (Sₚ) for day of week. Pinned slots are the predicted slots for the day of week for the subscriber. Step 2534 ranks remaining slots based on slot occupancy and considers only those slots with occupancy greater than a pre-defined slot occupancy threshold. Step 2536 selects top (M_{MAX}−|Sₚ|) backup slots that are ISG_{MIN} apart from pinned and identified, backup slots.

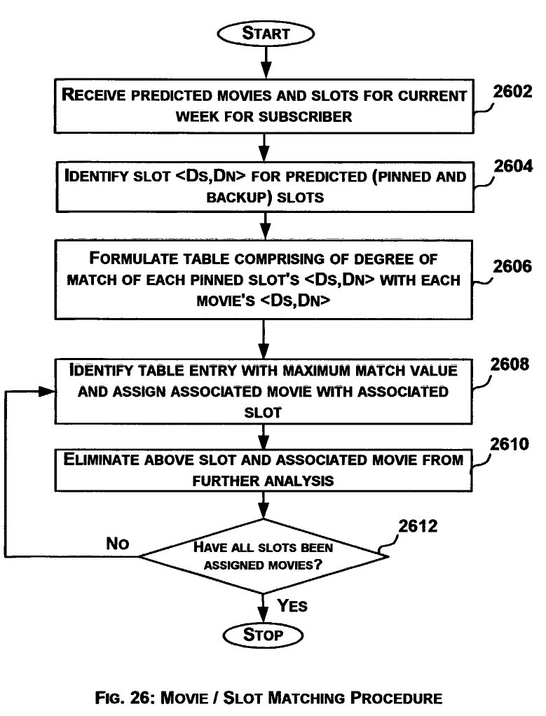

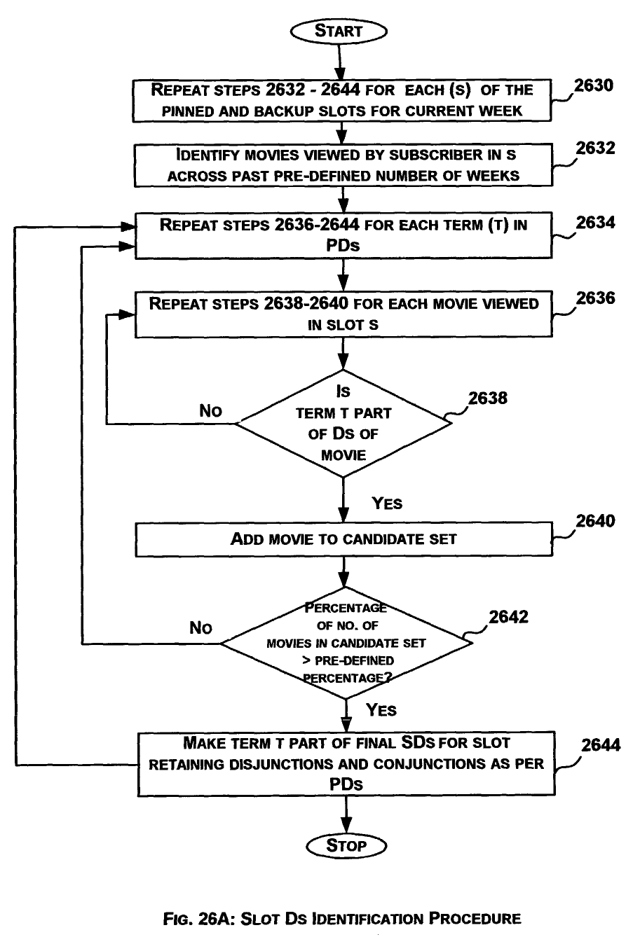

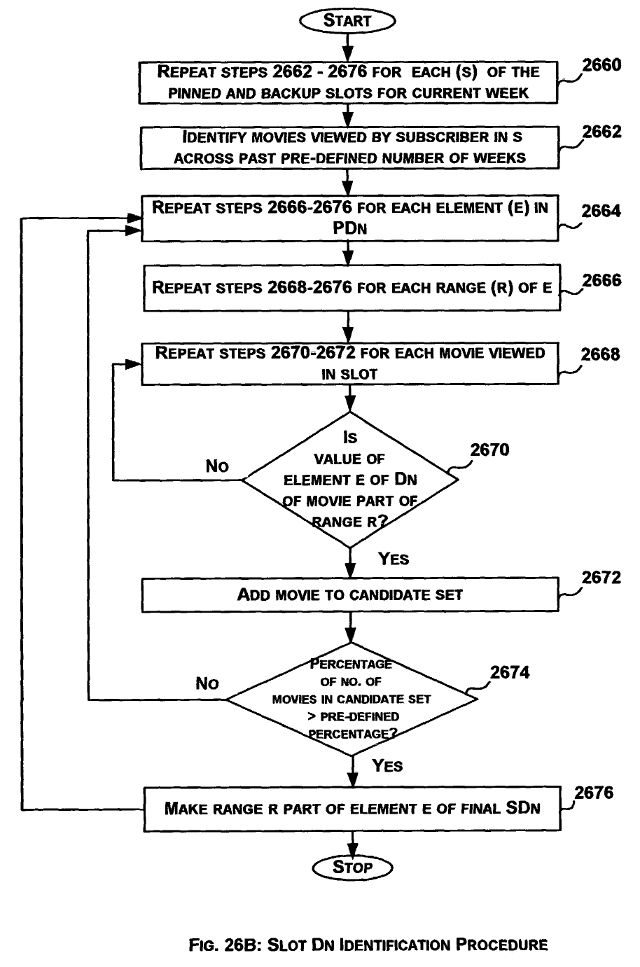

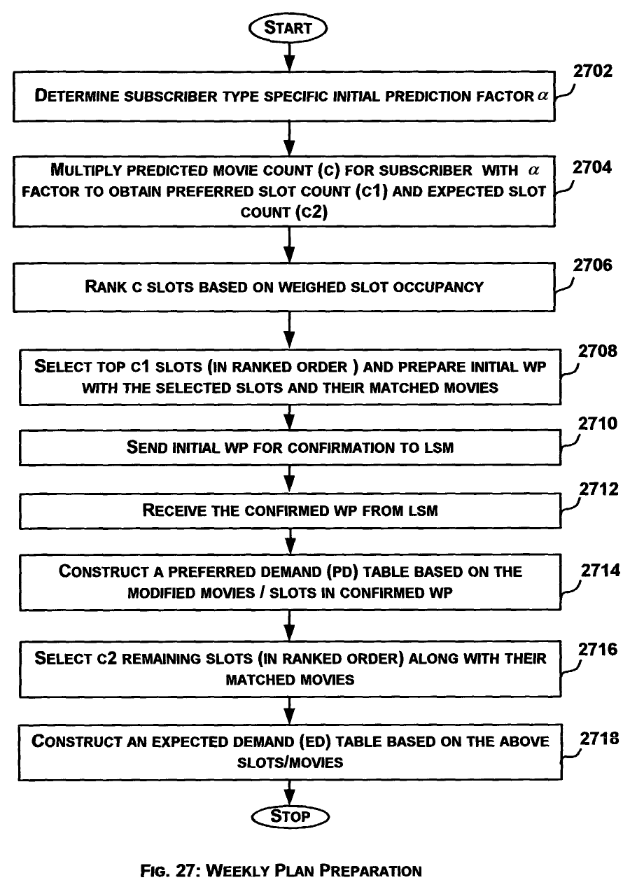

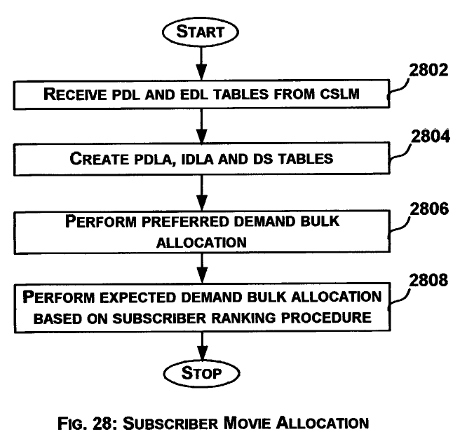

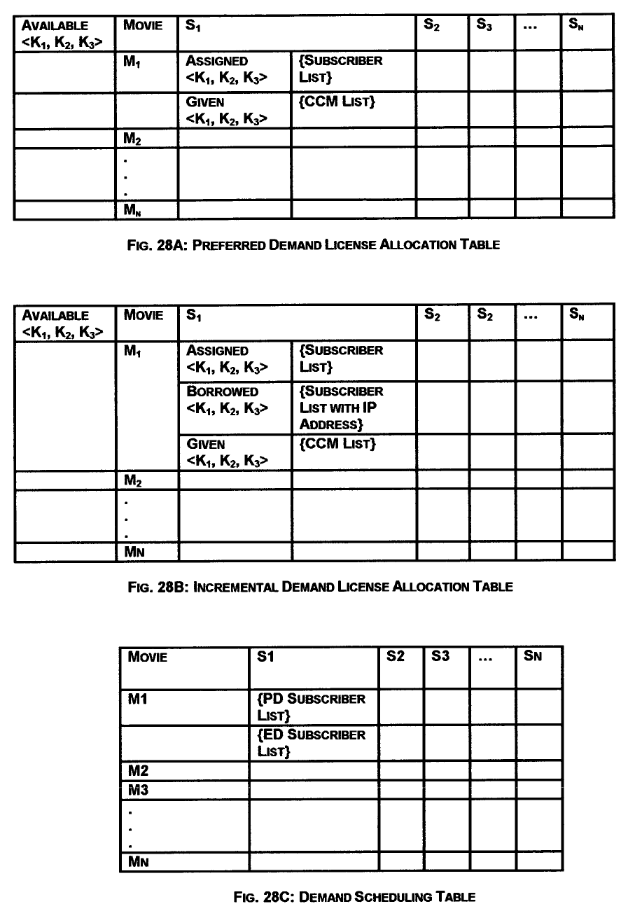

FIG. 26 describes the steps involved in the movie/slot matching procedure for a subscriber. This procedure matches movies of interest to the subscriber to the pinned slots, based on maximum degree of similarity between symbolic and numeric features associated with each movie and symbolic and numeric features associated with each slot.

In step 2602, the predicted movies and slots for a subscriber are received. In step 2604, the symbolic and numeric features for each of the predicted (pinned and backup) slots are identified. In step 2606, a table comprising of degree of match (based on maximum degree of similarity) of each slot's <DS,DN> with each movie's <DS,DN> is formed. In step 2608, the table entry with maximum match value is identified and the associated movie is assigned to the associated slot. In step 2610, the identified slot and movie are eliminated from further analysis and step 2612 continues the above matching for the remaining slots till all the pinned slots are assigned with movies.

FIG. 26A describes steps involved in Slot Ds Identification Procedure. Step 2630 repeats steps 2632-2644 for each (S) of the pinned and backup slots for current week. Step 2632 identifies movies viewed by subscriber in S across past pre-defined number of weeks. Step 2634 repeats steps 2636-2644 for each term (T) in PDS. Step 2636 repeats steps 2638-2640 for each movie viewed in slot S. Step 2638 checks whether term T is part of Ds of movie. If true, step 2340 adds movie to candidate set. Step 2642 checks whether the percentage of number of movies in candidate set is greater than a pre-defined percentage. Step 2644 makes term T part of final SDS for slot S retaining disjunctions and conjunctions as per PDS.

FIG. 26B describes steps involved in Slot DN Identification Procedure. Step 2660 repeats steps 2662-2676 for each (S) of the pinned and backup slots of a subscriber for current week. Step 2662 identifies movies viewed by the subscriber in S across past pre-defined number of weeks. Step 2664 repeats steps 2666-2676 for each element (E) in PDN. Step 2666 repeats steps 2668-2676 for each range (R) of E. Step 2668 repeats steps 2670-2672 for each movie viewed in slot. Step 2670 checks whether the value of element E of DN of movie is a part of range R. If true, step 2672 adds movie to candidate set. Step 2674 checks whether the percentage of number of movies in candidate set is greater than a pre-defined percentage. Step 2676 makes range R part of element E of final SDN for slot S.

FIG. 27 is a description of the weekly plan preparation for a subscriber. This procedure involves computing subscriber specific number of preferred and expected movies based on the subscriber type specific prediction factor and subscriber specific movie count. Preferred movies are those movies for which the subscriber's consent has to be obtained and expected movies are additional movies predicted for the subscriber in order to fill the subscriber's expected demand for the week. The number of preferred and expected movies for a subscriber varies based on subscriber's type. The objective of the weekly plan preparation is to be able to receive confirmation for all or most movies and their slots in the preferred movies category from the subscriber. As the system matures, this objective is achieved as the preferred plan offered to the subscribers for confirmation is based on the detailed analysis of the viewing patterns of the subscribers.

In step 2702, subscriber type specific initial prediction factor α is determined. In step 2704, the predicted movie count (C1) for the subscriber is multiplied with the α factor to obtain the preferred slot count (C1) and expected slot count (C2). Step 2706 ranks C slots based on weighed slot occupancy where the slot occupancy weights are based on the occupancy in the slot-set corresponding to the slot. In step 2708, the top C1 slots (in ranked order) are selected and the initial weekly plan is prepared with the selected slots and their matched movies. In step 2710, the initial weekly plan is sent for confirmation to the LSM. In step 2712, the confirmed weekly plan is received from the LSM. In step 2714, a preferred demand table is constructed based on the modified movies/slots in the confirmed weekly plan. Further, any change in the confirmed WP is used to modify appropriately the expected demand predicted for the subscriber. In step 2716, the remaining C2 slots are selected in ranked order along with their matched movies. In step 2718, an expected demand table is constructed based on the above movies and slots. The preferred and expected demand tables together constitute WP for the subscriber.

FIG. 28 is a description of the steps involved in a subscriber movie allocation process. In step 2802, the PDL and EDL tables are received from the CSLM. PDL and EDL tables contain the licenses allocated by CSLM to meet the consolidated preferred and expected demands of CCM. In step 2804, the PDLA, IDLA and DS tables are created. PDLA table is created to contain the usage of allotted licenses by distributing the same to preferred demands of LSM subscribers, expected demands of LSM subscribers, and expected demands of subscribers of other CCMs. Similarly, IDLA table is created to contain the usage of allotted licenses by distributing the same to expected demands of LSM subscribers and expected demands of subscribers of other CCMs. Further, IDLA will also contain licenses borrowed from other CCMs to meet expected demands. Expected demands include incremental and real-time demands made during the course of a week. In step 2806, the preferred demand bulk allocation is performed to achieve the distribution of licenses to the preferred demands of the subscribers and to prepare DS table. DS table contains the necessary subscriber related movie/slot information to manage previews. In step 2808, the expected demand bulk allocation is performed based on subscriber ranking procedure to update DS table.

FIG. 28A describes the structure of the PDLA table.

FIG. 28B describes the structure of the IDLA table.

FIG. 28C describes the structure of the DS table.

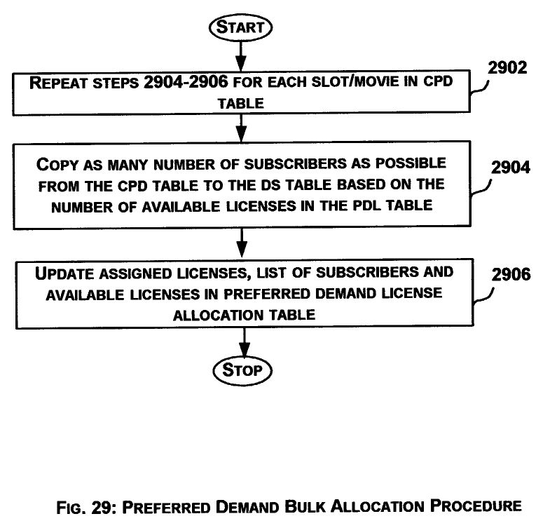

FIG. 29 describes the preferred demand bulk allocation procedure. The bulk license allocation procedure is performed to meet all the preferred demands from subscribers based on the licenses allotted by CSLM for preferred demands.

Step 2902 repeats steps 2904-2906 for each movie/slot in the CPD table. In step 2904, the adequate number of subscribers from the CPD table is copied to the DS table based on the number of available licenses (allocated by CSLM) in the PDL table for the movie/slot under consideration. The subscriber list in the DS table is used to show previews related to subscriber specific preferred and expected demands. In step 2906, the assigned licenses, list of subscribers, and available licenses fields in PDLA table are updated.

In order to efficiently allocate the allotted licenses, the following steps are followed during movie-specific bulk allocation:

(a) BR licenses are slot-specific license allocations such that utilization is maximum;

Allocate as much BR licenses as possible, and update license availability and demand;

(b) Allocate as much BNR licenses as possible such that the utilization is maximum, and update license availability and demand;

(c) Repeat allocating SNR licenses in slabs of, say 5, licenses starting from the slab 1-5, and update license availability and demand; and

(d) Repeat allocating BNR licenses, if still available, in slabs of, say 5, starting from the slab, say 15-20 (assuming that BNR licenses are in the units of 20), and update license availability and demand.

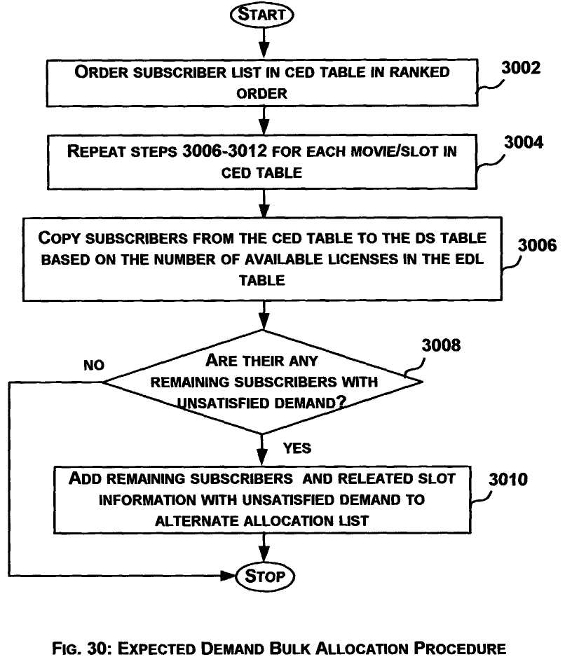

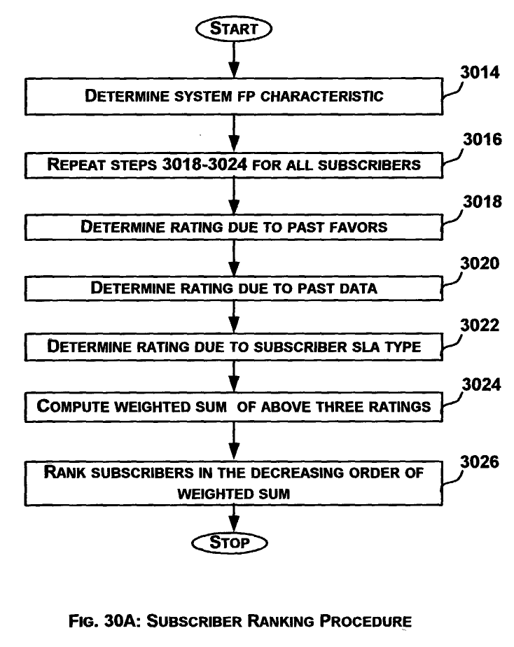

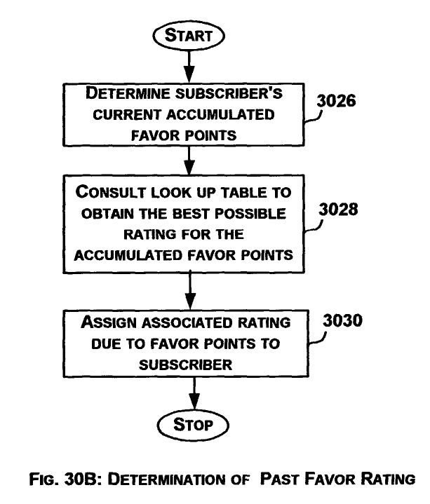

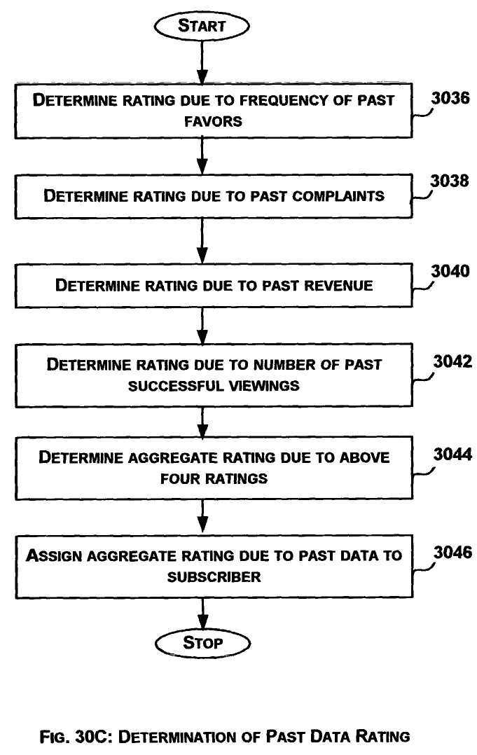

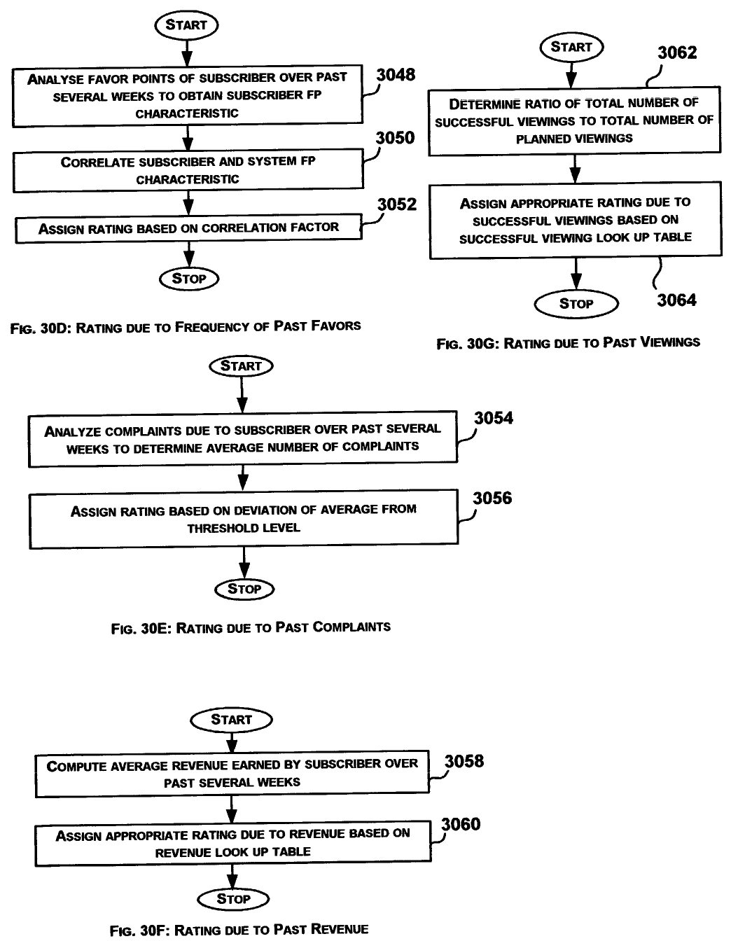

FIG. 30 describes the expected demand bulk allocation procedure. The expected demand bulk allocation procedure is executed to meet the expected demands based on the licenses allotted by CSLM for expected demands.

In step 3002, a ranked order of the subscriber list is created. The ranking is based on ratings associated with the subscribers and the ratings are determined based on subscriber specific past data consisting of complaints, revenue, successful viewings, past favor points, and SLA type. In order to address shortage of licenses while allocating bulk licenses to meet expected demands it is necessary to prioritize the subscribers. The proposed ranking is to ensure a high level of subscriber satisfaction.

Step 3004 repeats steps 3006-3012 for each movie/slot in the CED table. In step 3006, the subscribers in the subscriber list are copied from the CED table to the DS table based on the number of available licenses (allocated by CSLM) in the EDL table for the movie/slot under consideration. The subscriber list in the DS table is used to show previews related to subscriber specific preferred and expected demands. In step 3008, a check is made to determine if there are any remaining subscribers with unsatisfied demands. If true, step 3010 is executed. In step 3010, the subscribers with unsatisfied demand are added to the alternate allocation list. After the completion of bulk license allocation, the remaining licenses for various movie/slot combinations are used to identify and assign alternate movies to the unsatisfied subscribers' expected demands.

FIG. 30A is a description of the steps involved in the subscriber ranking procedure. The ranking procedure is specific to each CCM and is based on rating associated with the subscribers. The rating for a subscriber is determined based on subscriber specific past data consisting of complaints, revenue, successful viewings, past favor points, and SLA type. Equal weightage is given to each of the three categories, namely, past favors, past data and subscriber priority in a preferred embodiment. The rating for each of the above three categories is computed and normalized to be between 0 and 1 for each subscriber.

In step 3014, the system favor point (FP) characteristic is determined. The system FP characteristic depicts the variation in the accumulated FP, over the past pre-defined number of weeks, aggregated over a week for all subscribers of the CCM. The system FP characteristic is used to determine the nature of the subscriber behavior by comparing the system FP characteristic with subscriber specific FP characteristic. Step 3016 repeats steps 3018-3024 for all subscribers. In step 3018, the rating due to past favors is determined. In step 3020, the rating due to past data is determined. In step 3022, the rating due to subscriber's type is determined. In step 3024, the weighted sum of above three ratings is computed. In step 3026, the subscribers are ranked in the decreasing order of weighed sum.

FIG. 30B is a description of the steps involved in the determination of past favor rating for the subscriber. In step 3026, the subscriber's current accumulated favor point is obtained. In step 3028, the favor point look up table is queried to determine the best possible rating for the accumulated favor points. The favor points and their associated ratings are pre-defined in the look up table. A negative favor point incurs a lesser rating. It indicates that the system has done extra favors to the subscriber. A positive favor point incurs a higher rating. In this case, the system owes the subscriber some pending favors. In step 3030, the associated rating is assigned to the subscriber.

FIG. 30C is a description of the steps involved in the determination of past data rating for the subscriber. In step 3036, the rating due to frequency of past favors is determined. In step 3038 the rating due to past complaints is determined. In step 3040, the rating due to past revenue is determined. In step 3042, the rating due to number of past successful viewings is determined. In step 3044, the aggregate rating due to above four ratings is determined. In step 3046, the computed aggregate rating due to past data is assigned to the subscriber.

FIG. 30D is a description of the steps involved in the determination of the rating due to frequency of past favors.

In step 3048, the variation in week-wise accumulated favor points by the subscriber is analyzed over past pre-defined number of weeks to determine the subscriber specific FP characteristic. In step 3050, the correlation factor between the subscriber specific FP characteristic and system FP characteristic is determined. In step 3052, an appropriate rating based on correlation factor is assigned to the subscriber. A high correlation factor incurs a lower rating.

FIG. 30E is a description of the steps involved in the determination of rating due to past complaints. Step 3054 analyzes complaints from the subscriber over past several weeks to determine average number of complaints. Step 3056 assigns rating based on the deviation of the computed average number from the threshold level.

FIG. 30F is a description of the steps involved in the determination of rating due to past revenue. In step 3058, the average revenue earned by the subscriber over past pre-defined number of weeks is computed. In step 3060, the rating due to earned revenue is assigned based on the revenue look up table. A higher value of average revenue earned incurs a higher rating.

FIG. 30G is a description of the steps involved in the determination of rating due to past viewings. In step 3062, the ratio of the total number of successful viewings to the total number of planned viewings during the past pre-defined number of weeks for the subscriber is computed. In step 3064, the rating due to past successful viewings is assigned based on successful viewing look up table. A lower value of the above ratio incurs a higher rating.

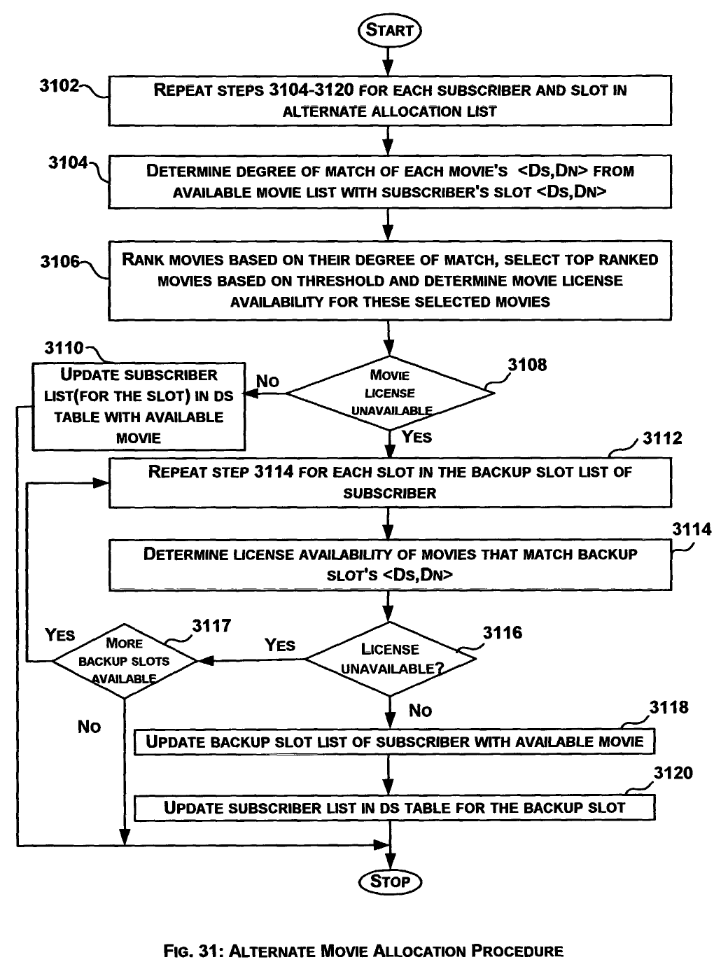

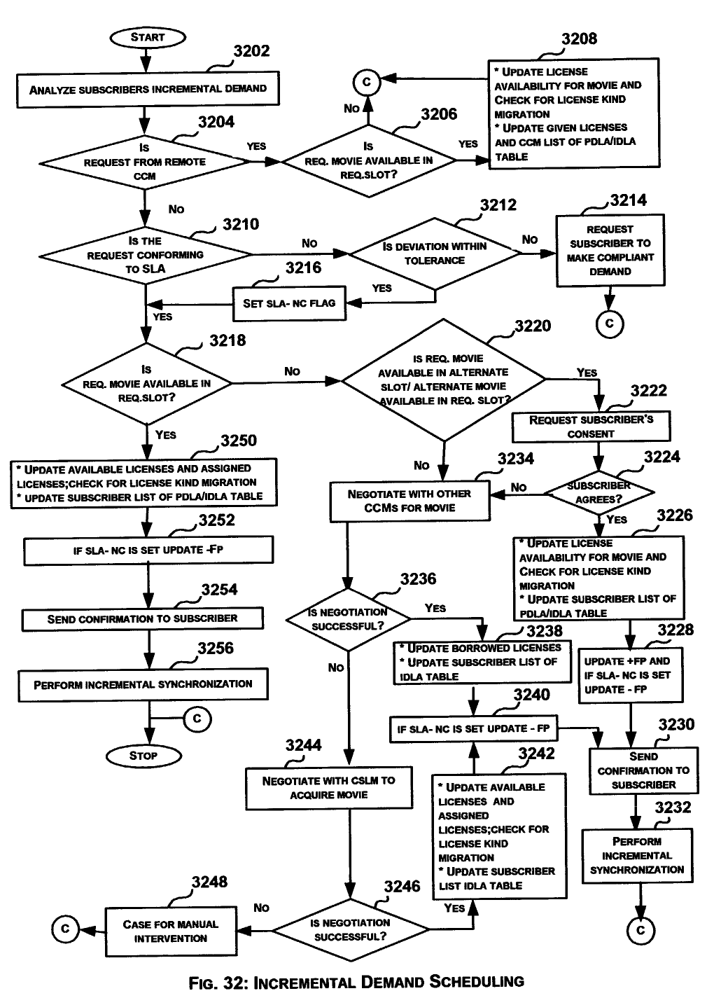

FIG. 31 is a description of the steps involved in the alternate movie allocation procedure for a subscriber. Alternate movie allocation procedure assigns best possible alternate movies to meet the unsatisfied expected demands if any due to shortage of license. Further, the alternate movies are selected based on the degree of match between slots'<DS,DN> and alternate movies'<DS,DN>.

Step 3102 repeats steps 3104-3120 for each subscriber and slot in alternate allocation list. In step 3104, the degree of match of each movie's <DS,DN> from available movie list with subscriber's slot <DS,DN> is determined. Step 3106 ranks movies based on their degree of match, selects top ranked movies based on threshold, and determines movie license availability for these selected movies. In step 3108, a check is made to determine if movie licenses are unavailable for the selected movies. If true, step 3112 is performed else step 3110 is performed. In step 3110, the subscriber list is updated for the slot under consideration in the DS table with the available movie. Step 3112 repeats step 3114 for each slot in the backup slot list of the subscriber. In step 3114, the license availability for movies that match backup slot's <DS,DN> is determined. In step 3116, a check is made to determine if movie licenses are unavailable for all movies pertaining to backup slot. If true, step 3117 is performed else step 3118 is performed. In step 3117, a check is made to determine the availability of backup slots. If available, step 3112 is executed. In step 3118, the backup slot list of subscriber is updated with the available movie. In step 3120, the subscriber list is updated in DS table for the backup slot.

FIG. 32 depicts Incremental Demand Scheduling procedure of CVLDS. Incremental Demand scheduling procedure processes incremental demands for a movie in a slot made by a subscriber. The incremental demand processing includes checking for the subscriber's SLA compliance, checking license availability for the demanded movie in the demanded slot, negotiating for an alternative movie or slot in case of non-availability of license, generation of FP triggers, and updating licenses and subscriber list in either preferred demand license allocation table or incremental demand license allocation table.

Step 3202 analyzes the demand received from a subscriber. Step 3204 checks whether the request is from a remote CCM. If the request is from remote CCM, step 3206 is performed otherwise, step 3210 performed. Step 3206 checks whether the requested movie is available in the requested slot. If requested movie is available in requested slot step 3208 updates license availability for movie in IDLA table, checks for license kind migration and updates “given licenses” and corresponding CCM list in IDLA table. Step 3210 checks whether the incremental demand from the subscriber conforms to the subscriber's SLA. If the demand does not conform to SLA, step 3212 is performed otherwise, step 3218 is performed. Step 3212 checks whether the deviation from conformation is within a pre-defined tolerance. If deviation is within the tolerance, step 3216 sets SLA non-confirmation (SLA-NC) flag and proceeds to step 3218. If deviation is beyond the tolerance limit, step 3214 requests the subscriber to make compliant demand.

Step 3218 checks whether the requested movie is available in requested slot. If available, step 3250 is performed otherwise step 3220 is performed. Step 3220 checks whether requested movie is available in an alternate slot or an alternate movie is available in the requested slot. If not available, step 3234 is performed, otherwise step 3222 requests for the subscriber's consent to accept the change in slot or movie and further step 3224 checks whether the subscriber has agreed for the change. If subscriber does not agree, step 3234 is performed else step 3226 is performed. Step 3226 updates license availability for movie in IDLA or CDLA table, checks for license kind migration and updates subscriber list of CDLA or IDLA table. The availability of license is first checked in CDLA table and in case of unavailability in CDLA table, availability is checked in IDLA table. This is to ensure that any licenses available after bulk allocation to meet preferred demands is completely utilized. Step 3228 adds appropriate number of favor points for the subscriber in Favor Point DB to reward the subscriber for accepting the slot or movie modification and further, subtracts appropriate number of favor points, if SLA-NC is set. Step 3230 sends confirmation to the subscriber and further, step 3232 performs incremental synchronization to update DS table to help manage previews. Step 3234, as the alternate movie/slot is unavailable or as the subscriber did not agree for alternate movie/slot, negotiates with other CCMs for the requested movie. Step 3236 checks whether negotiation is successful and if successful, step 3238 is performed else step 3244 is performed. Step 3238 updates “borrowed licenses” and subscribers list in CDLA/IDLA table. Further, step 3240 updates Favor Point DB with negative favor points if SLA-NC flag is set and step 3230 is performed.

Step 3244 negotiates with CSLM to acquire license for the requested movie in the requested slot and further, step 3246 checks whether the negotiation is successful. If negotiation is successful, step 3242 is performed otherwise step 3248 informs operator for manual intervention.

Step 3242 increments available licenses in EDL Table as an additional license was received from CSLM, updates “assigned licenses” in IDLA table, checks for license kind migration, updates subscribers list in IDLA table, and further, performs steps 3240.

Step 3250 updates “available licenses” and “assigned licenses” in CDLA/IDLA table, checks for license kind migration and updates subscribers list in CDLA/IDLA table. Step 3252 updates negative favor points if SLA-NC flag is set, performs step 3254 to send confirmation to the subscriber, and further, step 3256 performs incremental synchronization.

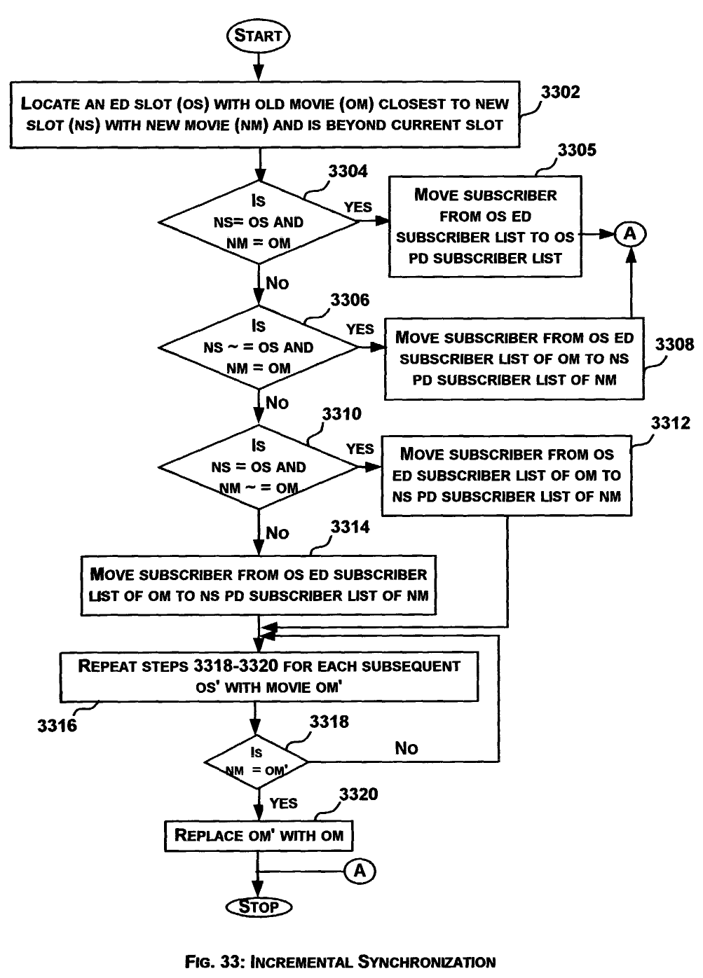

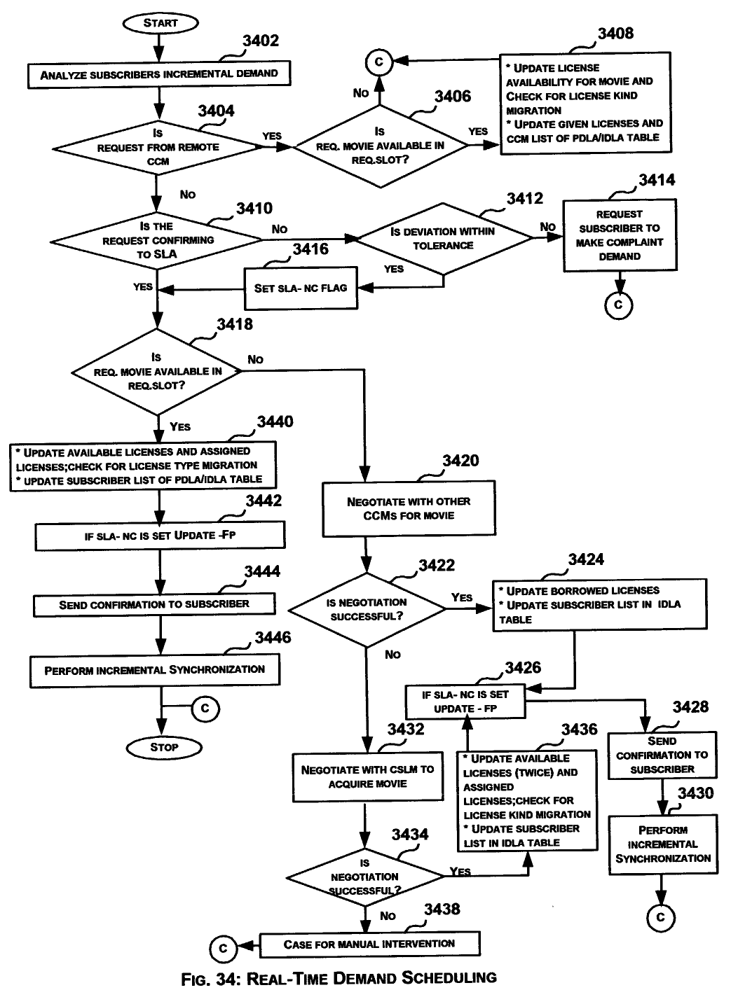

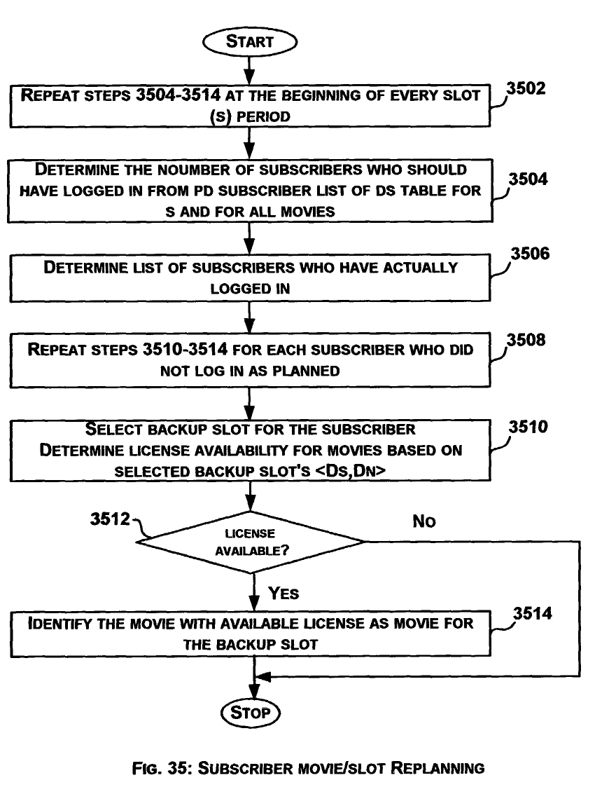

FIG. 33 depicts Incremental Synchronization procedure of CVLDS. Incremental Synchronization procedure synchronizes DS Table with respect to an incremental demand or real-time demand where the process of synchronization adjusts said demand schedule table based on the way the incremental and real-time demands are met. DS Table contains movie allocations to meet preferred demands. Incremental/real-time demand could match with an expected demand in the DS Table. In case there is a mismatch, as an entry related to an expected demand in the DS table is optimistic one, it is essential to locate and remove a nearest matching expected demand entry.

Step 3302 locates an ED slot (OS) with old movie (OM) closest to new slot (NS) with new movie (NM) and is beyond current slot where NS and the corresponding NM are based on the incremental demand made and agreed upon by the subscriber, and further, ES and OM are slot and movie allotted based on expected demand. Step 3304 checks whether NS is same as OS, and NM and OM are same, and if so, step 3305 is performed otherwise, step 3306 is performed. Step 3305 moves the subscriber entry in ED subscriber list of DS Table to PD subscriber list. Step 3306 checks whether NS is not the same as OS, and NM and OM are same, and if so, then in this case synchronization is needed as planned and actual demands differ in slots, and hence, step 3308 moves the subscriber entry from OS ED subscriber list of OM to NS PD subscriber list of NM in DS Table.

Step 3310 checks whether NS is the same as OS, and NM is not same as OM, and if so, then in this case synchronization is needed as planned and actual demands differ in movies, and hence, step 3312 moves the subscriber entry from OS ED subscriber list of OM to NS subscriber list of NM in DS table and proceeds to step 3316. When both NM and NS do not match with corresponding OM and OS, synchronization is needed as planned and actual demands differ in both movie and slot, and hence, step 3314 moves the subscriber entry from OS ED subscriber list of OM to NS PD subscriber list of NM in DS Table and proceeds to step 3316.

Step 3316 repeats steps 3318-3320 for all the subsequent ED slots related to the subscriber's expected demands in DS Table. The said repetition for subsequent ED slots in DS table is performed to check whether the new movie allocated to the subscriber based on the subscriber's incremental demand has been planned for the subscriber in any of the future ED slots. Hence, step 3318 checks whether NM allotted based on incremental demand is the same as the movie in the subsequent ED slot (OM′). If yes, step 3320 replaces movie (OM′) in the subsequent ED slot with old movie (OM).

FIG. 34 depicts real-time Demand Scheduling procedure of CVLDS. Real-time demands are demands for a slot that are received just before show timing. The real-time demand processing includes checking subscriber's SLA compliance, checking license availability for the demanded movie in the demanded slot, generation of FP triggers, and updating licenses and subscriber list in either preferred demand license allocation table or incremental demand license allocation table.

Step 3402 analyzes the demand received from the subscriber. Step 3404 checks whether the request is from a remote CCM. If the request is from remote CCM, step 3406 is performed otherwise step 3410 is performed. Step 3406 checks whether requested movie is available in requested slot. If requested movie is available in requested slot, step 3408 updates license availability for movie in IDLA table, checks for license kind migration and updates “given licenses” and corresponding CCM list in IDLA table. Step 3410 checks whether the real-time demand from the subscriber conforms to the subscriber's SLA. If demand does not conform to SLA, step 3412 is performed else 3418 is performed. Step 3412 checks whether the deviation from conformation is within a pre-defined tolerance. If deviation is within the tolerance, step 3416 sets SLA non-conformation (SLA-NC) flag and proceeds to step 3418. If deviation is beyond the tolerance limit, step 3414 requests the subscriber to make a compliant demand.

Step 3418 checks whether the requested movie is available in the requested slot. If available, step 3440 is performed else 3420 is performed. Step 3420 negotiates with other CCMs for the requested movie. Step 3422 checks whether negotiation is successful and if successful, proceeds to 3424 else perform 3432.

Step 3424 updates “borrowed licenses” and subscribers list in CDLA/IDLA table. Further, step 3426 updates Favor Point DB with negative favor points if SLA-NC flag is set and step 3428 is performed. Step 3428 sends confirmation to the subscriber and further, step 3430 performs incremental synchronization to update DS table to help manage previews.

Step 3432 negotiates with CSLM to acquire license for the requested movie in the requested slot and further, step 3434 checks whether negotiation is successful. If the negotiation is successful, step 3436 is performed otherwise, step 3438 informs operator for manual intervention.

Step 3436 increments available licenses in EDL table as an additional license was received from CSLM, updates “assigned licenses” in IDLA table, checks for license kind migration, updates subscribers list in IDLA table and further, performs step 3426.

Step 3440 updates “available licenses” and “assigned licenses” in CDLA/IDLA table, checks for license kind migration and updates subscribers' list in CDLA/IDLA table. Step 3442 updates negative favor points if SLA-NC flag is set, performs step 3444 to send confirmation to the subscriber, and further, step 3446 performs incremental synchronization.

FIG. 35 describes the steps involved in subscriber movie/slot re-planning procedure. The re-planning procedure is executed at the beginning of every slot period, every fifteen minutes if slot duration is fifteen minutes. Re-planning is invoked in case a subscriber fails to watch a demanded movie. Re-planning of movies for the subscriber is done to ensure that the subscriber is shown adequate previews for a movie identified in an alternate slot called backup slot and thereby enhancing the chances for license utilization.

Step 3502 repeats steps 3504-3514 at the beginning of every slot (S) period. In step 3504, the number of subscribers who should have ideally logged in is determined from PD subscriber list of DS Table for slot S and for all movies. In step 3506, the list of subscribers who have actually logged in is determined. Step 3508 repeats steps 3510-3514 for each subscriber who did not log in as planned for the slot under consideration. Step 3510 selects backup slot for the subscriber based on a backup slot that is closest to the slot S and further, determines license availability for movies based on the selected backup slot's <DS,DN>. In step 3512, a check is made to determine if license is available and if available, the movie for which license is available is made as the movie for the backup slot in step 3514.

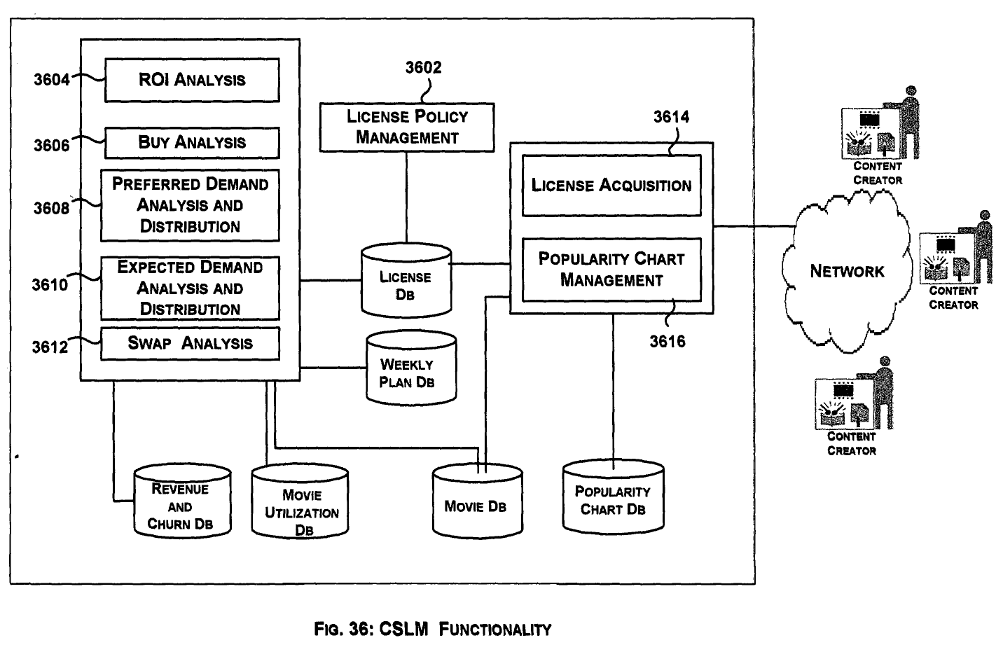

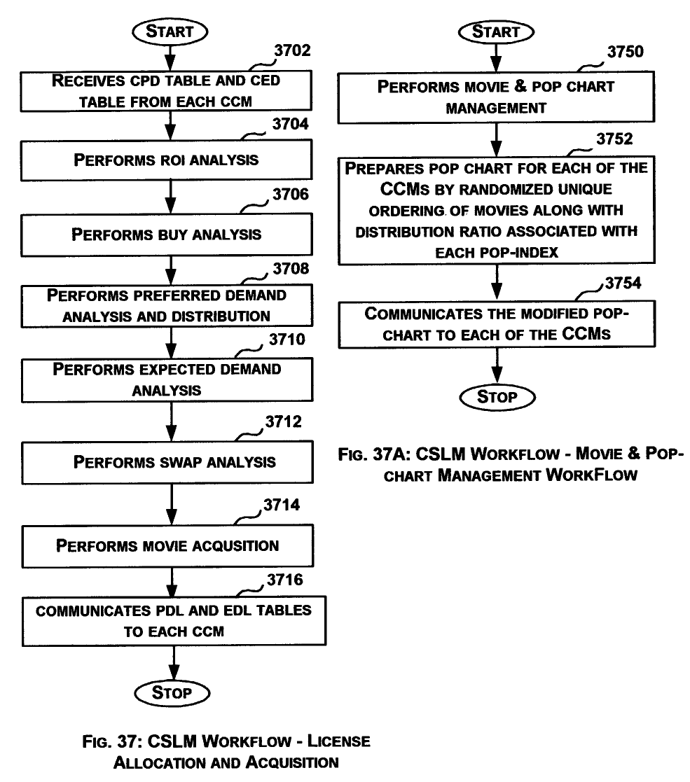

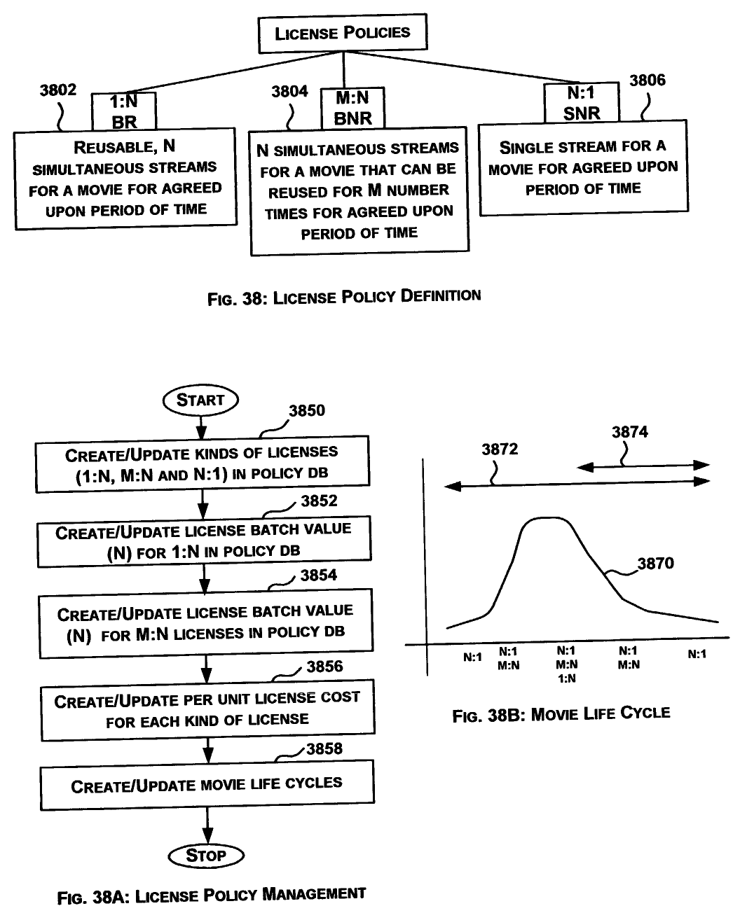

FIG. 36 depicts the functionality of the CSLM subsystem of the present invention. The CSLM subsystem comprises of License Policy Management Component 3602, ROI Analysis Component 3604, Buy Analysis Component 3606, Preferred Demand Analysis and Distribution Component 3608, Expected Demand Analysis and Distribution Component 3610, Swap Analysis Component 3612, License Acquisition and Swapping Component 3614, and Popularity Chart Management component 3616.

The License Policy Management Component 3602 of CSLM subsystem is responsible for managing three distinct kinds of licenses, namely bulk reusable, bulk non-reusable, and single non-reusable license kinds.

The ROI Analysis Component 3604 of CSLM subsystem is responsible for movie specific ranking of the CCMs based on the computation of movie churn rate, incurred expense for a movie, and revenue earned for a movie.

The Buy Analysis Component 3606 of CSLM subsystem is responsible for the selection of multiple movies for license acquisition based on allocated budget and consistent license utilization of the movie using upper watermark and movie life cycle analyses.

The Preferred Demand Analysis and Distribution Component 3608 of CSLM subsystem is responsible for analyzing subscribers' preferred demands and for determining near-optimal distribution of the movie licenses for preferred demands.

The Expected Demand Analysis and Distribution Component 3610 of CSLM subsystem is responsible for analyzing subscribers' expected demands and for determining utilization based distribution of the movie licenses for expected demands.

The Swap Analysis Component 3612 of CSLM subsystem is responsible for selecting movies for relinquishing licenses and if possible, for swapping with new licenses based on lower watermark and movie life cycle analyses.

The License Acquisition Component 3614 of CSLM subsystem is responsible for managing movie license acquisitions from distributors based on distributor swap potential and license exchange criteria of each distributor.

The Movie and Pop-Chart Management Component 3614 of CSLM subsystem is responsible for managing the interaction with external entities for managing symbolic and numeric feature updates for movies, movie content, updates for movie hierarchies, and popularity chart updates.

FIG. 37 CSLM Workflow—License Allocation and Acquisition describes the sequence of various license related activities executed in CSLM.

In step 3702, CSLM initially receives CPD table and CED table from each CCM. Step 3704 performs ROI analysis where CCMs of CVLDS are ranked based on the movie specific churn rate, incurred expense and generated revenue. Further, step 3706 performs buy analysis where licenses for movies to be acquired are identified based on allocated budget and consistent usage across CCMs. Further, step 3708 performs preferred demand analysis and distribution where available license are distributed near-optimally based on utilization and cost criteria to meet the preferred demands. Step 3710 performs expected demand analysis and distribution where available licenses are distributed based on the utilization criteria to meet as many expected demands as possible. Further, step 3712 performs swap analysis where the licenses that can be swapped from various distributors are identified based on life cycle of the movies and usage consistency of the movies that are part of CVLDS. Further, step 3714 performs license acquisition where the license acquisition package is prepared for each of the distributors from whom licenses need to be acquired, using the buy list and swap list prepared in the aforementioned buy and swap analysis. Step 3716 communicates PDL and EDL tables to each of the CCMs in CVLDS.

FIG. 37A CSLM Workflow—Movie & Pop-chart Management describes the sequence of various movie related activities performed in CSLM.

Step 3750 receives and updates movie and pop-chart information from external entities. Further, step 3752 prepares pop-chart, for each of the CCMs, by randomized unique ordering of movies along with distribution ratio associated with each pop-index. Distribution ratio is computed based on the available licenses for the movies grouped under a single <DS,DN> feature set within a pop-chart index. This distribution ratio is used by CCMs to efficiently identify movies during WP preparation. Step 3754 communicates the modified pop-chart to each of the CCMs of CVLDS.

FIG. 38 defines kinds of licenses and licensing policies of the CVLDS of the present invention. The three kinds of license kinds are bulk reusable, bulk non-reusable, and single non-reusable. The three kinds of license policies aid in achieving the license utilization objective of CVLDS by allowing the usage of a combination of these three kinds of licenses.

Step 3802 defines bulk reusable license kind where bulk reusable license is a set of N simultaneous streams for a movie for agreed upon period of time. During the agreed upon period of time, the bulk reusable license can be used unlimited number of times except for the constraint that once the usage of bulk reusable license begins, it can be reused only after the completion of the streaming of the associated movie. Grouping of more demands in slots that are movie duration apart for a particular movie results in optimal usage of bulk reusable license.

Step 3804 defines bulk non-reusable license kind where bulk non-reusable license kind is a set of N simultaneous streams for a movie that can be reused M number times, for agreed upon period of time. The bulk reusable license kind is used in a timeslot in which the subscribers' demands cannot be accommodated by the aforementioned 1:N license efficiently and also when more demands accumulate in and around a timeslot. During the agreed upon period of time, once the usage of bulk reusable license begins the licenses actually burn out and cannot be reused thereby reducing the value of M with usage.

Step 3806 defines single non-reusable license kind, N:1, where each license of single non-reusable license kind allows a single stream of movie. The single non-reusable license kind is used in a timeslot where subscribers' demand cannot be accommodated efficiently by the aforementioned 1:N and M:N license kinds. During the agreed upon period of time, once the usage of single non-reusable license begins the licenses actually burn out and cannot be reused.

FIG. 38A describes license policy management procedure of CVLDS where various parameters associated with license kinds can be created, modified, and/or deleted. Step 3850 creates/modifies the three different license kinds. Step 3852 creates/modifies the batch value N associated with bulk reusable license kind. Step 3854 creates/modifies the batch values N and M associated with bulk non-reusable license kind. Step 3856 creates/modifies per unit cost for each of the license kinds. Step 3858 manages life cycle of a movie to help the kinds of licenses to be acquired/relinquished at various times.

The life cycle of a movie, from the point of view of demand, typically follows a bell shaped curve. As soon as a movie is released, the demand for the movie slowly increases, reaches a peak after some time and then, gradually decreases. Hence, the proposed license policy management acquires/relinquishes licenses of different kinds based on a bell shaped curve.

FIG. 38B describes a typical life cycle of a movie. Graph 3870 describes the proposed license acquisition during various time periods. It is proposed to begin the license acquisition for a newly released movie by purchasing N:1 licenses and after some time enhancing with M:N kind and finally with 1:N kind during peak period. Range 3872 indicates the buy region in a movie life cycle and step 3874 indicates the swap region. In the buy region, licenses of different kinds are bought and also, it is possible to swap one kind of license to buy licenses of the same movie of different kind or additional licenses of another movie in the swap region.

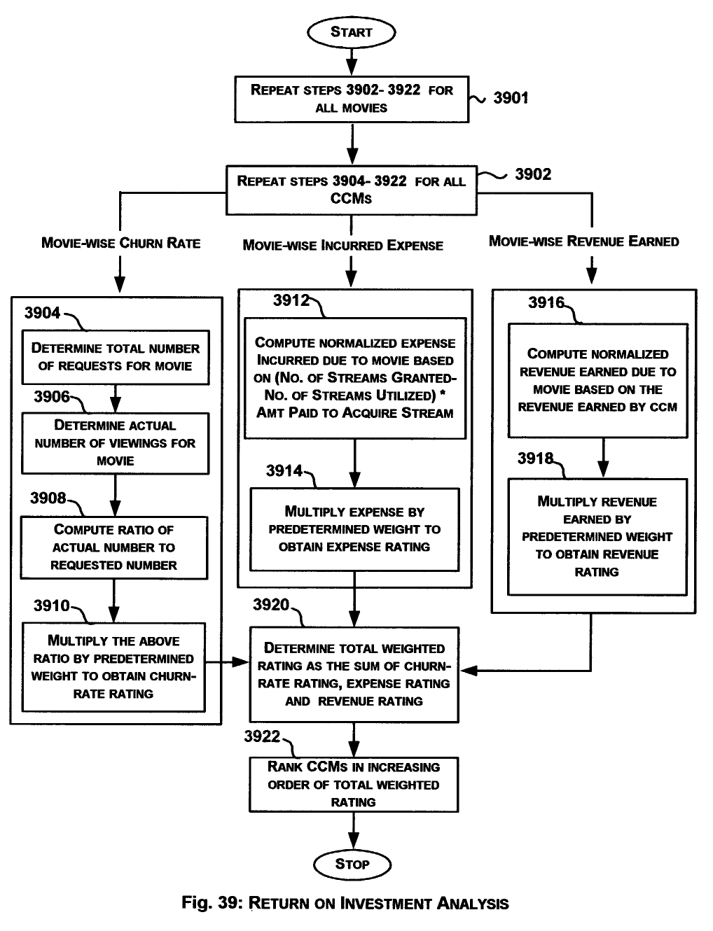

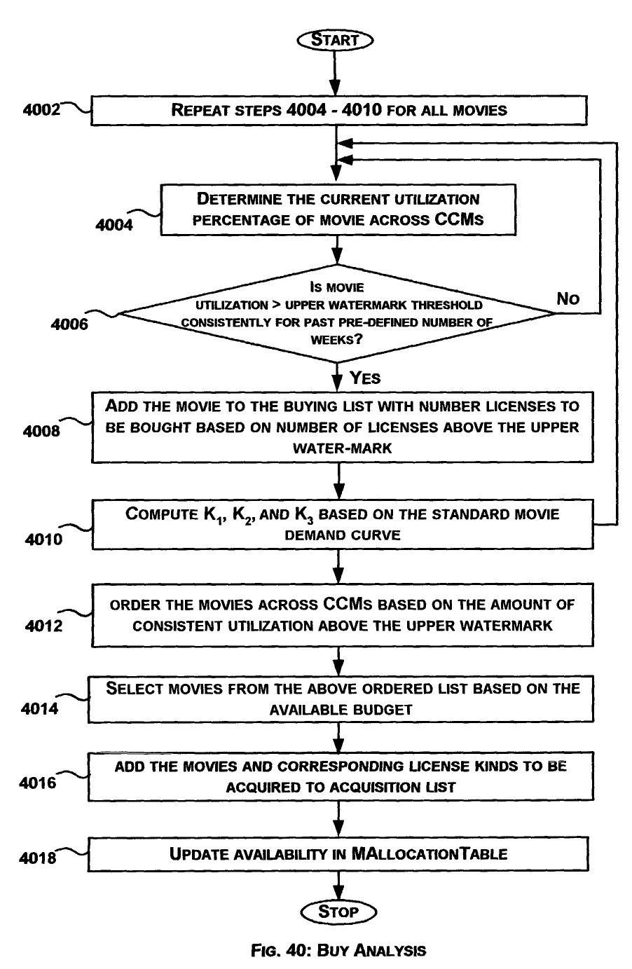

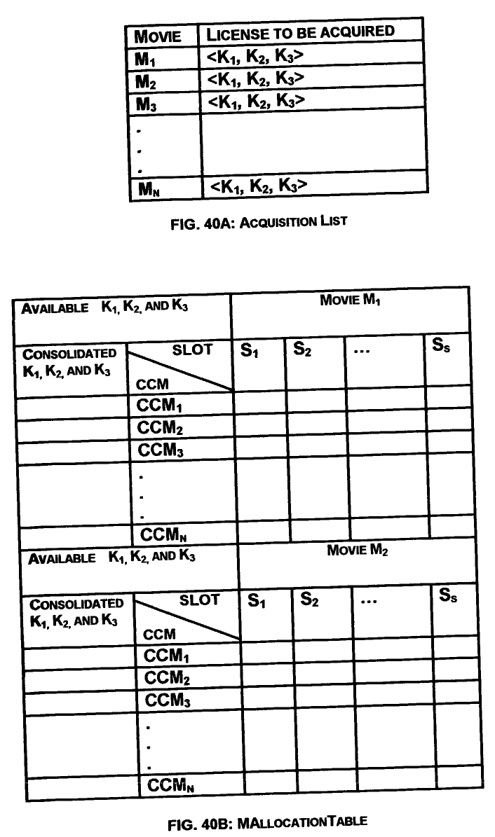

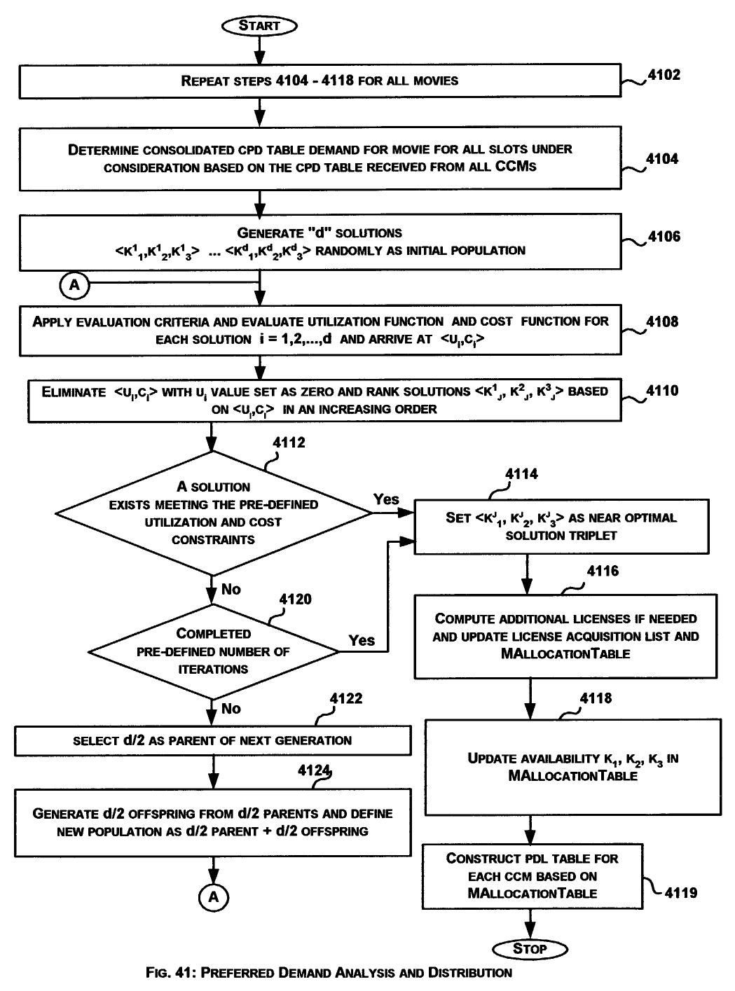

FIG. 39 describes steps involved in Return on Investment (ROI) Analysis procedure of CVLDS. The ROI analysis is performed for each movie that is demanded for the current week and the analysis ranks CCMs based on ratings computed by taking into account movie-wise churn rate, movie-wise revenue earned and movie-wise expense incurred. The ROI analysis aids in maintaining fairness across CCMs during movie-wise license distribution. Further, CVLDS comprises of means to attach a weight to churn rate, revenue earned and expense incurred with weights varying between 0 and 1.

Step 3901 repeats steps 3902-3922 for all movies that are part of the CVLDS. Step 3902 repeats steps 3904-3922 for all CCMs that are part of the CVLDS for each of the demanded movies using past data over a pre-defined number of weeks. Steps 3904-3910 describe steps involved in the determination of weighted ratings based on movie wise chum rate for each CCM.

Step 3904 determines the total number of licenses requested for the movie by the CCM during the past pre-defined number of weeks. Step 3906 determines the actual number of viewings for the movie by the CCM for the same period. Step 3908 computes the ratio of actual number of viewings for the movie to the total number of licenses requested for the movie by the CCM. Step 3910 multiplies the above ratio by a predetermined weight to obtain the final churn-rate rating for the CCM for the movie.

Steps 3912-3914 describe determination of rating based on movie wise incurred expense for each CCM.

Step 3912 computes expense incurred due to movie as

((Number of Streams Granted−Number of Streams Utilized)*(Amount Paid to Acquire Stream)/(Maximum expense incurred by one of the CCMs for that movie).

Step 3914 multiplies the above computed incurred expense by a predetermined weight to obtain the final expense rating for the CCM for the movie.

Steps 3916-3918 describe the determination of rating based on movie wise revenue earned for each CCM.

Step 3916 computes revenue earned due to the movie as the ratio of revenue earned by CCM to total revenue earned by all CCMs. Step 3918 multiplies the above computed revenue earned by a predetermined weight to obtain the final revenue rating for the CCM for the movie.

Step 3920 determines total weighted rating as the sum of churn-rate rating, expense incurred rating and revenue earned rating obtained in the above steps. Step 3922 ranks CCMs in increasing order of the total weighted rating.

For new movies, till such time data becomes available, movie independent ranking of CCMs is used to during the license distribution where the movie independent rating is based on the movie wise computational results.

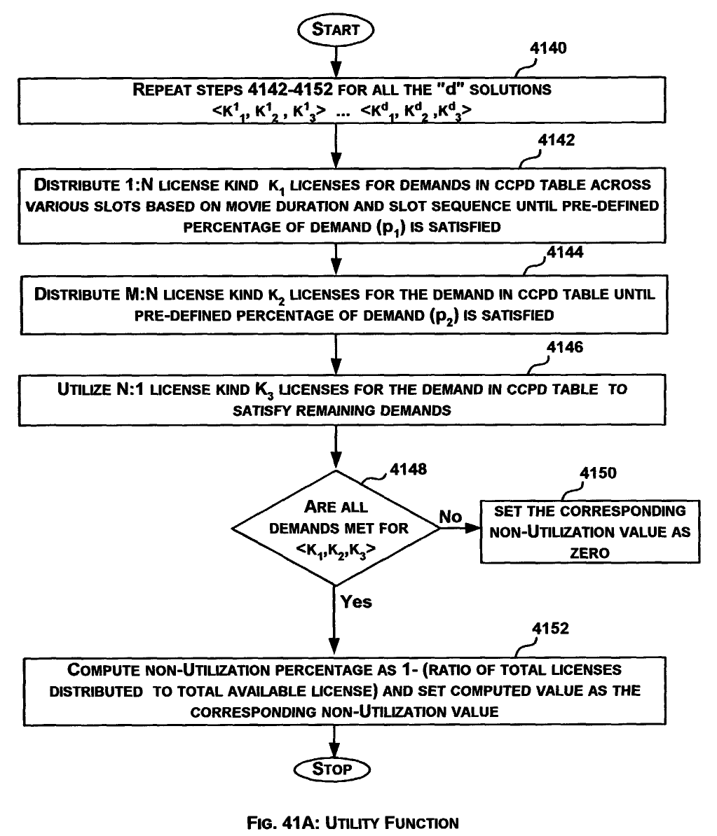

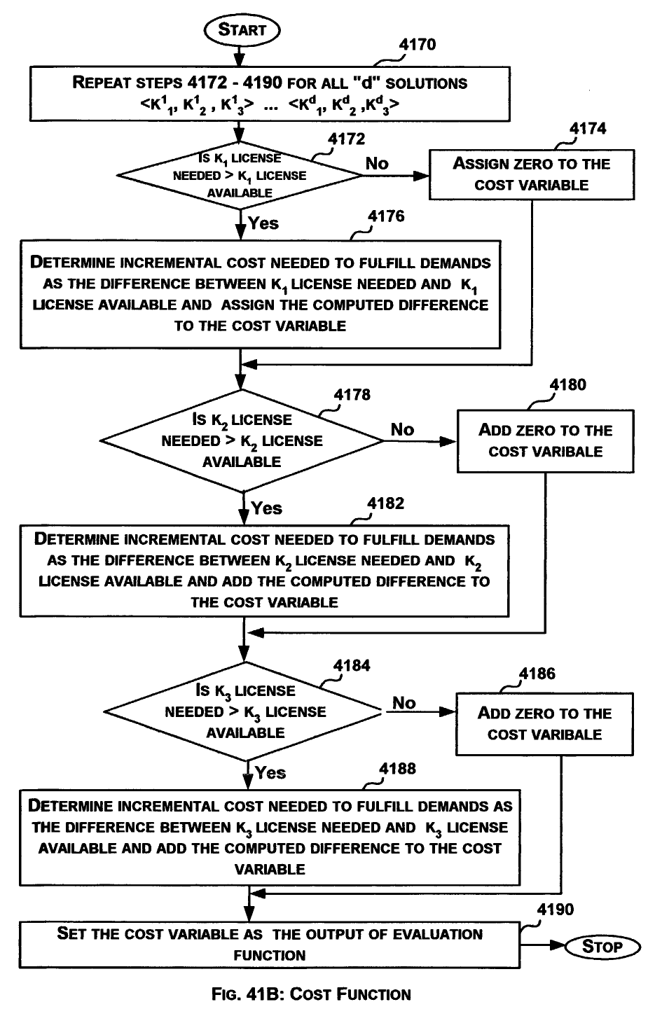

FIG. 40 describes steps involved in Buy Analysis procedure of CVLDS. Buy analysis procedure selects movies for which licenses need to be acquired based on an upper watermark analysis of the movies' license utilization and based on life cycle of the movies' where the license utilization is signified by high and consistent demand for the movies' across the CCMs.

Step 4002 repeats steps 4004-4010 for all the movies that are part of CVLDS.

Step 4004 determines the current utilization percentage of movie across CCMs. Further, step 4006 checks whether utilization of the movie is consistently higher than a pre-defined upper watermark threshold for the past pre-defined number of weeks. In case the utilization is consistently high, step 4008 is performed otherwise, step 4004 is performed. Step 4008 adds the movie and number of licenses to be bought to the buying list where the number of licenses to be bought are determined based on the increase in the utilization above the upper watermark level. Step 4010 further determines the number of licenses to be obtained, K₁, K₂, and K₃ respectively, for each license kind BR, BNR, and SNR based on the standard life cycle based movie demand curve. If movie is in its initial and early middle stages of life cycle, then preference is given to BNR and BR license kinds and if a movie is in its late middle and final stages, preference is given to SNR and BR license kinds. Step 4012 orders the consistently utilized movies across CCMs based on the amount of consistent utilization above the upper watermark. Step 4014 selects movies from the above ordered list based on the pre-defined available budget. Step 4016 adds movies and number of licenses of each license kind to be bought to acquisition list. Step 4018 updates the movie-wise availability K₁, K₂, K₃ field of MAllocationTable using the additional licenses to be acquired for the selected movies.

FIG. 40A provides the structure of Acquisition List.

FIG. 40B provides the structure of MAllocationTable.

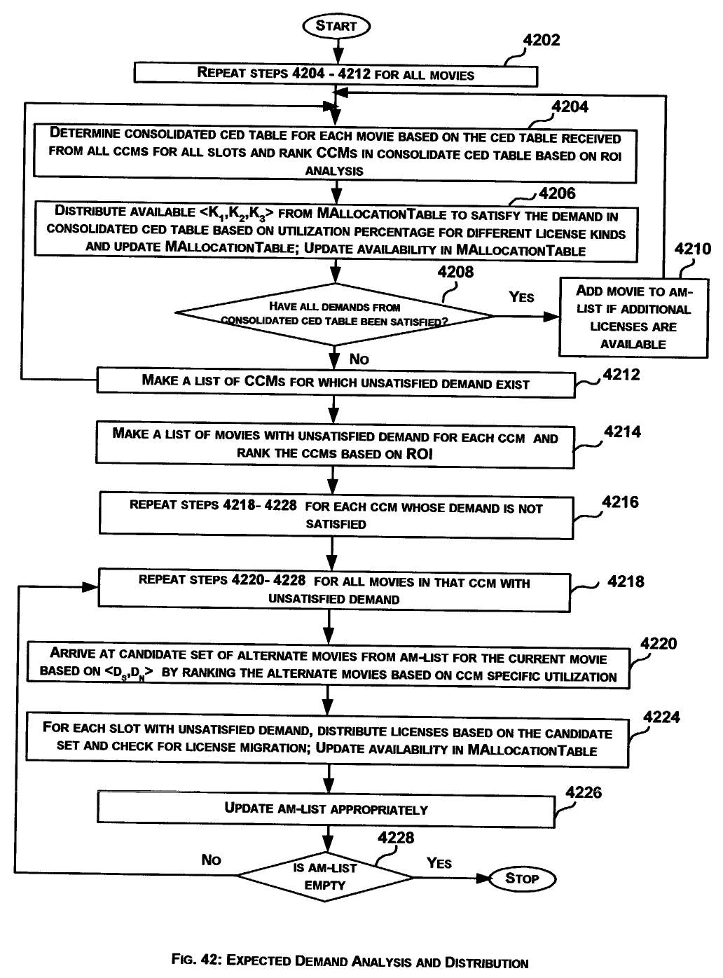

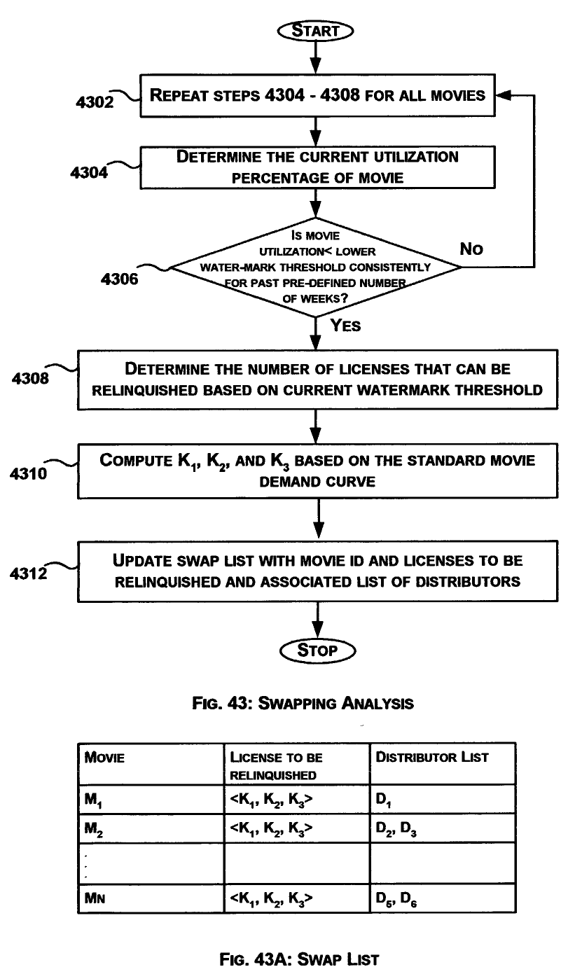

FIG. 41 describes steps involved in Preferred Demand Analysis and Distribution procedure of CVLDS. Preferred demands are demands confirmed by subscribers and CSLM receives the Consolidated Preferred Demand table from all CCMs in CVLDS. Preferred Demand Analysis and Distribution procedure determines the consolidated demand and performs a near-optimal distribution of available licenses of the plurality of license kinds, across CCMs for each of the demanded movies, using a stochastic optimization technique based on cost and utility functions. As preferred demands are demands confirmed by subscribers, licenses need to be acquired in case sufficient licenses are not available to meet all the demands in the consolidate preferred demand table.

Step 4102 repeats steps 4104-4118 for all movies that are part of CVLDS. Step 4104 determines consolidated demand (consolidated CPD table) for each movie for each slot based on the CPD table received from all CCMs. The order of CCMs in consolidate CPD table is based on the ROI specific ranking of CCMs. Step 4106 generates “d” solutions <k¹₁, k¹₂, k¹₃>, . . . , <k^{d}₁, k^{d}₂, k^{d}₃> randomly as initial population where k₁ is the number of bulk reusable license kind, k₂ is the number of bulk non-reusable license kind and k₃ is the number of single non-reusable license kind. The solution <kⁱ₁, kⁱ₂, kⁱ₃> indicates a hypothesis regarding the total number of licenses that might be required to meet the consolidated demand of all CCMs. Subsequent steps validate this hypothesis for its accuracy and makes a suitable correction to arrive at a better solution. Step 4108 applies evaluation criteria to determine the “goodness” of the solutions in the population by determining utilization and cost values <Uᵢ,Cᵢ> for all the “d” solutions using utility and cost functions where the value Uᵢ denotes the extent of non-Utilization of licenses <kⁱ₁, kⁱ₂, kⁱ₃> and C, is the total incremental acquisition cost value of <kⁱ₁, kⁱ₂, kⁱ₃>.

Step 4110 eliminates all solutions <kⁱ₁, kⁱ₂, kⁱ₃> if the corresponding <Uᵢ,Cᵢ> with value of Uᵢ being zero, indicates that the total available licenses is insufficient to meet the consolidated demand and further, ranks the remaining solutions <k^{j}₁, k^{j}₂, k^{j}₃> based on <Uⱼ, Cⱼ> in an increasing order. Step 4112 checks whether any of the remaining solutions <Uⱼ, Cⱼ> meets the pre-defined utilization and cost constraints. If pre-defined utilization and cost constraints are not met, then step 4120 is performed otherwise, if pre-defined utilization and cost constraints are met by the j^{th} solution, step 4114 sets <k^{j}₁, k^{j}₂, k^{j}₃> as the near-optimal solution triplet and step 4116 computes whether additional licenses are needed and updates license acquisition list. Further, step 4118 updates availability of licenses in MAllocationTable. Step 4119 constructs PDL table for each CCM based on MAllocationTable.

Step 4120 checks whether the aforementioned steps from 4108-4112 were performed for a pre-defined numbers of iterations. If yes, steps 4114-4119 are performed, otherwise step 4122 is performed. Step 4122 selects d/2 from the ranked solutions as parents to be part of the population for the next generation. If the number of ranked solutions is less than d/2, select as many available and generate additional random solutions to get d/2 parents to be part of the population for the next generation. Further, step 4124 generates d/2 offspring from the d/2 parents and defines new population as d/2 parents+d/2 offspring.

FIG. 41A describes the evaluation of non-utilization value for all the “d” solutions <k¹₁, k^{d}₂, k^{d}₃>, . . . , <k^{d}₁, k^{d}₂, k^{d}₃>.

Step 4140 repeats steps 4142-4152 for each of the “d” solutions <k¹₁, k¹₂, k¹₃>, . . . , <k^{d}₁, k^{d}₂, k^{d}₃>. Step 4142 distributes 1:N (BR) license kind k₁ licenses to demands in consolidate CPD table across various slots based on movie duration and slot sequence until a pre-defined percentage of demand (pl) is satisfied where a typical value of p₁ can be 70%. It is required to analyze multiple slot sequences to determine the best possible allocation of BR licenses as these licenses are reusable. Further, step 4144 distributes M:N (BNR) license kind k₂ licenses to the demands in consolidated CPD table until a pre-defined percentage of demand (p₂) is satisfied where a typical value p₂ can be 80%. Step 4146 utilizes N:1 (SNR) license kind k₃ licenses to distribute remaining demands in consolidated CPD table. Step 4148 checks whether the triplet <k₁, k₂, k₃> satisfies all demands in the consolidated CPD Table. In case if all demands are not met, step 4150 is performed where the corresponding non-Utilization is set as zero. In case if all demands are met, step 4152 is performed. Step 4152 computes non-Utilization percentage as 1—(ratio of total licenses distributed to total available <k₁, k₂, k₃> licenses) and sets the computed value as the corresponding non-Utilization value. The total available licenses is computed as the sum of k₁ times the unit license of BR, k₂ times the unit license of BNR and k₃ times the unit license of SNR.

FIG. 41B describes the evaluation of incremental cost value for all the “d” solutions <k¹₁, k¹₂, k¹₃>, . . . , <k^{d}₁, k^{d}₂, k^{d}₃>.

Step 4170 repeats steps 4172-4190 for each of the “d” solutions <k¹₁, k¹₂, k¹₃>, . . . , <k^{d}₁, k^{d}₂, k^{d}₃>. Step 4172 checks whether k₁ licenses needed is greater than k₁ licenses available for the movie under consideration. If more of k₁ licenses are needed, then step 4176 is performed otherwise, step 4174 is performed where cost variable of the evaluation function is set as zero. Step 4176 determines the incremental cost needed to fulfill the demands as the product of per unit cost of BR and the difference between k, licenses needed and k₁ licenses available and assigns the computed product to the cost variable of the evaluation function. Step 4178 checks whether k₂ licenses needed is greater than k₂ licenses available for the movie. If more of k₂ licenses are needed, then step 4182 is performed otherwise, step 4180 is performed where zero is added to the cost variable of the evaluation function. Step 4182 determines incremental cost needed to fulfill the demands as the product of per unit cost of BNR and difference between k₂ licenses needed and k₂ licenses available and adds the computed product to the cost variable of the evaluation function. Step 4184 checks whether k₃ licenses needed is greater than k₃ licenses available for the movie. If more of k₃ licenses are needed, then step 4188 is performed otherwise, step 4186 is performed where zero is added to the cost variable of the evaluation function. Step 4188 determines incremental cost needed to fulfill the demands as the product of per unit cost of SNR and difference between k₃ licenses needed and k₃ licenses available and adds the computed product to the cost variable of the evaluation function. Further, step 4190 sets the cost variable as the output of evaluation function.

FIG. 42 describes steps involved in Expected Demand Analysis and Distribution procedure. Expected movies are additional movies predicted for a subscriber in order to fill the subscriber's expected demands for the week and CSLM receives the Consolidated Expected Demand table from all CCMs in CVLDS. Expected Demand Analysis and Distribution procedure determines the consolidated demand and distributes the available licenses of the plurality of license kinds across CCMs for each of the demanded movies based on pre-defined utilization percentage associated with each of the license kinds. The distribution of licenses is done in the order of CCM ranking based on ROI analysis. This is to ensure that the system objective of zero reject of movies, maximizing license utilization and minimizing churn rate is achieved. In case of non-availability of licenses to meet the expected demands for a particular movie, an alternate movie with the same movie characteristic is selected to meet the unsatisfied expected demands.

Step 4202 repeats steps 4204-4212 for all movies that are part of the expected demand. Step 4204 determines consolidated CED table (consolidated CED table) for each movie based on the CED table received from all CCMs for all slots. Step 4206 distributes available <k₁, k₂, k₃> from MAllocationTable to satisfy the demand in consolidated CED table based on the pre-defined utilization percentage for license kinds where distribution of licenses is to ensure that the demands of CCMs are met in their ROI based ranked order and updates MAllocationTable. Further, step 4206 also updates license availability in MAllocationTable. Step 4208 checks whether all demands in the consolidated CED table are met. If yes, step 4210 adds available additional licenses to AM-list. If demands are not met, step 4212 makes a list of CCMs for which unsatisfied demand exist. AM-list contains a list of movies for which additional licenses are available that could be used to meet the unsatisfied demands from CCMs.

Step 4214 prepares a list of movies with unsatisfied demand for each CCM and ranks CCMs based on the ROI Analysis. Step 4216 repeats steps 4218-4228 for all CCMs whose demands have been partially met. Step 4218 repeats steps 4220-4228 for all movies associated with a given CCM with unsatisfied demand. Step 4220 arrives at a candidate list of alternate movies from AM-list for the current movie based on <DS, DN> and further, by ranking the alternate movies based on CCM specific utilization. As license is not available for the originally demanded movie, an attempt is made to identify a best-fit movie as a replacement for which licenses are available. This “fitness” is based on symbolic and numeric features associated with the original movie and the movies that are in AM-list. Further, in order to ensure the better utilization of such an alternate movie, CCM's past utilization history of the identified alternate movies is used in the selection process. Step 4224 distributes licenses for each slot with unsatisfied demand based on the candidate set and performs license kind migration if necessary and further, updates MAllocationTable. Further, step 4224 also updates the license availability in MAllocationTable. Step 4226 updates AM-list for the utilized licenses. Step 4228 checks whether AM-list is empty. If AM-list is not empty, step 4218 is repeated for the next movie in AM-list.

FIG. 43 describes steps involved in Swapping Analysis procedure of CVLDS. Swapping of licenses aid the system in investing on those movies for which there is a more demand and disinvesting on those movies for which there is a lesser demand. Hence, during buy-time, an effort is made to identify the movies with lesser demand and these movies are swapped to buy licenses. SLA between a distributor and CVLDS identifies distributor specific, movie-independent swap ratio that is used during swapping. Further, in order to build loyalty, swap with respect to a distributor is restricted the total past buys and planned current buys.

Swap analysis identifies a movie for which licenses need to be relinquished based on lower watermark analysis of the movie's license utilization signified by low and consistent decrease in demand for the movie across the system. The swap analysis further determines the number of each kind of licenses to be relinquished based on the life cycle analysis of the movie.

Step 4302 repeats steps 4304-4308 for all the movies that are part of CVLDS. Step 4304 determines the current utilization percentage of movie across CCMs. Further, step 4306 checks whether the utilization of the movie is consistently lower than the pre-defined lower watermark threshold for the past pre-defined number of weeks. In case the utilization is low consistently, step 4308 is performed otherwise, step 4304 and step 4306 is repeated for the next movie. Step 4308 determines the number of licenses to be relinquished based on the decrease in the utilization below the lower watermark level. Step 4310 determines the number of each one of the license kinds to be relinquished based on standard movie demand curve. Step 4312 adds movies, number of licenses of each license kind to be relinquished and the corresponding distributors to Swap list.

FIG. 43A describes Swap list format.

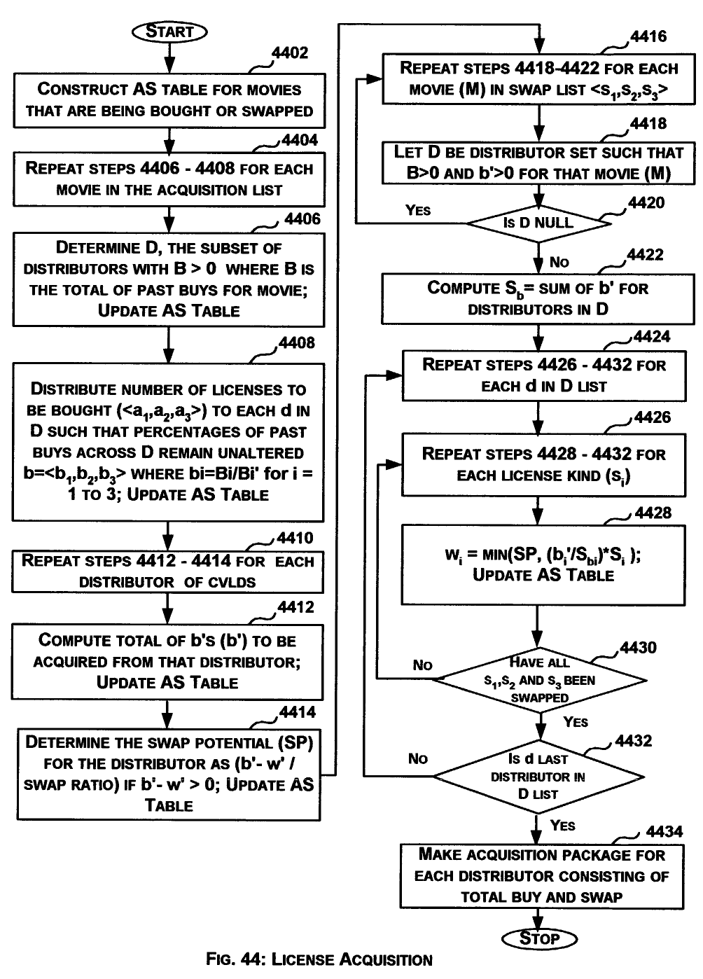

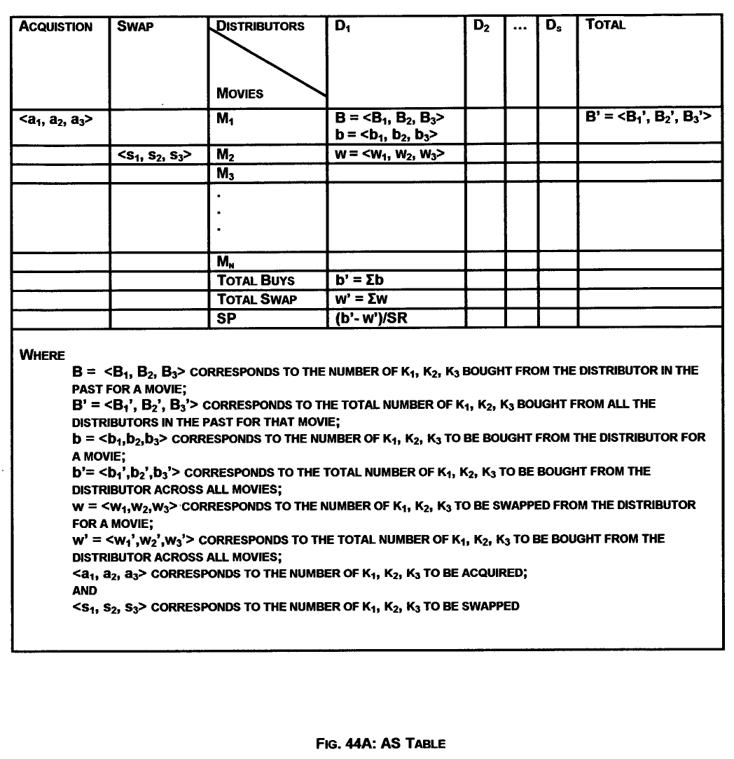

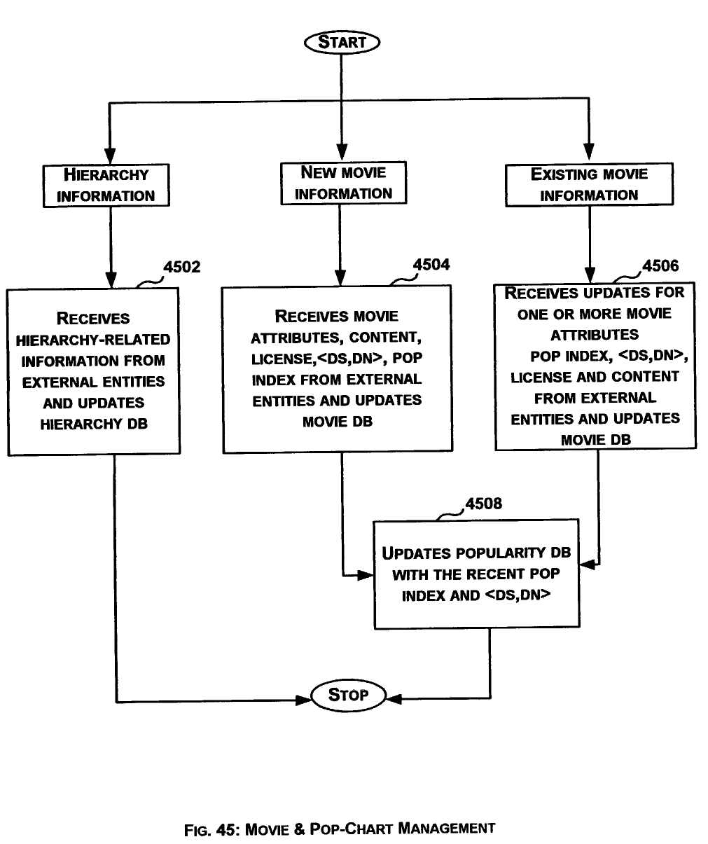

FIG. 44 describes License Acquisition procedure of CVLDS. License acquisition procedure prepares an acquisition package for acquiring licenses for movies present in acquisition list from the distributors such that the overall percentage distribution of licenses acquired from these distributors remains the same. In order to avail loyalty based discounts, the licenses of the movies to be relinquished is swapped, if possible, with the distributors from whom new licenses are being planned to be acquired.

Step 4402 constructs AS Table for movies that are being bought or swapped with B=<B₁, B₂, B₃> denoting the number of license of different kinds bought from a distributor in the past for a movie and B′=<B₁′, B₂′, B₃′> denoting the total number of licenses of different kinds bought from all the distributors in the past for the movie. Step 4404 repeats steps 4406-4408 for each movie in the Acquisition list. Step 4406 determines D, the subset of distributors with B>0 where B is the total of past buys for the movie under consideration. Step 4408 distributes number of licenses to be bought <a₁, a₂, a₃> from each distributor in D such that the percentages of past buys across D remain unaltered. Step 4408 also updates AS Table with b=<b₁, b₂, b₃> for each movie for each distributor in D.

Step 4410 repeats steps 4412-4414 for each distributor of CVLDS. Step 4412 computes the total number of license's to be bought (b′) from d in D across all the movies. Step 4412 also updates AS Table with b=<b₁, b₂, b₃> for each movie for each distributor and b′=<b₁′, b₂′, b₃′> for each distributor in D. Step 4414 determines the swap potential (SP) for the distributor d as (b′−w′)/swap ratio where the swap ratio is a pre-defined constant and typical value of swap ratio can be 4. If (b′−w′)<0, then SP is set as zero. The swap ratio indicates that for a single unit of license of a movie to be acquired, swap ratio units of licenses acquired from the same distributor need to be swapped. Step 4416 repeats steps 4418-4422 for each movie in Swap list. Step 4418 determines distributor set D such that B>0 and b′>0 for the movie (M) under consideration in Swap list. In other words, in order to swap licenses from a distributor, not only some licenses for M should have been bought from the distributor in the past but also some licenses are being planned to be bought from the distributor during current acquisition process. Step 4420 checks whether the distributor set D is null. If the distributor set is null, steps 4418-4422 are repeated for the next movie in Swap list. If the distributor set is not null, step 4422 computes Sb as the sum of b′ associated with each distributor in D. Step 4424 repeats step 4426-4432 for each d in D list. Step 4426 repeats steps 4428-4432 for each license kind Sᵢ associated with the movie M. Step 4428 determines wᵢ as min(SP, (b_{i′/S}_{bi})*Sᵢ) where wᵢ is the number of licenses of i^{th} license kind to be swapped from distributor d for movie M. Step 4428 also updates AS Table with w′=<w₁′, w₂′, w₃′>. Step 4430 checks whether swapping is completed for all license kinds S₁, S₂, S₃ for the distributor. If swapping is not completed, step 4426 is repeated. If completed, step 4432 checks whether d is last distributor in D list. If d is not the last distributor then step 4424 is repeated. Otherwise, step 4434 prepares an acquisition package for each distributor consisting of licenses for the movies to be bought and licenses of the movies to be swapped from the distributor.

FIG. 45 describes Movie & Pop Chart Management procedure of CVLDS. Movie & Pop Chart Management procedure interacts with external entities for managing symbolic and numeric feature updates for new and old movies, managing updates for movie hierarchies, and managing popularity chart updates.

Step 4502 receives hierarchy-related information from the external entities and updates Movie DB of CVLDS. Step 4504 receives movie attributes, content, license, <DS, DN> and pop index from the external entities for a new movie and updates Movie DB of CVLDS. Step 4506 receives updates for one or more movie attributes, content, license, <DS, DN> and pop index from the external entities and updates movie database of CVLDS for an existing movie and further, step 4508 updates Popularity Chart DB with the recent pop index and <DS,DN>.

Thus, a system and method for video license distribution based on zero-reject policy for maximizing license utilization and minimizing churn rate has been disclosed. Although the present invention has been described particularly with reference to the figures, it will be apparent to one of the ordinary skill in the art that the present invention may appear in any number of systems that performs video distribution. It is further contemplated that many changes and modifications may be made by one of ordinary skill in the art without departing from the spirit and scope of the present invention.

Acronym List

| | |
|---|---|
| 1. AM | ALTERNATE MOVIE |
| 2. BNR | BULK NON-REUSABLE |
| 3. BR | BULK REUSABLE |
| 4. CCM | COMMUNITY CONTENT MANAGER |
| 5. CED | CONSOLIDATED EXPECTED DEMAND |
| 6. CPD | CONSOLIDATED PREFERRED DEMAND |
| 7. CSLM | CONTENT STORAGE AND LICENSE MANAGER |
| 8. CVC | COMMUNITY VIEW CENTRE |
| 9. CVLDS | COMPRHENSIVE VIDEO LICENSE DISTRIBUTION |
| | SYSTEM |
| 10. DS | DEMAND SCHEDULING |
| 11. ED | EXPECTED DEMAND |
| 12. EDL | EXPECTED DEMAND LICENSE |
| 13. EG | EXCEPTION GROUP |
| 14. FP | FAVOR POINT |
| 15. GTO | GIVE AND TAKE OFFER |
| 16. IDLA | INCREMENTAL DEMAND LICENSE ALLOCATION |
| 17. ISG | INTER-SLOT GAP |
| 18. LSM | LOCAL SUBSCRIBER MANAGER |
| 19. MCFV | MOVIE COUNT FREQUENCY VECTOR |
| 20. MTTR | MEAN TIME TO REPAIR |
| 21. NACK | NO ACKNOWLEDGEMENT |
| 22. NG | NORMAL GROUP |
| 23. PD | PREFERRED DEMAND |
| 24. PDL | PREFERRED DEMAND LICENSE |
| 25. PDLA | PREFERRED DEMAND LICENSE ALLOCATION |
| 26. ROI | RETURN ON INVESTMENT |
| 27. SLA | SERVICE LEVEL AGREEMENT |
| 28. SNR | SINGLE NON-REUSABLE |
| 29. URL | UNIVERSAL RESOURCE LOCATOR |
| 30. VOD | VIDEO ON DEMAND |
| 31. WP | WEEKLY PLAN |

What is claimed is:

1. A comprehensive video license distribution system based on zero-reject model for maximizing usage of licenses and minimizing churn rate, said comprehensive video license distribution system comprising:
a) a subsystem local subscriber manager for managing subscriber related information, said local subscriber manager comprising:
a subscriber manager element for managing SLAs, subscriber group identification, and weekly plan confirmation;
a favor point element for managing FP specific SLA parameters, FP policies, and FP-based subscriber migrations;
a billing element for managing subscriber bill discounts based on subscriber specific FPs;
a preview element for managing URL based, sponsor based, and login time previews and previews for community viewings;
a complaint element for performing root cause analysis of complaints and subscriber churn analysis; and
b) a subsystem community content manager for analyzing past movie viewing pattern and periodic subscriber specific planning and scheduling of movies, said community content manager comprising:
a movie description element that uses the description of movies, wherein each said movie is aptly described using a plurality of symbolic and numeric features;
a hierarchy description element that uses plurality of hierarchical description of a collection of movies, wherein each said hierarchy consists of multiple nodes with each node aptly described using symbolic and numeric features;
a movie count element that predicts plurality of movies that most probably be viewed by a subscriber in a week;
a movie feature identification element for subscriber specific analysis of past movie viewing pattern and prediction of representative symbolic and numeric features representing the movies that most probably be viewed by said subscriber in a week;
a movie selection element for subscriber specific selection of plurality of movies based on representative symbolic and numeric features of said subscriber and the movies in popularity chart, wherein said popularity chart describes movies in the order of the popularity of said movies;
a slot selection element for subscriber specific prediction of plurality of most probable slots based on the analysis of slot occupancy and inter-slot gap, wherein said slot is a possible show timing;
a movie slot matching element for the best possible subscriber specific symbolic and numeric feature matching of the most probable movies with the most probable slots;
a weekly plan preparation element for the preparation of subscriber specific weekly plan consisting of preferred demand and expected demand;
a preferred demand bulk allocation element for the allocation of allotted licenses to meet preferred demand;
an expected demand bulk allocation element for the allocation of allotted licenses to meet expected demand using subscriber specific past data consisting of complaints, revenue, and successful viewings, past favor points, and SLA type;
a subscriber ranking element for the ranking of based on a plurality of factors consisting of subscriber specific past data consisting of complaints, revenue, and successful viewings, past favor points, and SLA type
an alternate movie allocation element for managing shortage of licenses to meet expected demands;
an incremental demand scheduling element for analyzing and scheduling of incremental demands of subscribers and generating FP triggers;
a real-time demand scheduling element for analyzing and scheduling of near real-time demands of subscribers and generating FP triggers;
a re-planning element for modifying subscriber specific weekly plan based on the comparison of actual and planned viewings; and
c) a subsystem content storage and license manager for managing license acquisition, swapping, and near-optimal distribution, said content storage and license manager comprising:
a license management element for managing three distinct kinds of license, wherein said kinds of license consists of bulk reusable, bulk non-reusable, and single non-reusable licenses;
a return on investment element for movie specific ranking community content managers, wherein ranking is based on weighted sum of rating due to said movie churn rate, rating due to said movie incurred expense, and rating due to said movie revenue earned;
a buy analysis element for managing the selection of plurality of movies for license acquisition based on consistent utilization of said each movie using upper watermark and life cycle analyses;
a preferred demand allocation element for analyzing and near-optimal distribution of the movie licenses for preferred subscriber demands;
an expected demand allocation element for the distribution of available licenses to meet the expected demand based on near-optimal maximization of license utilization;
a swap analysis element for managing the selection of plurality of movies for swapping based on consistent non-utilization of said each movie using lower watermark and life cycle analyses;
a license acquisition element for managing movie license acquisition from distributors based on swap potential and license exchange criteria of said each distributor;
a movie and popularity chart manager element for interaction with external entities for managing symbolic and numeric feature updates for movies, updates for movie hierarchies, and popularity chart updates.

2. The system of claim 1, wherein said subscriber manager element of said subsystem local subscriber manager comprises means for subscriber registration and crafting of SLAs.

3. The system of claim 2, wherein said subscriber manager element further comprises means for analyzing of subscribers to classify said subscribers into one of plurality of subscriber groups, wherein said subscriber groups consists of normal group and exception group, wherein said exception group consists of new subscribers, unpredictable subscribers, potential churn subscribers, and non weekly plan participation subscribers.

4. The system of claim 2, wherein said subscriber manager element further comprises means for interacting with subscribers to seek confirmation for subscriber specific weekly plans from said subscribers.

5. The system of claim 1, wherein said favor point element of said subsystem local subscriber manager includes means for defining FP rules as part of an SLA.

6. The system of claim 5, wherein said favor point element further comprises means for defining, modification and deletion of FP rules.

7. The system of claim 5, wherein said favor point element further comprises means for computing subscriber favor points and accumulating said favor points based on FP triggers, wherein said FP triggers are generated during transaction processing.

8. The system of claim 5, wherein said favor point element further comprises means for analyzing subscriber favor points for subscriber type migration, wherein said subscriber favor points are the accumulated favor points over a period of time using a set of rules.

9. The system of claim 5, wherein said favor point element further comprises means for analyzing subscriber favor points for FP expiry, wherein said FP expiry is based on a set of rules.

10. The system of claim 1, wherein said billing element of said subsystem local subscriber manager comprises means for computing subscriber billing discount, wherein said subscriber billing discount is determined based on the accumulated favor points over a period of time using a set of rules.

11. The system of claim 1, wherein said preview element of said subsystem local subscriber manager comprises means for utilization of preview capsules, wherein said preview capsules are part of preview package of a movie, said utilization is based on ensuring equal usage of preview capsules.

12. The system of claim 11, wherein said preview element further comprises means for processing subscriber specific URL preview events to stream one of plurality of preview capsules, wherein said preview capsules include previews of forthcoming, subscriber specific preferred, and subscriber specific expected movies.

13. The system of claim 11, wherein said preview element further comprises means for processing subscriber specific sponsor click events to stream one of plurality of preview capsules, wherein said preview capsules include previews of forthcoming, subscriber specific preferred, and subscriber specific expected movies.

14. The system of claim 11, wherein said preview element further comprises means for processing post login events to stream one of plurality of preview capsules, wherein said preview capsules include previews of forthcoming movies and subscriber specific preferred or subscriber specific expected movies pertaining to next immediate subscriber-specific show time.

15. The system of claim 11, wherein said preview element further comprises means for streaming community movie related previews, wherein said community movie is screened at plurality of community viewing centers.

16. The system of claim 1, wherein the said complaint element of said subsystem local subscriber manager comprises means for root cause analysis of subscriber specific new complaints, wherein said root cause analysis analyses criticality of root cause to determine the potential churn status of said subscriber.

17. The system of claim 16, wherein the said complaint element further comprises means for periodic subscriber specific analysis of complaints, wherein said analysis compares subscriber specific MTTR sequence of said complaints with system defined MTTR sequence to determine the potential churn status of said subscriber.

18. The system of claim 1, wherein said movie count element of said subsystem community content manager comprises means for analyzing day-wise past subscriber movie viewing pattern, determining day-wise weighted movie count based on movie recency, and identifying subscriber specific week-wise most probable movie count.

19. The system of claim 1, wherein said movie feature identification element of said subsystem community content manager comprises means for classifying movies viewed by subscriber during past pre-defined number of weeks into best possible leaf nodes of each one of plurality of hierarchies, wherein said movie classification is based on symbolic and numeric feature set of said movies.

20. The system of claim 19, wherein said movie feature identification element further comprises means for identifying best possible plurality of representative nodes of plurality of hierarchies for collection of movies viewed by subscriber during past pre-defined number of weeks, wherein said representative nodes are most general description of said collection of movies with respect to said hierarchies, wherein said most general description is derived by recursively climbing said hierarchies based on weighted movie count derived using movie recency factor.

21. The system of claim 19, wherein said movie feature identification element further comprises means for identifying and deriving subscriber specific combined symbolic and numeric feature set, wherein said identification is based on said subscriber specific minimum number of most general representative nodes from plurality of hierarchies and said derivation is based on logical OR of symbolic features and union of numeric ranges of numeric features associated with said most general representative nodes, wherein said representative nodes together maximally cover the movies viewed by said subscriber during past pre-defined number of weeks.

22. The system of claim 19, wherein said movie feature identification element further comprises means for predicting subscriber specific symbolic and numeric feature set based on combined symbolic and numeric features sets representing movies viewed by said subscriber during past pre-defined number of weeks, wherein said prediction involves prediction of symbolic and numeric feature set, wherein said prediction of symbolic feature set is based on logical AND of plurality of subsets, wherein each said subset is a maximal subset of as many disjuncts in as many said combined symbolic feature sets, wherein said prediction of numeric feature set is based on union of plurality of most similar ranges, wherein each said range generalizes plurality of ranges of said numeric feature of plurality of numeric features sets of said combined numeric feature sets.

23. The system of claim 1, wherein said movie selection element of said subsystem community content manager comprises means for ranking of movies in subscriber specific popularity chart based on distance between said subscriber specific predicted symbolic and numeric feature set and symbolic and numeric features sets associated with said movies in said popularity chart, wherein said subscriber specific popularity chart consists of movie types compliant with SLA of said subscriber and movies not so far viewed by said subscriber.

24. The system of claim 23, wherein said movie selection element further comprises means for selecting plurality of movies from ranked popularity chart, wherein said selection accounts for subscriber specific predicted movie count, wherein each of said movie count movies is from distinct ranked index, wherein said ranked index is associated with said ranked popularity chart.

25. The system of claim 24, wherein said selection is based on distribution ratio, wherein said distribution ratio is based on available licenses of said movies in said popularity chart.

26. The system of claim 24, wherein said selection is iteratively performed based on SLA type, wherein said selection is for each subscriber with said SLA type.

27. The system of claim 1, wherein said slot selection element of said subsystem community content manager comprises means for ranking subscriber specific slots, wherein said ranking is based on weighted slot occupancy due to movies viewed by said subscriber during past pre-defined number of weeks.

28. The system of claim 27, wherein said slot selection element further comprises means for selecting subscriber specific movie count number of pinned slots, wherein said selection is from ranked said subscriber slots day-wise over a week and said selected slots are said subscriber specific inter-slot gap apart, wherein said inter-slot gap is based on the most frequent time period between movies viewed most frequently in said movie count number of pinned slots on said day.

29. The system of claim 27, wherein said slot selection element further comprises means for selecting subscriber specific day-wise backup slots, wherein said selection involves selecting a number of slots from ranked said subscriber slots day-wise over a week, wherein said number is the difference between pre-defined maximum movie count for said day and the number of selected pinned slots for said day and said slots are pre-defined minimum inter-slot gap apart from said pinned slots and other said backup slots.

30. The system of claim 27, wherein said slot selection element further comprises means for identifying subscriber specific slot specific symbolic feature set, wherein each disjunct of said symbolic feature set is contained in one of disjuncts of said subscriber specific predicted symbolic feature set and each symbolic atomic feature of said symbolic feature set is contained in symbolic feature set of each of a number of movies, wherein each of said plurality of movies is a movie viewed by said subscriber in said slot over past pre-defined number of weeks and said number exceeds pre-defined threshold.

31. The system of claim 27, wherein said slot selection element further comprises means for identifying subscriber specific slot specific numeric feature set, wherein each range of each element of said numeric feature set is part of said subscriber specific predicted numeric feature set, wherein said range of said element contains element of numeric feature set of each of a number of movies, wherein each of said plurality of movies is a movie viewed by said subscriber in said slot over past pre-defined number of weeks and said number exceeds pre-defined threshold.

32. The system of claim 1, wherein said movie slot matching element of said subsystem community content manager comprises means for matching of subscriber specific movies to subscriber specific slots, wherein said each matching is based on maximum degree of similarity between symbolic and numeric features associated with said each movie and symbolic and numeric features associated with said each slot.

33. The system of claim 1, wherein said weekly plan preparation element of said subsystem community content manager comprises means for computing subscriber specific number of preferred and expected movies, wherein said preferred number of movies are said subscriber confirmed and said computation of preferred movies is based on said subscriber specific prediction factor and subscriber specific movie count, wherein said computation of said expected movies is based on one minus subscriber specific prediction factor and subscriber specific movie count.

34. The system of claim 33, wherein said weekly plan preparation element further comprises means for construction of preferred demand table, wherein said construction is based on movie-wise consolidation of preferred demands from subscribers.

35. The system of claim 33, wherein said weekly plan preparation element further comprises means for construction of expected demand table, wherein said construction is based on movie-wise consolidation of computed expected demands for subscribers.

36. The system of claim 1, wherein said preferred demand bulk allocation element of said subsystem community content manager comprises means for checking of allotted licenses with respect to preferred demand table and updating demand schedule table, wherein said updation copies subscribers in said preferred demand table to said demand schedule table creating movie-slot specific subscriber lists.

37. The system of claim 36, wherein said preferred demand bulk allocation element further comprises means for allocating preferred demand licenses in preferred demand license allocation table, wherein said allocation assigns licenses and subscribers to movie specific slots in said preferred demand license allocation table and further updates license availability for each of plurality of license kinds in said preferred demand license allocation table.

38. The system of claim 1, wherein said expected demand bulk allocation element of said subsystem community content manager comprises means for checking of allotted licenses with respect to expected demand table and updation of demand schedule table, wherein said updation copies adequate number of ranked subscribers to movie specific slots to match said allotted licenses from said expected demand table to said demand schedule table, wherein said ranking is based on weights associated with said subscribers, wherein said weights are determined based on said subscriber specific past data consisting of complaints, revenue, and successful viewings, past favor points, and SLA type.

39. The system of claim 38, wherein said expected demand bulk allocation element further comprises means for updation of alternate allocation list, wherein said list consists of slot specific subscribers whose expected demands could not be met due to shortage of licenses.

40. The system of claim 1, wherein said subscriber ranking element of said subsystem community content manager comprises means for ranking of subscribers, wherein said ranking is based on weighted sum of rating due to past favors, rating due to past data, and rating due to subscriber SLA type.

41. The system of claim 40, wherein said subscriber ranking element further comprises means for computing subscriber specific rating due to past favors, wherein said computation is based on said subscriber specific accumulated favor points and lookup table.

42. The system of claim 40, wherein said subscriber ranking element further comprises means for computing subscriber specific rating due to subscriber specific past data, wherein said rating is based on frequency of past favors, past complaints, past revenue, and past successful viewings.

43. The system of claim 42, wherein said computation of rating due to frequency of past favors comprises correlation of subscriber specific favor point characteristic and system specific favor point characteristic, wherein said subscriber specific favor point characteristic denotes the variation in favor points over past pre-defined number of weeks and said system specific favor point characteristic denotes the typical variation in favor points.

44. The system of claim 42, wherein said computation of rating due to past complaints comprises analyzing subscriber specific average number of complaints, wherein said average is based on said subscriber specific complaints over past pre-defined number of weeks.

45. The system of claim 42, wherein said computation of rating due to past revenue comprises analyzing subscriber specific average revenue using a lookup table, wherein said average is based on said subscriber specific revenue over past pre-defined number of weeks.

46. The system of claim 42, wherein said computation of rating due to past successful viewings comprises analyzing subscriber specific ratio of total number of successful viewings to total number of planned viewings, wherein the said total is based on said subscriber specific viewings over past pre-defined number of weeks.

47. The system of claim 40, wherein said subscriber ranking element further comprises means for computing subscriber specific rating due to subscriber SLA type, wherein said computation is based on said subscriber specific SLA type and lookup table.

48. The system of claim 1, wherein said alternate movie allocation element of said subsystem community content manager comprises means for allocation of movies in alternate allocation list to meet unsatisfied expected demands of subscribers, wherein said allocation involves assigning license available movie to subscriber specific slot, wherein said subscriber specific slot contains an unmet expected demand and said movie in said alternate allocation list matches best with said slot based on matching of symbolic and numeric features of movie from said alternate allocation list with subscriber specific slot specific symbolic and numeric features.

49. The system of claim 48, wherein said alternate movie allocation element further comprises means for allocation of movies in alternate allocation list to meet unsatisfied expected demands of subscribers, wherein said allocation involves assigning license available movie to subscriber specific backup slot, wherein said movie in said alternate allocation list matches best with said slot based on matching of symbolic and numeric features of movie from said alternate allocation list with subscriber specific slot specific symbolic and numeric features.

50. The system of claim 1, wherein said incremental demand scheduling element of said subsystem community content manager comprises means for processing of incremental demand for a movie in a slot by a subscriber, wherein said processing includes checking of said subscriber SLA compliance, checking of license availability for said movie in said slot, negotiating for an alternative movie or slot in case of non-availability of said license with said subscriber, generation of FP triggers, and updation of movie-slot specific licenses and subscriber list in one of preferred demand license allocation table and incremental demand license allocation table based on demanded or negotiated movie and demanded or negotiated slot.

51. The system of claim 50, wherein said incremental demand scheduling element further comprises means for negotiation to meet an incremental demand for a movie in a slot by a subscriber, wherein said negotiation is with other CCMs and CSLM to obtain a license for said movie in said slot.

52. The system of claim 50, wherein said incremental demand scheduling element further comprises means for synchronization of demand schedule table with respect to an incremental demand for a movie in a slot by a subscriber, wherein said synchronization involves moving and changing, wherein said moving adjusts said demand schedule table by moving said subscriber from an expected movie and an expected slot specific list in said demand schedule table to an assigned movie and an assigned slot specific list in said demand schedule table, wherein said expected slot is a slot closest to said assigned slot and said expected movie is a movie in said expected slot and said changing replaces an expected demand for said assigned movie with said expected movie based on license availability.

53. The system of claim 1, wherein said real-time demand scheduling element of said subsystem community content manager comprises means for processing of near real-time demands, wherein said demands are for a slot received fifteen minutes before show timing of said slot.

54. The system of claim 53, wherein said real-time demand scheduling element further comprises means for processing of real-time demand for a movie by a subscriber, wherein said processing includes checking of said subscriber SLA compliance, checking of license availability for said movie in said slot, generation of FP triggers, and updation of movie-slot specific licenses and subscriber list in one of preferred demand license allocation table and incremental demand license allocation table based on said movie and said slot.

55. The system of claim 53, wherein said real-time demand scheduling element further comprises means for negotiation to meet a real-time demand for a movie in a slot by a subscriber, wherein said negotiation is with other CCMs and CSLM to obtain a license for said movie in said slot.

56. The system of claim 53, wherein said real-time demand scheduling element further comprises means for synchronization of demand schedule table with respect to a real-time demand for a movie in a slot by a subscriber, wherein said synchronization involves moving and changing, wherein said moving adjusts said demand schedule table by moving said subscriber from an expected movie and an expected slot specific list in said demand schedule table to an assigned movie and an assigned slot specific list in said demand schedule table, wherein said expected slot is a slot closest to said assigned slot and said expected movie is a movie in said expected slot and said changing replaces an expected demand for said assigned movie with said expected movie based on license availability.

57. The system of claim 1, wherein said re-planning element of said subsystem community content manager comprises means for processing of planned and actual viewings, wherein said processing is performed every fifteen minutes five minutes after the commencement of show.

58. The system of claim 57, wherein said re-planning element further comprises means for processing planned and not viewed demands, wherein said processing for each of said demands includes allocation of a backup slot, and allocation of movie of said demand for said backup slot or allocation of best possible alternate movie for said backup slot based on license availability, and updation of demand schedule table, wherein said best possible alternate movie is based on symbolic and numeric features of movies and slots.

59. The system of claim 1, wherein said license management element of said subsystem content storage and license manager comprises means for management of bulk reusable license kind, wherein single license for a movie of said bulk reusable license kind allows simultaneous streaming of said movie to a group of subscribers repeatedly, wherein said successive repeated simultaneous streams do not overlap.

60. The system of claim 59, wherein said license management element further comprises means for management of bulk non reusable license kind, wherein single license for a movie of said bulk non reusable kind allows simultaneous streaming of said movie to a group of subscribers once.

61. The system of claim 59, wherein said license management element further comprises means for management of single non reusable license kind, wherein single license for a movie of said singe non reusable kind allows streaming of said movie to a subscribers once.

62. The system of claim 59, wherein said license management element further comprises means for management of movie life cycle, wherein said movie life cycle is a bell shaped curve denoting the demand on a move after release of said movie.

63. The system of claim 1, wherein said return on investment element of said subsystem content storage and license manager comprises means for computing community content manager specific movie-wise churn rate, wherein said computation is based on ratio of actual viewings of said movie to requested viewing of said movie.

64. The system of claim 63, wherein said return on investment element further comprises means for computing community content manager specific movie-wise incurred expense, wherein said computation is based on said movie license utilization percentage.

65. The system of claim 63, wherein said return on investment element further comprises means for computing community content manager specific movie-wise revenue earned, wherein said computation is based on revenue earned by said community content manager as a percentage of total revenue earned, wherein said total revenue is sum of revenue earned by plurality of community content managers.

66. The system of claim 1, wherein said buy analysis element of said subsystem content storage and license manager comprises means for selecting movie for buying, wherein said selection of said movie is based on consistent utilization of said movie above upper watermark, wherein said consistent utilization is over past pre-defined number of weeks.

67. The system of claim 66, wherein said buy analysis element further comprises means for computing movie-wise number of licenses to be bought, wherein said computation is based on advancing upper watermark by amount based on difference between two successive consistent utilization marks of said movie.

68. The system of claim 66, wherein said buy analysis element further comprises means for movie-wise splitting of number of licenses to be bought into bulk reusable, bulk non-reusable, and single non-reusable, wherein said splitting is based on life cycle analysis of said movie, wherein said analysis is by comparing utilization curve of said movie with standard movie demand curve, wherein said movie utilization curve is based on actual per week license utilization of said movie over past pre-defined number of weeks and said standard demand curve is based on expected utilization of standard movie.

69. The system of claim 1, wherein said preferred demand allocation element of said subsystem content storage and license manager comprises means for movie-wise determination of near optimal license-kind-wise requirement to meet preferred demand of said movie, wherein said determination is based on evaluation of utilization and cost criteria of said license-kind-wise requirement.

70. The system of claim 69, wherein said preferred demand allocation element further comprises means for computing movie-wise determination of near optimal license-kind based on a stochastic optimization technique.

71. The system of claim 69, wherein said preferred demand allocation element further comprises means for evaluating license utilization of a number of licenses of BR, BNR, and SNR license-kind with respect to movie specific slot-wise preferred demands, wherein said utilization is based on first distributing licenses of BR kind as much as possible based on pre-defined percentage, next distributing licenses of BNR kind as much as possible based on pre-defined percentage, and finally distributing licenses of SNR kind as much as possible to meet said preferred demands.

72. The system of claim 69, wherein said preferred demand allocation element further comprises means for evaluating incremental license acquisition cost to meet movie specific slot-wise preferred demands, wherein said incremental cost is based on cost of additional licenses required of BR kind, cost of additional licenses of BNR kind, and cost of additional licenses of SNR kind, wherein said additional licenses of BR kind is based on the difference between the licenses needed of BR kind and licenses available of BR kind, said additional licenses of BNR kind is based on the difference between the licenses needed of BNR kind and licenses available of BNR kind, and said additional licenses of SNR kind is based on the difference between the licenses needed of SNR kind and licenses available of SNR kind.

73. The system of claim 1, wherein said expected demand allocation element of said subsystem content storage and license manager comprises means for movie-wise distribution of available licenses to plurality of community content managers, wherein said distribution is based on near optimal allocation of plurality of license kinds, wherein said allocation meets said license-kind specific pre-defined utilization criterion.

74. The system of claim 73, wherein said expected demand allocation element further comprises means for near optimal allocation of licenses of BR, BNR, and SNR license-kinds to meet movie specific slot-wise demands, wherein said allocation first allocates as much of BR licenses as possible such that utilization is maximum, next allocates as much of BNR licenses as possible such that utilization is maximum, allocates as much of SNR slabs licenses as possible, and finally repeating allocating of BR, BNR and SNR in slabs, wherein said slab-based allocation allows compromising license utilization in order to arrive at a near optimal allocation.

75. The system of claim 73, wherein said expected demand allocation element further comprises means for identifying alternate movies, wherein said identification is based on available licenses for each of said movie after meeting expected demand for said movie.

76. The system of claim 73, wherein said expected demand allocation element further comprises means for identifying community content manager wise movie with unsatisfied demands and further assigning best possible alternate movie based on license availability.

77. The system of claim 1, wherein said swap analysis element of said subsystem content storage and license manager comprises means for selecting movie for license swapping, wherein said selection of said movie is based on consistent non-utilization of said movie below lower watermark, wherein said consistent utilization is over past pre-defined number of weeks.

78. The system of claim 77, wherein said swap analysis element further comprises means for computing movie-wise number of licenses to be swapped, wherein said computation is based on lowering lower watermark by amount based on difference between two successive consistent non-utilization marks of said movie.

79. The system of claim 77, wherein said swap analysis element further comprises means for movie-wise splitting of number of licenses to be swapped into bulk reusable, bulk non-reusable, and single non-reusable; wherein said splitting is based on life cycle analysis of said movie, wherein said analysis is by comparing utilization curve of said movie with standard movie demand curve, wherein said movie utilization curve is based on actual per week license utilization of said movie over past pre-defined number of weeks and said standard demand curve is based on expected utilization of standard movie.

80. The system of claim 1, wherein said license acquisition element of said subsystem content storage and license manager comprises means for movie-wise distribution of licenses to be acquired from plurality of distributors, wherein said distribution is based on past bought percentage of said movie from each of said distributors.

81. The system of claim 80, wherein said license acquisition element further comprises means for computing number of licenses of movie to be swapped from distributor, wherein said computation is based on swap potential of said distributor and licenses for said movie to be bought from said distributor, wherein said swap potential is based on total number of licenses for plurality of movies to be bought from said distributor and pre-defined swap ratio.

82. An apparatus for distribution of video licenses based on zero-reject model for maximizing usage of licenses and minimizing churn rate comprising:
(a) plurality of LSM computer systems for executing LSM procedures related to LSM;
(b) plurality of CCM computer systems for executing CCM procedures related to CCM; and
(c) a CSLM computer system for executing CSLM procedures related to CSLM.

83. The apparatus of claim 82, wherein each one of said LSM computer systems is configured for execution of a procedure for managing SLAs, subscriber group identification, and weekly plan confirmation.

84. The apparatus of claim 83, wherein said LSM computer system is further configured for execution of a procedure for managing FP specific SLA parameters, FP policies, and FP-based subscriber migrations.

85. The apparatus of claim 83, wherein said LSM computer system is further configured for execution of a procedure for managing subscriber bill discounts based on subscriber specific FPs.

86. The apparatus of claim 83, wherein said LSM computer system is further configured for execution of a procedure for managing URL based, sponsor based and login time previews and previews for community viewings.

87. The apparatus of claim 83, wherein said LSM computer system is further configured for execution of a procedure for performing root cause analysis of complaints and subscriber churn analysis.

88. The apparatus of claim 82, wherein each one of said CCM computer systems is configured for execution of a procedure for processing movie descriptions based on a plurality of symbolic and numeric features.

89. The apparatus of claim 88, wherein said CCM computer system is further configured for execution of a procedure for processing hierarchical descriptions of a collection of movies, wherein each said hierarchy consists of multiple nodes with each node aptly described using symbolic and numeric features.

90. The apparatus of claim 88, wherein said CCM computer system is further configured for execution of a procedure for predicting subscriber specific plurality of movies that most probably be viewed by said subscriber in a week.

91. The apparatus of claim 88, wherein said CCM computer system is further configured for execution of a procedure for predicting subscriber specific representative symbolic and numeric features representing the movies that most probably be viewed by said subscriber in a week.

92. The apparatus of claim 88, wherein said CCM computer system is further configured for execution of a procedure for selecting subscriber specific plurality of movies based on representative symbolic and numeric features of said subscriber and movies in popularity chart.

93. The apparatus of claim 88, wherein said CCM computer system is further configured for execution of a procedure for predicting subscriber specific plurality of most probable slots based on the analysis of slot occupancy and inter-slot gap.

94. The apparatus of claim 88, wherein said CCM computer system is further configured for execution of a procedure for best possible subscriber specific symbolic and numeric feature matching of the most probable movies with the most probable slots.

95. The apparatus of claim 88, wherein said CCM computer system is further configured for execution of a procedure for the preparation of subscriber specific weekly plan consisting of preferred demand and expected demand.

96. The apparatus of claim 88, wherein said CCM computer system is further configured for execution of a procedure for the allocation of allotted licenses to meet preferred demands.

97. The apparatus of claim 88, wherein said CCM computer system is further configured for execution of a procedure for the allocation of allotted licenses to meet expected demands by ranking subscribers based on subscriber specific past data consisting of complaints, revenue, and successful viewings, past favor points, and SLA type based subscriber ranking.

98. The apparatus of claim 88, wherein said CCM computer system is further configured for execution of a procedure for ranking subscribers based on subscriber specific past data consisting of complaints, revenue, and successful viewings, past favor points, and SLA type based subscriber ranking.

99. The apparatus of claim 88, wherein said CCM computer system is further configured for execution of a procedure for allocating alternate movies for managing shortage of licenses.

100. The apparatus of claim 88, wherein said CCM computer system is further configured for execution of a procedure for analyzing and scheduling of incremental demands of subscribers and generating FP triggers.

101. The apparatus of claim 88, wherein said CCM computer system is further configured for execution of a procedure for analyzing and scheduling of real-time demands of subscribers and generating FP triggers.

102. The apparatus of claim 88, wherein said CCM computer system is further configured for execution of a procedure for modifying subscriber specific weekly plan based on the comparison of actual and planned viewings.

103. The apparatus of claim 82, wherein said CSLM computer system is configured for execution of a procedure for managing three distinct license kinds.

104. The apparatus of claim 103, wherein said CSLM computer system is further configured for execution of a procedure for movie specific ranking of CCMs, wherein ranking is based on computation of said movie churn rate, said movie incurred expense, and said movie revenue earned.

105. The apparatus of claim 103, wherein said CSLM computer system is further configured for execution of a procedure for the selection of plurality of movies for license acquisition based on consistent utilization of said each movie using upper watermark and life cycle analyses.

106. The apparatus of claim 103, wherein said CSLM computer system is further configured for execution of a procedure for analyzing and near-optimal distribution of the movie licenses for preferred subscriber demands.

107. The apparatus of claim 103, wherein said CSLM computer system is further configured for execution of a procedure for the distribution of available licenses to meet the expected demand based on near optimal maximization of license utilization.

108. The apparatus of claim 103, wherein said CSLM computer system is further configured for execution of a procedure for the selection of plurality of movies based consistent non-utilization of said each movie using lower watermark and life cycle analyses.

109. The apparatus of claim 103, wherein said CSLM computer system is further configured for execution of a procedure for managing license acquisition from distributors based on swap potential and license exchange criteria of each said distributor.

110. The apparatus of claim 103, wherein said CSLM computer system is further configured for execution of a procedure for interaction with external entities for managing symbolic and numeric feature updates for movies, updates for movie hierarchies, and popularity chart updates.

111. An apparatus, for distribution of video licenses based on zero-reject model for maximizing usage of licenses and minimizing churn rate, coupled to a communication system, comprising:
(a) IP network to interconnect plurality of subscriber terminal systems to LSM computer system;
(b) IP network to interconnect plurality of LSM computers systems to CCM computer system;
(c) IP network to interconnect plurality of CCM computer systems to CSLM computer system; and
(d) IP network to interconnect plurality of CCM computer systems.

112. The apparatus coupled to a communication system of claim 111, wherein said IP network provides for communication of subscriber specific SLA information, weekly plan details, favor point details, previews, complaints, subscriber information, and movie streams between subscriber terminal system and LSM computer system.

113. The apparatus coupled to a communication system of claim 111, wherein said IP network provides for communication of incremental demands, real-time demands, and movie streams between subscriber terminal system and CCM computer system.

114. The apparatus coupled to a communication system of claim 111, wherein said IP network provides for communication of movie information, pop-chart information, FP triggers, weekly plan details, and past movie viewing patterns between LSM computer system and CCM computer system.

115. The apparatus coupled to a communication system of claim 111, wherein said IP network provides for communication of movie information, movie hierarchy information, pop-chart information, preferred and expected demands, allotted licenses information, and subscriber information between CCM computer system and CSLM computer system.

116. The apparatus coupled to a communication system of claim 111, wherein said IP network provides for communication of incremental and real-time demands among plurality of CCM computer systems.
